(19) United States
(12) Patent Application Publication
(10) Pub. No.: US 2024/0284462 A1
(43) Pub. Date: Aug. 22, 2024

(54) INDICATIONS FOR UPLINK RESOURCES VIA UPLINK CONTROL INFORMATION

(71) Applicant: QUALCOMM Incorporated, San Diego, CA (US)

(72) Inventor: Iyab Issam SAKHNINI, San Diego, CA (US)

(21) Appl. No.: 18/434,338

(22) Filed: Feb. 6, 2024

Related U.S. Application Data
(60) Provisional application No. 63/485,494, filed on Feb. 16, 2023.

(51) Int. Cl. H04W 72/21; H04L 1/1812; H04L 5/00

(52) U.S. Cl. CPC H04W 72/21; H04L 1/1812; H04L 5/0053

(57) ABSTRACT

Methods, systems, and devices for wireless communications are described. A user equipment (UE) may receive a control message indicating a configuration for uplink control information (UCI) that supports an indication of hybrid automatic repeat request (HARQ) feedback, an indication of a scheduling request, an indication of channel state information (CSI), and an indication of additional information. In some aspects, the indication of the additional information may be associated with uplink resources configured for the UE. For example, the indication of the additional information may be an indication that the UE is to skip one or more uplink resources configured for the UE. The UE may transmit the UCI in accordance with the configuration, where the UCI includes at least one of the indication of the HARQ feedback, the indication of the scheduling request, the indication of the CSI, or the indication of the additional information.

### CROSS REFERENCE

The present application for patent claims the benefit of U.S. Provisional Patent Application No. 63/485,494 by SAKHNINI et al., entitled “INDICATIONS FOR UPLINK RESOURCES VIA UPLINK CONTROL INFORMATION,” filed Feb. 16, 2023, assigned to the assignee hereof, and expressly incorporated by reference herein.

### FIELD OF TECHNOLOGY

The following relates to wireless communications, including indications for uplink resources via uplink control information.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The described techniques relate to improved methods, systems, devices, and apparatuses that support indications for uplink resources via uplink control information (UCI). For example, the described techniques provide for a user equipment (UE) to indicate, via UCI, additional information associated with one or more uplink resources configured for the UE. For example, the UE 115 may autonomously determine to skip, or otherwise not use, one or more uplink resources associated with a configured grant. As such, the UE may transmit UCI via a physical uplink control channel (PUCCH), where the UCI includes an indication that the UE is skipping (e.g., not transmitting a signal using) the one or more uplink resource. That is, the UE may transmit an indication of additional information in the UCI, where in one example the additional information is associated with the UE skipping one or more uplink resource occasions configured for the UE. By indicating such additional information to the network entity, the network entity may repurpose, or reschedule, such skipped resources for use by other UEs, thereby providing more efficient utilization of communication resources and improved coordination between devices. In some aspects, the UE may transmit the additional information via the UCI in accordance with various techniques, for example, based on a format of the PUCCH that carries the UCI, or based on a quantity of bits of respective information included in the UCI, or both.

A method for wireless communication at a UE is described. The method may include receiving a control message indicating a configuration for UCI that supports an indication of hybrid automatic repeat request (HARQ) feedback, an indication of a scheduling request, an indication of channel state information (CSI), and an indication of additional information, the indication of the additional information being associated with a set of multiple uplink resources configured for the UE and transmitting the UCI via a PUCCH in accordance with the configuration, where the UCI includes at least one of the indication of the HARQ feedback, or the indication of the scheduling request, or the indication of the CSI, or the indication of the additional information.

A UE is described. The UE may include one or more memories storing processor-executable code and one or more processors coupled with the one or more memories. The one or more processors may be individually or collectively operable to execute the code to cause the UE to receive a control message indicating a configuration for UCI that supports an indication of HARQ feedback, an indication of a scheduling request, an indication of CSI, and an indication of additional information, the indication of the additional information being associated with a set of multiple uplink resources configured for the UE and transmit the UCI via a PUCCH in accordance with the configuration, where the UCI includes at least one of the indication of the HARQ feedback, or the indication of the scheduling request, or the indication of the CSI, or the indication of the additional information.

Another UE is described. The UE may include means for receiving a control message indicating a configuration for UCI that supports an indication of HARQ feedback, an indication of a scheduling request, an indication of CSI, and an indication of additional information, the indication of the additional information being associated with a set of multiple uplink resources configured for the UE and means for transmitting the UCI via a PUCCH in accordance with the configuration, where the UCI includes at least one of the indication of the HARQ feedback, or the indication of the scheduling request, or the indication of the CSI, or the indication of the additional information.

A non-transitory computer-readable medium storing code for wireless communication at a UE is described. The code may include instructions executable by one or more processors to receive a control message indicating a configuration for UCI that supports an indication of HARQ feedback, an indication of a scheduling request, an indication of CSI, and an indication of additional information, the indication of the additional information being associated with a set of multiple uplink resources configured for the UE and transmit the UCI via a PUCCH in accordance with the configuration, where the UCI includes at least one of the indication of the HARQ feedback, or the indication of the scheduling request, or the indication of the CSI, or the indication of the additional information.

In some examples of the method, UEs, and non-transitory computer-readable medium described herein, the PUCCH may be configured as PUCCH format 0 and the method, UEs, and non-transitory computer-readable medium may include further operations, features, means, or instructions for determining a cyclic shift from a set of multiple cyclic shifts associated with the UCI based on whether the UCI includes the indication of the HARQ feedback, the indication of the scheduling request, the indication of the additional information, or a combination thereof, where the UCI may be transmitted via the PUCCH based on the cyclic shift being applied to a base sequence.

In some examples of the method, UEs, and non-transitory computer-readable medium described herein, the cyclic shift includes an initial cyclic shift value based on the UCI including only the indication of the additional information.

In some examples of the method, UEs, and non-transitory computer-readable medium described herein, the cyclic shift includes a first cyclic shift value based on the UCI including only the indication of the additional information, the first cyclic shift value being offset from an initial cyclic shift value.

In some examples of the method, UEs, and non-transitory computer-readable medium described herein, the cyclic shift includes a second cyclic shift value based on the UCI including only the indication of the HARQ feedback, the second cyclic shift value being offset from an initial cyclic shift value by a first value in accordance with the HARQ feedback including a negative acknowledgment, or the second cyclic shift value being offset from the initial cyclic shift value by a second value different from the first value in accordance with the HARQ feedback including an acknowledgment.

In some examples of the method, UEs, and non-transitory computer-readable medium described herein, the cyclic shift includes an initial cyclic shift value based on the UCI including only the indication of the scheduling request.

In some examples of the method, UEs, and non-transitory computer-readable medium described herein, the cyclic shift includes a fourth cyclic shift value based on the UCI including the indication of the additional information and the indication of the scheduling request, the fourth cyclic shift value being offset from an initial cyclic shift value based on the scheduling request and the additional information.

In some examples of the method, UEs, and non-transitory computer-readable medium described herein, the cyclic shift includes a fifth cyclic shift value based on the UCI including the indication of the additional information and the indication of the HARQ feedback, the fifth cyclic shift value being offset from an initial cyclic shift value by a third value in accordance with the HARQ feedback including a negative acknowledgment, or the fifth cyclic shift value being offset from the initial cyclic shift value by a fourth value different from the third value in accordance with the HARQ feedback including an acknowledgment.

In some examples of the method, UEs, and non-transitory computer-readable medium described herein, the cyclic shift includes a sixth cyclic shift value based on the UCI including the indication of the additional information, the indication of the HARQ feedback, and the indication of the scheduling request, the sixth cyclic shift value being offset from an initial cyclic shift value by a fifth value in accordance with the HARQ feedback including a negative acknowledgment, or the sixth cyclic shift value being offset from the initial cyclic shift value by a sixth value different from the fifth value in accordance with the HARQ feedback including an acknowledgment.

In some examples of the method, UEs, and non-transitory computer-readable medium described herein, the cyclic shift includes a seventh cyclic shift value based on the UCI including the indication of the HARQ feedback and the indication of the scheduling request, the seventh cyclic shift value being offset from an initial cyclic shift value by a seventh value in accordance with the HARQ feedback including a negative acknowledgment, or the seventh cyclic shift value being offset from the initial cyclic shift value by a eighth value different from the seventh value in accordance with the HARQ feedback including an acknowledgment.

In some examples of the method, UEs, and non-transitory computer-readable medium described herein, the cyclic shift may be further based on a quantity of bits associated with each of the indication of the HARQ feedback, or indication of the scheduling request, or the indication of the additional information, or any combination thereof, and a bit value of each of the indication of the HARQ feedback, or the indication of the additional information, or both.

In some examples of the method, UEs, and non-transitory computer-readable medium described herein, the PUCCH may be configured as PUCCH format 1 and the method, UEs, and non-transitory computer-readable medium may include further operations, features, means, or instructions for selecting at least one of a modulation scheme or an uplink resource for transmitting at least the indication of the additional information, where the UCI may be transmitted via the PUCCH based on at least one of the modulation scheme or the uplink resource.

In some examples of the method, UEs, and non-transitory computer-readable medium described herein, the UCI includes only the indication of the additional information; and the additional information may be indicated using the modulation scheme based on a quantity of bits associated with the indication of the additional information.

In some examples of the method, UEs, and non-transitory computer-readable medium described herein, the modulation scheme includes a binary phase shift keying (BPSK) modulation scheme in accordance with the indication of the additional information including one bit.

In some examples of the method, UEs, and non-transitory computer-readable medium described herein, the modulation scheme includes a quadrature phase shift keying (QPSK) modulation scheme in accordance with the indication of the additional information including two or more bits.

In some examples of the method, UEs, and non-transitory computer-readable medium described herein, the UCI includes the indication of the additional information and the indication of the HARQ feedback; the indication of the additional information and the indication of the HARQ feedback may be transmitted via the uplink resource, the uplink resource being allocated for the indication of the additional information; and the indication of the HARQ feedback transmitted via the uplink resource includes the indication of the additional information based on the indication of the additional information including one bit.

In some examples of the method, UEs, and non-transitory computer-readable medium described herein, the UCI includes the indication of the additional information and the indication of the HARQ feedback; the indication of the additional information and the indication of the HARQ feedback may be transmitted using the modulation scheme, the modulation scheme including a QPSK modulation scheme; and the indication of the additional information includes one bit.

In some examples of the method, UEs, and non-transitory computer-readable medium described herein, the UCI includes the indication of the additional information and the indication of the scheduling request; the indication of the additional information and the indication of the scheduling request may be transmitted via the uplink resource, the uplink resource including either a first uplink resource allocated for the indication of the additional information or a second uplink resource allocated for the indication of the scheduling request; and the indication of the additional information includes one bit.

In some examples of the method, UEs, and non-transitory computer-readable medium described herein, the UCI includes the indication of the additional information and the indication of the scheduling request; the indication of the additional information and the indication of the scheduling request may be transmitted via the uplink resource, the uplink resource being allocated for the indication of the scheduling request; and the indication of the additional information includes one or more bits.

In some examples of the method, UEs, and non-transitory computer-readable medium described herein, the UCI includes the indication of the additional information, the indication of the scheduling request, and the indication of the HARQ feedback; the indication of the HARQ feedback may be transmitted via the uplink resource, the uplink resource including either a first uplink resource allocated for the indication of the additional information or a second uplink resource allocated for the indication of the scheduling request; and the indication of the additional information includes one bit.

In some examples of the method, UEs, and non-transitory computer-readable medium described herein, the UCI includes the indication of the additional information, the indication of the scheduling request, and the indication of the HARQ feedback, the indication of the additional information; the indication of the scheduling request, and the indication of the HARQ feedback may be transmitted using the modulation scheme and via the uplink resource, the modulation scheme including a QPSK modulation scheme and the uplink resource being allocated for the indication of the scheduling request; and the indication of the additional information includes one bit.

In some examples of the method, UEs, and non-transitory computer-readable medium described herein, the PUCCH may be configured as PUCCH format 2 and the method, UEs, and non-transitory computer-readable medium may include further operations, features, means, or instructions for transmitting, as part of the UCI, at least one of the indication of the additional information, or the indication of the HARQ feedback, or the indication of the CSI, where one or more bits associated with the indication of the additional information may be multiplexed with at least one of one or more bits associated with the indication of the HARQ feedback or one or more bits associated with the indication of the CSI.

In some examples of the method, UEs, and non-transitory computer-readable medium described herein, the one or more bits associated with the indication of the HARQ feedback may have a first priority that may be greater than a second priority associated with the one or more bits associated with the indication of the additional information; the second priority may be greater than a third priority associated with the one or more bits associated with the indication of the CSI; and the UCI includes at least one of the indication of the additional information, or the indication of the scheduling request, or the indication of the HARQ feedback, or the indication of the CSI, based on the first priority, the second priority, or the third priority.

In some examples of the method, UEs, and non-transitory computer-readable medium described herein, the PUCCH may be configured as PUCCH format 3 or PUCCH format 4 and the method, UEs, and non-transitory computer-readable medium may include further operations, features, means, or instructions for transmitting, as part of the UCI, at least one of the indication of the additional information, or the indication of the HARQ feedback, or the indication of the CSI, where one or more bits associated with the indication of the additional information may be multiplexed and jointly encoded with at least one of one or more bits associated with the indication of the HARQ feedback, or one or more bits associated with the indication of the CSI.

In some examples of the method, UEs, and non-transitory computer-readable medium described herein, mapping at least one of the one or more bits associated with the indication of the additional information, or the one or more bits associated with the indication of the HARQ feedback, or the one or more bits associated with the indication of the CSI based on at least one of a first mapping priority, or a second mapping priority that may be less than the first mapping priority, or a third mapping priority that may be less than the second mapping priority, where: the one or more bits associated with the indication of the HARQ feedback may have the first mapping priority; the one or more bits associated with the indication of the additional information may have the second mapping priority; and the one or more bits associated with the indication of the CSI may have the third mapping priority.

In some examples of the method, UEs, and non-transitory computer-readable medium described herein, the additional information indicates that the UE may be to skip one or more uplink resources of the set of multiple uplink resources configured for the UE.

In some examples of the method, UEs, and non-transitory computer-readable medium described herein, the UCI excludes the indication of the scheduling request based on the UCI indicating that the UE may be to skip the one or more uplink resources.

In some examples of the method, UEs, and non-transitory computer-readable medium described herein, the UCI excludes the indication of the additional information based on the UCI including the indication of the scheduling request.

A method for wireless communication at a network entity is described. The method may include transmitting a control message indicating a configuration for UCI that supports an indication of HARQ feedback, an indication of a scheduling request, an indication of CSI, and an indication of additional information, the indication of the additional information being associated with a set of multiple uplink resources configured for a UE and receiving the UCI via a PUCCH in accordance with the configuration, where the UCI includes at least one of the indication of the HARQ feedback, or the indication of the scheduling request, or the indication of the CSI, or the indication of the additional information.

A network entity is described. The network entity may include one or more memories storing processor-executable code and one or more processors coupled with the one or more memories. The one or more processors may be individually or collectively operable to execute the code to cause the network entity to transmit a control message indicating a configuration for UCI that supports an indication of HARQ feedback, an indication of a scheduling request, an indication of CSI, and an indication of additional information, the indication of the additional information being associated with a set of multiple uplink resources configured for a UE and receive the UCI via a PUCCH in accordance with the configuration, where the UCI includes at least one of the indication of the HARQ feedback, or the indication of the scheduling request, or the indication of the CSI, or the indication of the additional information.

Another network entity is described. The network entity may include means for transmitting a control message indicating a configuration for UCI that supports an indication of HARQ feedback, an indication of a scheduling request, an indication of CSI, and an indication of additional information, the indication of the additional information being associated with a set of multiple uplink resources configured for a UE and means for receiving the UCI via a PUCCH in accordance with the configuration, where the UCI includes at least one of the indication of the HARQ feedback, or the indication of the scheduling request, or the indication of the CSI, or the indication of the additional information.

A non-transitory computer-readable medium storing code for wireless communication at a network entity is described. The code may include instructions executable by one or more processors to transmit a control message indicating a configuration for UCI that supports an indication of HARQ feedback, an indication of a scheduling request, an indication of CSI, and an indication of additional information, the indication of the additional information being associated with a set of multiple uplink resources configured for a UE and receive the UCI via a PUCCH in accordance with the configuration, where the UCI includes at least one of the indication of the HARQ feedback, or the indication of the scheduling request, or the indication of the CSI, or the indication of the additional information.

In some examples of the method, network entities, and non-transitory computer-readable medium described herein, the PUCCH may be configured as PUCCH format 0 and the method, network entities, and non-transitory computer-readable medium may include further operations, features, means, or instructions for receiving the UCI via the PUCCH based on a cyclic shift applied to a base sequence, the cyclic shift being from a set of multiple cyclic shifts, where the cyclic shift may be based on whether the UCI includes the indication of the HARQ feedback, the indication of the scheduling request, the indication of the additional information, or a combination thereof.

In some examples of the method, network entities, and non-transitory computer-readable medium described herein, the cyclic shift includes an initial cyclic shift value based on the UCI including only the indication of the additional information.

In some examples of the method, network entities, and non-transitory computer-readable medium described herein, the cyclic shift includes a first cyclic shift value based on the UCI including only the indication of the additional information, the first cyclic shift value being offset from an initial cyclic shift value.

In some examples of the method, network entities, and non-transitory computer-readable medium described herein, the cyclic shift includes a second cyclic shift value based on the UCI including only the indication of the HARQ feedback, the second cyclic shift value being offset from an initial cyclic shift value by a first value in accordance with the HARQ feedback including a negative acknowledgment, or the second cyclic shift value being offset from the initial cyclic shift value by a second value different from the first value in accordance with the HARQ feedback including an acknowledgment.

In some examples of the method, network entities, and non-transitory computer-readable medium described herein, the cyclic shift includes an initial cyclic shift value based on the UCI including only the indication of the scheduling request.

In some examples of the method, network entities, and non-transitory computer-readable medium described herein, the cyclic shift includes a fourth cyclic shift value based on the UCI including the indication of the additional information and the indication of the scheduling request, the fourth cyclic shift value being offset from an initial cyclic shift value based on the scheduling request and the additional information.

In some examples of the method, network entities, and non-transitory computer-readable medium described herein, the cyclic shift includes a fifth cyclic shift value based on the UCI including the indication of the additional information and the indication of the HARQ feedback, the fifth cyclic shift value being offset from an initial cyclic shift value by a third value in accordance with the HARQ feedback including a negative acknowledgment, or the fifth cyclic shift value being offset from the initial cyclic shift value by a fourth value different from the third value in accordance with the HARQ feedback including an acknowledgment.

In some examples of the method, network entities, and non-transitory computer-readable medium described herein, the cyclic shift includes a sixth cyclic shift value based on the UCI including the indication of the additional information, the indication of the HARQ feedback, and the indication of the scheduling request, the sixth cyclic shift value being offset from an initial cyclic shift value by a fifth value in accordance with the HARQ feedback including a negative acknowledgment, or the sixth cyclic shift value being offset from the initial cyclic shift value by a sixth value different from the fifth value in accordance with the HARQ feedback including an acknowledgment.

In some examples of the method, network entities, and non-transitory computer-readable medium described herein, the cyclic shift includes a seventh cyclic shift value based on the UCI including the indication of the HARQ feedback and the indication of the scheduling request, the seventh cyclic shift value being offset from an initial cyclic shift value by a seventh value in accordance with the HARQ feedback including a negative acknowledgment, or the seventh cyclic shift value being offset from the initial cyclic shift value by a eighth value different from the seventh value in accordance with the HARQ feedback including an acknowledgment.

In some examples of the method, network entities, and non-transitory computer-readable medium described herein, the cyclic shift may be further based on a quantity of bits associated with each of the indication of the HARQ feedback, or the indication of the scheduling request, or the indication of the additional information, or any combination thereof, and a bit value of each of the indication of the HARQ feedback, or the indication of the additional information, or both.

In some examples of the method, network entities, and non-transitory computer-readable medium described herein, the PUCCH may be configured as PUCCH format 1 and the method, network entities, and non-transitory computer-readable medium may include further operations, features, means, or instructions for receiving at least the indication of the additional information based on at least one of a modulation scheme or an uplink resource, where the UCI may be received via the PUCCH based on at least one of the modulation scheme or the uplink resource.

In some examples of the method, network entities, and non-transitory computer-readable medium described herein, the UCI includes only the indication of the additional information; and the additional information may be indicated using the modulation scheme based on a quantity of bits associated with the indication of the additional information.

In some examples of the method, network entities, and non-transitory computer-readable medium described herein, the modulation scheme includes a QPSK modulation scheme in accordance with the indication of the additional information including two or more bits.

In some examples of the method, network entities, and non-transitory computer-readable medium described herein, the modulation scheme includes a BPSK modulation scheme in accordance with the indication of the additional information including one bit.

In some examples of the method, network entities, and non-transitory computer-readable medium described herein, the UCI includes the indication of the additional information and the indication of the HARQ feedback; the indication of the additional information and the indication of the HARQ feedback may be transmitted via the uplink resource, the uplink resource being allocated for the indication of the additional information; and the indication of the HARQ feedback transmitted via the uplink resource includes the indication of the additional information based on the indication of the additional information including one bit.

In some examples of the method, network entities, and non-transitory computer-readable medium described herein, the UCI includes the indication of the additional information and the indication of the HARQ feedback; the indication of the additional information and the indication of the HARQ feedback may be transmitted using the modulation scheme, the modulation scheme including a QPSK modulation scheme; and the indication of the additional information includes one.

In some examples of the method, network entities, and non-transitory computer-readable medium described herein, the UCI includes the indication of the additional information and the indication of the scheduling request; the indication of the additional information and the indication of the scheduling request may be transmitted via the uplink resource, the uplink resource including either a first uplink resource allocated for the indication of the additional information or a second uplink resource allocated for the indication of the scheduling request; and the indication of the additional information includes one bit.

In some examples of the method, network entities, and non-transitory computer-readable medium described herein, the UCI includes the indication of the additional information and the indication of the scheduling request; the indication of the additional information and the indication of the scheduling request may be transmitted via the uplink resource, the uplink resource being allocated for the indication of the scheduling request; and the indication of the additional information includes one or more bits.

In some examples of the method, network entities, and non-transitory computer-readable medium described herein, the UCI includes the indication of the additional information, the indication of the scheduling request, and the indication of the HARQ feedback; the indication of the HARQ feedback may be transmitted via the uplink resource, the uplink resource including either a first uplink resource allocated for the indication of the additional information or a second uplink resource allocated for the indication of the scheduling request; and the indication of the additional information includes one.

In some examples of the method, network entities, and non-transitory computer-readable medium described herein, the UCI includes the indication of the additional information, the indication of the scheduling request, and the indication of the HARQ feedback, the indication of the additional information; the indication of the scheduling request, and the indication of the HARQ feedback may be transmitted using the modulation scheme and via the uplink resource, the modulation scheme including a QPSK modulation scheme and the uplink resource being allocated for the indication of the scheduling request; and the indication of the additional information includes one bit.

In some examples of the method, network entities, and non-transitory computer-readable medium described herein, the PUCCH may be configured as PUCCH format 2 and the method, network entities, and non-transitory computer-readable medium may include further operations, features, means, or instructions for receiving, as part of the UCI, at least one of the indication of the additional information, or the indication of the HARQ feedback, or the indication of the CSI, where one or more bits associated with the indication of the additional information may be multiplexed with at least one of one or more bits associated with the indication of the HARQ feedback, or one or more bits associated with the indication of the CSI.

In some examples of the method, network entities, and non-transitory computer-readable medium described herein, the one or more bits associated with the indication of the HARQ feedback may have a first priority that may be greater than a second priority associated with the one or more bits associated with the indication of the additional information; the second priority may be greater than a third priority associated with the one or more bits associated with the indication of the CSI; and the UCI includes at least one of the indication of the additional information, or the indication of the scheduling request, or the indication of the HARQ feedback, or the indication of the CSI, based on the first priority, the second priority, or the third priority.

In some examples of the method, network entities, and non-transitory computer-readable medium described herein, the PUCCH may be configured as PUCCH format 3 or PUCCH format 4 and the method, network entities, and non-transitory computer-readable medium may include further operations, features, means, or instructions for receiving, as part of the UCI, at least one of the indication of the additional information, or the indication of the HARQ feedback, or the indication of the CSI, where one or more bits associated with the indication of the additional information may be multiplexed and jointly encoded with at least one of one or more bits associated with the indication of the HARQ feedback, or one or more bits associated with the indication of the CSI.

In some examples of the method, network entities, and non-transitory computer-readable medium described herein, at least one of the one or more bits associated with the indication of the additional information, or the one or more bits associated with the indication of the HARQ feedback, or the one or more bits associated with the indication of the CSI may be mapped to resources based on at least one of a first mapping priority, or a second mapping priority that may be less than the first mapping priority, or a third mapping priority that may be less than the second mapping priority, where and the one or more bits associated with the indication of the HARQ feedback may have the first mapping priority; the one or more bits associated with the indication of the additional information may have the second mapping priority; and the one or more bits associated with the indication of the CSI may have the third mapping priority.

In some examples of the method, network entities, and non-transitory computer-readable medium described herein, the additional information indicates that the UE may be skipping one or more uplink resources of the set of multiple uplink resources configured for the UE.

Some examples of the method, network entities, and non-transitory computer-readable medium described herein may further include operations, features, means, or instructions for indicating a configuration to exclude the indication of the scheduling request from the UCI based on the UCI including the indication of the additional information, where the UCI may be received in accordance with the configuration to exclude the indication of the scheduling request.

Some examples of the method, network entities, and non-transitory computer-readable medium described herein may further include operations, features, means, or instructions for indicating a configuration to exclude the indication of the additional information from the UCI based on the UCI including the indication of the scheduling request, where the UCI may be received in accordance with the configuration to exclude the indication of the additional information.

### BRIEF DESCRIPTION OF THE DRAWINGS

FIGS. 1 and 2 illustrate examples of a wireless communications system that supports indications for uplink resources via uplink control information (UCI) in accordance with one or more aspects of the present disclosure.

FIGS. 3 through 5 illustrate examples of diagrams that supports indications for uplink resources via UCI in accordance with one or more aspects of the present disclosure.

FIG. 6 illustrates an example of a process flow that supports indications for uplink resources via UCI in accordance with one or more aspects of the present disclosure.

FIGS. 7 and 8 illustrate block diagrams of devices that support indications for uplink resources via UCI in accordance with one or more aspects of the present disclosure.

FIG. 9 illustrates a block diagram of a communications manager that supports indications for uplink resources via UCI in accordance with one or more aspects of the present disclosure.

FIG. 10 illustrates a diagram of a system including a device that supports indications for uplink resources via UCI in accordance with one or more aspects of the present disclosure.

FIGS. 11 and 12 illustrate block diagrams of devices that support indications for uplink resources via UCI in accordance with one or more aspects of the present disclosure.

FIG. 13 illustrates a block diagram of a communications manager that supports indications for uplink resources via UCI in accordance with one or more aspects of the present disclosure.

FIG. 14 illustrates a diagram of a system including a device that supports indications for uplink resources via UCI in accordance with one or more aspects of the present disclosure.

FIGS. 15 through 20 illustrate flowcharts showing methods that support indications for uplink resources via UCI in accordance with one or more aspects of the present disclosure.

### DETAILED DESCRIPTION

In some wireless communications systems, a user equipment (UE) may receive a configured grant indicating one or more periodic uplink resources, such that UE may transmit uplink data, via the periodic uplink resources, without transmitting a scheduling request or receiving respective resource grants for the uplink resources. That is, the UE may receive the configured grant and use the uplink resources in the configured grant to transmit uplink data in accordance with the respective periodicities of the uplink resources, thereby reducing the latency associated with transmitting scheduling requests as well as reducing overhead associated with downlink control information.

In some cases, however, the UE may autonomously determine to skip (e.g., refrain from transmitting data using) an occasion of an uplink resource at times when the UE may not have data to transmit. In such cases, the network entity may continue to monitor the occasion of the uplink resource for an uplink message from the UE without receiving any uplink messages (e.g., because the UE skipped transmission of data on that occasion). As such, if the UE autonomously determines to skip one or more uplink resources associated with the configured grant, the network entity may not have an indication of such skipped resources, leading to an inefficient use of resources, increased latency, or the like.

In some implementations, the UE may dynamically indicate skipped uplink resources to the network entity, such that the network entity may reschedule such resources for other UEs. For example, the UE may receive a configuration for uplink control information (UCI) that supports an indication of hybrid automatic repeat request (HARQ) feedback, an indication of a scheduling request, an indication of channel state information (CSI), and an indication additional information. In some cases, the indication of additional information indicates that the UE is to skip one or more uplink resources configured for the UE. As such, in accordance with the configuration, the UE may transmit the UCI, via a physical uplink control channel (PUCCH), where the UCI includes at least one of the indication of the HARQ feedback, the indication of the scheduling request, the indication of the CSI, or the indication of additional information (e.g., the indication of skipped resources). While the indication of skipped resources is provided as one example of the additional information indicated via UCI, the indication of additional information may be used for other signaling sent by the UE via the UCI (e.g., using the same or similar techniques described herein), and the examples provided herein should not be considered limiting to the scope covered by the claims or the disclosure. For example, the indication of additional information may include one or more of an on-demand synchronization signal block (SSB) request, an on-demand system information block 1 (SIB1) request, a guard interval length update request, a transmission configuration indicator (TCI) update request, or the like.

In this way, the UE may dynamically transmit the indication of additional information (e.g., an indication of skipped resources) to the network entity, thereby improving coordination between devices and enabling more efficient utilization of communication resources. For example, by transmitting the additional information in the UCI, the UE may indicate to the network entity which uplink resources may be skipped, thereby improving coordination between the UE and network entity. Further, by transmitting the additional information, the network entity may reschedule the skipped resources for use by other UEs, resulting in more efficient utilization of communication resources in the wireless communications system. Further, if the UE signals additional information via the UCI, then the UE and network entity may experience a reduction in signaling overhead. For example, by providing additional information via the UCI (e.g., in addition to HARQ feedback, scheduling requests, and/or CSI), the UE may avoid transmitting such information via one or more additional uplink messages, thereby reducing signaling overhead and enabling efficient allocation and use of uplink resources in the wireless communications system.

The indication of the additional information, as well as the indication of the scheduling request, the indication of the HARQ feedback, the indication of the CSI, or any combination thereof, may be signaled via the UCI in accordance with various techniques based on a format of the PUCCH and a quantity of bits in each indication. As an example, different cyclic shift values may be used for transmitting at least one of the indication of the additional information, the indication of the scheduling request, or the indication of the HARQ feedback in cases where the PUCCH is configured as PUCCH format 0 and based on a quantity of bits for each of the indication of additional information, the indication of the scheduling request, and the indication of the HARQ feedback. Additionally, or alternatively, when the PUCCH is configured as PUCCH format 1, a particular set of resources and/or a particular modulation scheme may be used for transmitting the indication of the additional information, or the indication of the scheduling request, or the indication of the HARQ feedback, or any combination thereof. In other examples, such as when the PUCCH is configured as PUCCH formats 2, 3, or 4, information bits associated with the indication of the additional information may be multiplexed with respective information bits associated with the indication of the scheduling request, the indication of the HARQ feedback, the indication of the CSI, or any combination thereof. In such examples, one or more priority rules may determine an order (e.g., a priority order, a mapping order) for information bits for each indication that is included in the UCI.

Aspects of the disclosure are initially described in the context of wireless communications systems. Aspects of the disclosure are further described in the context of cyclic shift diagrams and process flows. Aspects of the disclosure are further illustrated by and described with reference to apparatus diagrams, system diagrams, and flowcharts that relate to indications for uplink resources via UCI.

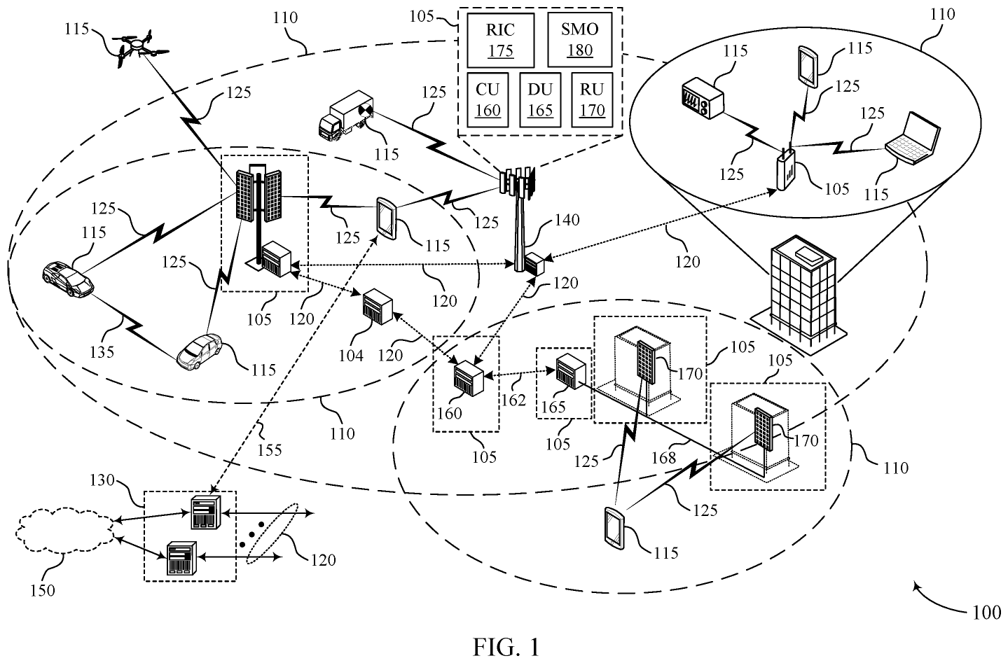

FIG. 1 illustrates an example of a wireless communications system 100 that supports indications for uplink resources via UCI in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another via a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

For instance, an access network (AN) or RAN may include communications between access nodes (e.g., an IAB donor), IAB nodes 104, and one or more UEs 115. The IAB donor may facilitate connection between the core network 130 and the AN (e.g., via a wired or wireless connection to the core network 130). That is, an IAB donor may refer to a RAN node with a wired or wireless connection to core network 130. The IAB donor may include a CU 160 and at least one DU 165 (e.g., and RU 170), in which case the CU 160 may communicate with the core network 130 via an interface (e.g., a backhaul link). IAB donor and IAB nodes 104 may communicate via an F1 interface according to a protocol that defines signaling messages (e.g., an F1 AP protocol). Additionally, or alternatively, the CU 160 may communicate with the core network via an interface, which may be an example of a portion of backhaul link, and may communicate with other CUs 160 (e.g., a CU 160 associated with an alternative IAB donor) via an Xn-C interface, which may be an example of a portion of a backhaul link.

In the case of the techniques described herein applied in the context of a disaggregated RAN architecture, one or more components of the disaggregated RAN architecture may be configured to support indications for uplink resources via UCI as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of TS=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1: M) system in which each UE 115 transmits to each of the other UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

The UEs 115 and the network entities 105 may support retransmissions of data to increase the likelihood that data is received successfully. HARQ feedback is one technique for increasing the likelihood that data is received correctly via a communication link (e.g., a communication link 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

The network entity 105 and the UE 115 may communicate one or more packets of data associated with various applications, such as extended reality (XR) applications. XR may generally refer to one or more immersive technologies including, for example, augmented reality (AR), virtual reality (VR), and mixed reality (MR). XR communications may have various traffic characteristics. For example, the UE 115 transmit various packet sizes and quantity of packets per transmission burst for XR applications. Further, the UE 115 may transmit, or receive, the burst of packets for XR applications in accordance with non-integer periods, where such non-integer periods may be based on the XR application. As an illustrative example, an XR application may operate at 1/60 frames per second (FPS), as such the UE may transmit, or receive, the burst of packets in accordance with a period of 16.67 milliseconds (ms) (e.g., 1/60 FPS=16.67 ms). As another illustrative example, the XR application may operate at 1/120 FPS, as such, the UE may transmit, or receive, the burst of packets in accordance with a period of 8.33 ms (e.g., 1/120 FPS=8.33 ms).

In some examples, the arrival times of the various XR traffic may vary, where such variance may be referred to as jitter. In some examples, the UE may experience jitter associated with XR traffic in various ranges, where one such range may by −4 to +4 ms. Additionally, the UE may transmit, or receive, XR traffic (e.g., packets of data) via multiple flows (e.g., channels). Each flow may be configured with different configurations, such as different periodicities, quality metrics, resources, or the like. Further, traffic associated with XR communications may have relatively lower packet delay budgets (PDB), such that the packets associated with XR traffic may not affect latency. That is, XR applications may disrupted or affected by increases in latency (e.g., the XR application may be degraded), and as such, the flows associated with XR traffic may have relatively lower PDBs.

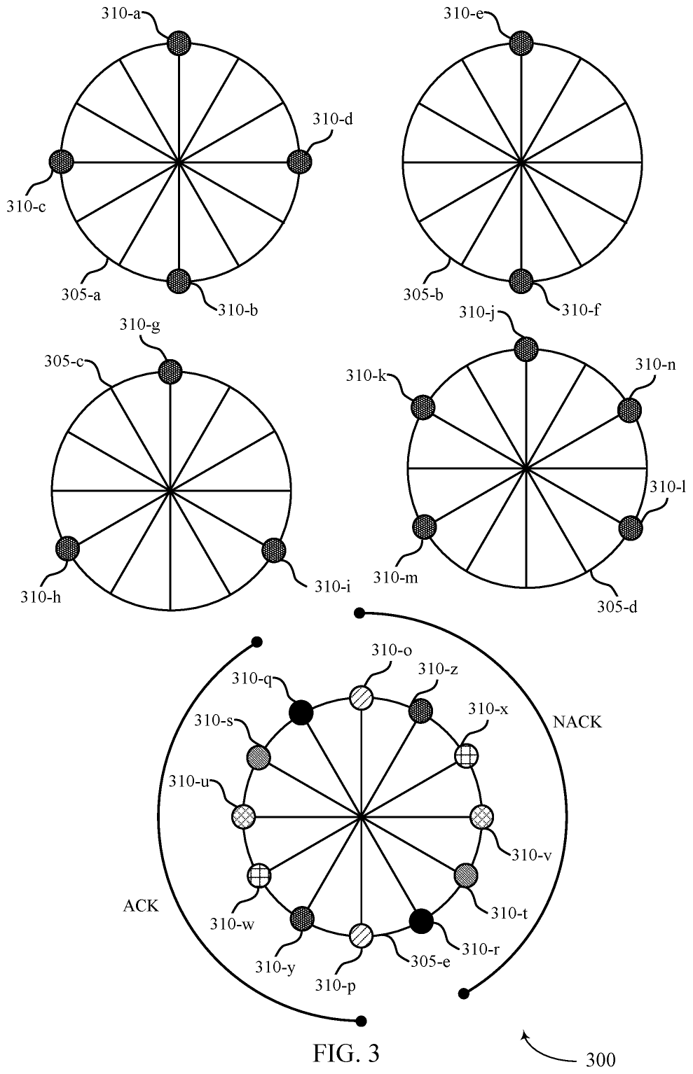

In some examples, the UE 115 and network entity 105 may include one or more enhancements related to capacity of the wireless communications system. For example, such enhancements may include multiple configured grant physical uplink shared channel (PUSCH) transmission occasions in a period of a single configured grant PUSCH configuration. Further, such enhancements may include dynamic indication of unused configured grant PUSCH occasions based on UCI by the UE 115, which may be further described herein with reference to FIGS. 3 through 6. Additionally, the network entity 105 and UE 115 may include buffer status report (BSR) enhancements, which may include at least an update to a buffer status table (e.g., new buffer status table). In some examples, the enhancements may include delaying the reporting of buffered data in uplink, provisioning of XR traffic assistance information for downlink and uplink (e.g., such as periodicity), discarding operation of packet data unit (PDU) sets, or a combination thereof. In some examples, the enhancements for XR awareness and detailed objectives may be further clarified.

In some cases, the UE 115 may receive a configured grant indicating one or more periodic uplink resources, such that UE 115 may transmit uplink data, via the periodic uplink resources, without transmitting a scheduling request. That is, the UE 115 may receive the configured grant and use the uplink resources in the configured grant to transmit uplink data in accordance with the respective periodicities of the uplink resources, thereby reducing the latency associated with transmitting scheduling requests. Further, the UE 115 may autonomously determine to skip (e.g., refrain from transmitting data on) an occasion of an uplink resource, at times when the UE 115 may not have data to transmit. In such cases, the network entity 105 may continue to monitor the occasion of the uplink resource for an uplink message from the UE 115 without receiving any uplink messages (e.g., because the UE 115 skipped transmission of data on that occasion). As such, if the UE 115 autonomously determines to skip one or more uplink resources in the configured grant, the network entity 105 may not have an indication of such skipped resources, leading to an inefficient use of resources, increased latency, or the like.

The wireless communications system 100 may support dynamic indications of skipped (e.g., unused) uplink resources to the network entity 105, for example, via UCI, such that the network entity 105 may reschedule such resources for other UEs 115. For example, the UE 115 may receive a configuration for UCI that supports an indication of HARQ, an indication of a scheduling request, an indication of CSI, and an indication additional information, where the indication of additional information indicates that the UE 115 is to skip one or more uplink resources configured for the UE 115. In accordance with the configuration, the UE 115 may transmit the UCI via a PUCCH, where the UCI includes at least one of the indication of the HARQ feedback, the indication of the scheduling request, the indication of the CSI, or the indication of additional information (e.g., the indication of skipped resources). In some aspects, the UE may transmit the additional information via the UCI in accordance with various techniques, for example, based on a format of the PUCCH that carries the UCI, or based on a quantity of bits of respective information included in the UCI, or both.

In this way, the UE 115 may dynamically transmit the indication of additional information (e.g., an indication of skipped resources) to the network entity 105, thereby improving coordination between devices and enabling more efficient utilization of communication resources. For example, by transmitting the additional information in the UCI, the UE 115 may indicate, to the network entity 105, which uplink resources may be skipped, thereby improving coordination between the UE 115 and network entity 105. Further, by transmitting the additional information, the network entity 105 may reschedule the skipped resources for use by other UEs 115, resulting in more efficient utilization of communication resources in the wireless communications system 100.

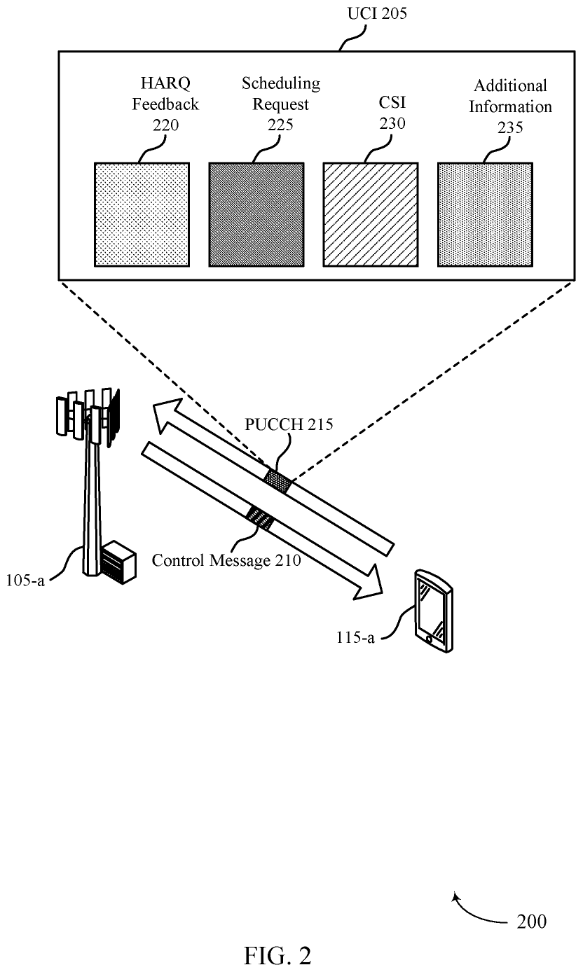

FIG. 2 illustrates an example of a wireless communications system 200 that supports indications for uplink resources via UCI in accordance with one or more aspects of the present disclosure. The wireless communications system 200 may implement, or be implemented by, aspects of the wireless communications system 100 as described herein. For example, the wireless communications system 200 may include a network entity 105-a and a UE 115-a, which may be examples of a network entity 105 and a UE 115 as described herein with reference to FIG. 1.

In some cases, the UE 115-a and the network entity 105-a may communicate control information (e.g., such as UCI 205 or a control message 210) via various control channels, such as a physical downlink control channel (PDCCH) or a PUCCH 215. In such cases, the UE 115-a and the network entity 105-a may transmit such control information via various formats associated with each channel, where each format includes respective parameters to be used for transmissions. For example, the UE 115-a may transmit the UCI 205 via the PUCCH 215 in accordance with one of multiple PUCCH formats (e.g., PUCCH format 0, PUCCH format 1, PUCCH format 2, PUCCH format 3, PUCCH format 4), where each PUCCH format is associated with a respective set of parameters. Such parameters for each PUCCH format may include a quantity of bits, a waveform, a quantity of symbols, a quantity of resource blocks, information to be carried, a method of transmission, or the like.

For example, using PUCCH format 0, the UE 115-a may transmit the UCI 205 including a threshold quantity of bits (e.g., at most two bits), using a waveform associated with a sequence (e.g., a computer-generated sequence (CGS), using a quantity of time resources (e.g., up to two symbols), and via a quantity of frequency resources (e.g., one resource block). In such examples, the UE 115-a may transmit an indication of HARQ feedback 220 (e.g., HARQ acknowledgment (ACK) or negative ACK (NACK) (HARQ-ACK/NACK)) and an indication of a scheduling request 225 via respective bits in the UCI 205. That is, if the UE 115-a transmits the UCI 205 via the PUCCH 215 configured with the PUCCH format 0, then the UE 115-a may transmit the indication of the HARQ feedback 220 and/or the indication of the scheduling request 225 using at most two bits. Further, using PUCCH format 0, the UE 115-a may transmit the UCI 205 using a phase rotation of the sequence used to transmit the UCI 205 (e.g., signal).

Using PUCCH format 1, the UE 115-a may transmit the UCI 205 including a threshold quantity of bits (e.g., at most two bits), using the CGS waveform, using a quantity of time resources (e.g., a quantity of between 4 and 14 symbols), and via a quantity of frequency resources (e.g., one resource block). In such examples, the UE 115-a may transmit the indication of HARQ feedback 220 and/or the indication of the scheduling request 225 via respective bits in the UCI 205. That is, if the UE 115-a transmits the UCI 205 via the PUCCH 215 configured with the PUCCH format 1, then the UE 115-a may transmit the indication of HARQ feedback 220 or the indication of the scheduling request 225, or both using at most two bits. Further, using PUCCH format 1, the UE 115-a may transmit the UCI 205 with a binary phase shift keying (BPSK) modulation scheme or a quadrature phase shift keying (QPSK) modulation scheme, using a phase rotation of the sequence used to transmit the UCI 205, and interlacing the sequence of the UCI 205 with a demodulation reference signal (DMRS) in the time domain.

Using PUCCH format 2, the UE 115-a may transmit the UCI 205 including some quantity of bits (e.g., at least two bits), using an OFDM waveform, via a quantity of time resources (e.g., a quantity of up to two symbols), and via a quantity of frequency resources (e.g., a quantity of up to 16 resource blocks). In such examples, the UE 115-a may transmit UCI 205 that includes the indication of the HARQ feedback 220, the indication of the scheduling request 225, or an indication of CSI 230, or any combination thereof. Further, using the PUCCH format 2, the UE 115-a may transmit the UCI 205 with a cyclic redundancy check (CRC), with a coding scheme, using the QPSK modulation scheme, and interlacing the sequence of the UCI 205 with the DMRS in the frequency domain. In some examples, if the bits to be encoded in the UCI 205 are relatively large (e.g., causing relatively increased overhead and latency), then the UE 115-a may prioritize the bits associated with the indication of the HARQ feedback 220 and drop the bits associated with the indication of the CSI 230.

Using PUCCH format 3, the UE 115-a may transmit the UCI 205 including a threshold quantity of bits (e.g., at least two bits (e.g., two bits or greater)), using a DFT-S-OFDM waveform, via a quantity of time resources (e.g., a quantity of between 4 and 14 symbols), and via a quantity of frequency resources (e.g., a quantity of between 1 and 6, 8 and 10, 12, 15, or 16 resource blocks (e.g., 1-6, 8-10, 12, 15, 16 frequency resources)). In such examples, the UE 115-a may transmit UCI 205 that includes the indication of the HARQ feedback 220, the indication of the scheduling request 225, the indication of CSI 230, or any combination thereof. Further, using the PUCCH format 3, the UE 115-a may transmit the UCI 205 with a cyclic redundancy check (CRC), with a coding scheme, using the QPSK modulation scheme, and multiplexing the UCI 205 with the DMRS in the time domain. Additionally, the UE 115-a may map priorities of the indication of the HARQ feedback 220, the indication of the scheduling request 225, and the indication of the CSI 230, where the mapping in the UCI 205 prioritizes the indication of HARQ feedback 220, the indication of the scheduling request 225, and the indication of CSI 230. In some examples, each indication may be jointly coded and mapped to the DMRS locations (e.g., in time, in frequency, or both).

Using PUCCH format 4, the UE 115-a may transmit the UCI 205 including a threshold quantity of bits (e.g., at least two bits (e.g., two bits or greater)), using a DFT-S-OFDM waveform, via a quantity of time resources (e.g., a quantity of between 4 and 14 symbols), and via a quantity of frequency resources (e.g., one resource block). In such examples, the UE 115-a may transmit UCI 205 that includes the indication of the HARQ feedback 220, the indication of the scheduling request 225, and the indication of CSI 230 (e.g., all UCI 205). Further, using the PUCCH format 4, the UE 115-a may transmit the UCI 205 with a cyclic redundancy check (CRC), with a coding scheme, using the QPSK modulation scheme, spreading, and interlacing the sequence of the UCI 205 with the DMRS in the frequency domain. Additionally, the UE 115-a may map priorities of the indication of the HARQ feedback 220, the indication of the scheduling request 225, and the indication of the CSI 230, where the mapping in the UCI 205 prioritizes the indication of HARQ feedback 220, the indication of the scheduling request 225, and the indication of CSI 230. In some examples, each indication may be jointly coded and mapped relatively close to the DMRS locations (e.g., in time, in frequency, or both).

In some cases, the UE 115-a and the network entity 105-a may support multiple configured grant PUSCH transmission occasions in a period of a single configured grant configuration, where one or more configure grant configurations may be indicated to the UE 115-a. For example, the UE 115-a may receive a configured grant configuration indicating one or more periodic uplink resources, such that the UE 115-a may transmit uplink data via the periodic uplink resources, without transmitting a scheduling request. That is, the UE 115-a may receive the configured grant configuration and use the uplink resources of the configured grant configuration to transmit uplink data in accordance with the respective periodicities of the uplink resources, thereby reducing the latency associated with transmitting scheduling requests as well as signaling overhead for corresponding uplink grants corresponding to the scheduling requests.

In some examples, the UE 115-a may autonomously determine to skip (e.g., refrain from transmitting data using) an occasion of an uplink resource, such as at times when the UE 115-a may not have data to transmit. In such cases, the network entity 105-a may continue to monitor the occasion of the uplink resource for an uplink message from the UE 115-a without receiving any uplink messages (e.g., because the UE 115-a skipped transmission of data on that occasion). As such, if the UE 115-a autonomously determines to skip one or more uplink resources in the configured grant, the network entity 105-a may not have an indication of such skipped resources, leading to an inefficient use of resources, increased latency, or the like. That is, conventional techniques may not provide a design or signaling for carrying configured grant skipping indications using UCI sent via the PUCCH 215.

In some implementations, the UE 115-a may support a dynamic indication of the unused (e.g., skipped) configured grant PUSCH occasions via the UCI 205 (e.g., a configured grant UCI or new UCI). The UE 115-a may transmit the dynamic indication as part of the UCI in a PUSCH or the PUCCH 215. As such, the techniques of the present disclosure may describe designs for the PUCCH 215 for carrying the configured grant skipping indication. That is, the techniques described herein may provide examples for transmitting an indication of additional information 235 (e.g., indicating one or more skipped or unused uplink resources) as part of the UCI 205 via the PUCCH 215. The additional information 235 (e.g., one or more additional bits of the UCI 205) is described herein as including a configured grant skipping indication (which may be referred to as CGskip, indicating one or more configured grant resources occasions are to be unused). It is understood, however, that other types of signaling and information not explicitly described herein may be included in the additional information. As such, the example of the skipping indication in the UCI 205 is provided for the sake of clarity, and other or additional indications may be transmitted using additional bits included in the UCI 205.

In some examples, the network entity 105-a may configure, via a control message 210 (e.g., RRC signaling), the PUCCH 215 to include the additional information 235 as part of the UCI 205, where the additional information 235 may include one or more bits of information that are transmitted using one of the multiple PUCCH formats (e.g., PUCCH format 0, PUCCH format 1, PUCCH format 2, PUCCH format 3, PUCCH format 4, or the like), which may be configured via control signaling (e.g., such as a PUCCH-Config). Additionally, or alternatively, the network entity 105-a may transmit the control message 210 (or another control message 210) that includes a configuration for the UCI 205 that supports a quantity of bits (e.g., Nₛₖᵢₚ) for the indication of additional information 235, a quantity of bits (e.g., N_{HARQ}) for the indication of the HARQ feedback 220, a quantity of bits (e.g., N_{SR}) for the indication of the scheduling request 225, and a quantity of bits (e.g., N_{CSI}) for the indication of the CSI 230.

Further, the network entity 105-a may indicate, via the configuration in the control message 210, whether the PUCCH 215 is configured for transmitting, via the UCI 205, both the indication of the scheduling request 225 and the indication of the additional information 235. For example, if the UE 115-a transmits the indication of additional information 235, then the indication of the scheduling request 225 may not be required since the UE 115-a is indicating that there is not data to be sent. In some examples, the network entity 105-a may indicate that the UE 115-a is to treat the indication of the scheduling request 225 and the indication of the additional information (e.g., CGskip, indication of skipped and/or unused resources) separately. That is, the network entity 105-a may indicate that the UE 115-a may transmit both the indication of the scheduling request 225 and the indication of the additional information 235 via the UCI 205. In some other examples, the network entity 105-a may indicate that the UE 115-a is to exclude the indication of the scheduling request 225 from the UCI 205, in the case that the indication of the additional information 235 is to be transmitted. In some other examples, the network entity 105-a may indicate that the UE 115-a is to exclude the indication of the indication of additional information 235 from the UCI 205, in the case that the indication of the scheduling request 225 is to be transmitted.

The network entity 105-a may indicate, via a configuration (e.g., PUCCH-Config) in a control message 210, which of the PUCCH formats the UE 115-a is to use, for example, for transmitting the UCI 205, including the indication of the additional information 235. In some examples, the network entity 105-a may indicate that the UE 115-a is to use the PUCCH format 0 for the PUCCH 215. In such examples, the UE 115-a may transmit the UCI 205 via the PUCCH 215 configured for PUCCH format 0, where the PUCCH format 0 may be configured to include (e.g., carry) the indication of the additional information 235 in addition to the indication of the HARQ feedback 220 and the indication of the scheduling request 225. For example, the PUCCH format 0 may be configured to include the UCI 205 having up to three bits of information, such that any combination of the indication of the additional information 235, the indication of the HARQ feedback 220, or the indication of the scheduling request 225 may be transmitted via the PUCCH 215.

In one example, the UE 115-a may transmit, via the UCI 205, only the indication of the additional information 235, where the indication of the additional information 235 may be represented by up to three bits (e.g., Nₛₖᵢₚ is up to three bits). In another example, the UE 115-a may transmit, via the UCI 205, both the indication of the HARQ feedback 220 and the indication of additional information 235, where both indications may be represented by up to three bits (e.g., Nₛₖᵢₚ+N_{HARQ} is no greater than three bits). In another example, the UE 115-a may transmit, via the UCI 205, both the indication of the scheduling request 225 and the indication of additional information 235, where both indications may be represented by up to three bits (e.g., Nₛₖᵢₚ+N_{SR} is no greater than three bits). In another example, the UE 115-a may transmit, via the UCI 205, the indication of the HARQ feedback 220, the indication of the scheduling request 225, and the indication of additional information 235, where the indications may be represented by up to three bits (e.g., Nₛₖᵢₚ+N_{HARQ}+N_{SR} is no greater than three bits).

In such examples, if the UE 115-a is to transmit the indication of additional information 235 via a single bit (e.g., Nₛₖᵢₚ=1), then UE 115-a may transmit, via the indication of additional information 235, an indication that the UE 115-a is not skipping configured grant resources implicitly (e.g., similar to implicit scheduling request indications, such as with negative scheduling requests) or explicitly (e.g., using a dedicated cyclic shift value). That is, the UE 115-a may transmit, via the indication of additional information 235 in the UCI 205, an explicit indication to the network entity 105-a that the UE 115-a is to skip one or more resources. However, in cases when the UE 115-a is not skipping one or more resources, the UE 115-a may implicitly or explicitly indicate that the UE 115-a is not skipping one or more resources. In such examples, the network entity 105-a may indicate, via the configuration in the control message 210, whether the UE 115-a is to explicitly or implicitly transmit the indication of the additional information 235. Further, using the PUCCH format 0, the UE 115-a may determine a cyclic shift from a multiple of cyclic shifts associated with UCI 205 based on whether the UCI 205 includes the indication of the HARQ feedback 220, the indication of the scheduling request 225, and the indication of the additional information 235. Such techniques may be further described herein with reference to FIGS. 3 through 5.

In some other examples, the network entity 105-a may indicate for the UE 115-a to use the PUCCH format 1 for the transmission of the UCI 205 via the PUCCH 215. In such examples, the network entity 105-a may additionally indicate, via the configuration in the control message 210, a quantity of bits to use for the UCI 205 and whether the indication to not skip resources is to be an implicit indication or explicit indication.

For example, the network entity 105-a may indicate, via the configuration in the control message 210, that the UE 115-a is to use a single bit of information (e.g., Nₛₖᵢₚ=1) for the indication of additional information 235 and implicitly indicate that the UE 115-a is not skipping one or more resources. For such an implicit indication, unless an indication that one or more resources are to be skipped (e.g., are to be unused by the UE 115-a), then the network entity 105-a may determine (e.g., assume) that the UE 115-a is not skipping resources (e.g., the UE 115-a is using each of the one or more uplink resources associated with a configured grant). In such examples, if the UE 115-a is to only transmit the additional information 235 via the UCI 205, then the UE 115-a may transmit the UCI 205 using a BPSK modulation scheme, where the indication of additional information 235 includes the single bit of information (e.g., a bit indicating the UE 115-a is to skip one or more uplink resource). As such, to indicate the UE 115-a is not skipping one or more uplink resources, the UE 115-a may not transmit the additional information 235 via the UCI 205, thereby providing an implicit indication to the network entity 105-a.

In some other examples, if the UE 115-a is to transmit the indication of additional information 235 and the indication of HARQ feedback 220 via the UCI 205, then the UE 115-a may transmit the UCI 205 using an uplink resource, where the indication of additional information 235 includes the single bit of information. In such examples, the uplink resource may be allocated for the indication of additional information 235 (e.g., a CGskip resource). As such, to indicate the UE 115-a is not skipping one or more uplink resources, the UE 115-a may not transmit the additional information 235 via the UCI 205, thereby providing an implicit indication to the network entity 105-a.

Additionally, or Alternatively, in some examples, if the UE 115-a is to transmit the indication of additional information 235 and the indication of the scheduling request 225 via the UCI 205, then the UE 115-a may transmit the indication of additional information 235 and the indication of the scheduling request 225 using an uplink resource, where the indication of additional information 235 includes the single bit of information. In such examples, the uplink resource may be allocated for the indication of additional information 235 (e.g., a CGskip resource) or for the indication of the scheduling request 225 (e.g., scheduling request resource). As such, to indicate the UE 115-a is not skipping one or more uplink resources, the UE 115-a may refrain from transmitting (e.g., not transmit) the additional information 235 via the UCI 205, thereby providing an implicit indication to the network entity 105-a.

Additionally, or Alternatively, if the UE 115-a is to transmit the indication of additional information 235, the indication of the scheduling request 225, and the indication of the HARQ feedback 220 via the UCI 205, then the UE 115-a may transmit the UCI 205 using an uplink resource, where the indication of additional information 235 includes the single bit of information (e.g., a bit indicating the UE 115-a is to skip one or more resources). In such examples, the uplink resource may be allocated for the indication of additional information 235 (e.g., a CGskip resource) or for the indication of the scheduling request 225 (e.g., scheduling request resource). As such, to indicate the UE 115-a is not skipping one or more uplink resources, the UE 115-a may not transmit the additional information 235 via the UCI 205, thereby providing an implicit indication to the network entity 105-a.

In some other examples, the network entity 105-a may indicate, via the configuration in the control message 210, that the UE 115-a is to use a single bit of information for the indication of the additional information 235 and explicitly indicate that the UE 115-a is not skipping one or more resources. In such examples, if the UE 115-a is to transmit only the indication of additional information 235 via the UCI 205, then the UE 115-a may transmit the UCI 205 using a BPSK modulation scheme, where the indication of additional information includes a single bit of information explicitly indicating whether the UE 115-a is to skip one or more uplink resources configured for the UE 115-a. As an illustrative example, the UE 115-a may transmit a ‘1’ as the indication of additional information 235 for cases when the UE 115-a is to skip one or more uplink resources. Similarly, the UE 115-a may transmit a ‘0’ as the indication of the additional information 235 for cases when the UE 115-a is not skipping one or more uplink resources.

Alternatively, if the UE 115-a is to transmit the indication of additional information 235 and the indication of the HARQ feedback 220 via the UCI 205, then the UE 115-a may transmit the UCI 205 using a QPSK modulation scheme, where the indication of additional information includes a single bit of information explicitly indicating whether the UE 115-a is to skip one or more uplink resources configured for the UE 115-a.

In some other examples, if the UE 115-a is to transmit the indication of additional information 235 and the indication of the scheduling request 225 via the UCI 205, then the UE 115-a may transmit the UCI 205 using an uplink resource, where the indication of additional information includes a single bit of information explicitly indicating whether the UE 115-a is to skip one or more uplink resources configured for the UE 115-a. In such examples, the uplink resource may be allocated for the indication of the scheduling request 225. That is, the UE 115-a may transmit the indication of the additional information 235 and the indication of the scheduling request 225 similarly to the transmission of the indication of HARQ feedback 220 and the indication of the scheduling request 225, where the one or more bits of the indication of HARQ feedback 220 may be replaced by the single bit of information associated with the indication of additional information 235.

Alternatively, if the UE 115-a is to transmit the indication of additional information 235, the indication of the scheduling request 225 (e.g., a positive scheduling request), and the indication of the HARQ feedback 220 via the UCI 205, then the UE 115-a may transmit the UCI 205 using an uplink resource indicating in the control message 210 and using a QPSK modulation scheme, where the indication of additional information includes a single bit of information explicitly indicating whether the UE 115-a is to skip one or more uplink resources configured for the UE 115-a. In such examples, the uplink resource may be allocated for the indication of the scheduling request 225.

In some examples, the network entity 105-a may indicate, via the configuration in the control message 210, that the UE 115-a is to use at least two bits of information for the indication of the additional information 235 (e.g., Nₛₖᵢₚ>1). In such examples, the UE 115-a transmit only the indication of the additional information 235 in the UCI 205 or the indication of the additional information 235 and the indication of the scheduling request 225 via the UCI 205. That is, in such examples, the UE 115-a may not be able to transmit the indication of the additional information 235 with the indication of the HARQ feedback 220 due to the quantity of bits allocated for the indication of additional information 235 and the quantity of bits required for the indication of the HARQ feedback 220 satisfying the bit limit associated with the PUCCH format 0.

As such, if the UE 115-a is to transmit only the indication of the additional information 235 via the UCI 205, then the UE 115-a may transmit the UCI 205 using a QPSK modulation scheme. In such examples, the UE 115-a may include in the indication of additional information 235 multiple bits of information to explicitly indicate whether the UE 115-a is to skip one or more uplink resources configured for the UE 115-a.

Alternatively, if the UE 115-a is to transmit the indication of additional information 235 and the indication of the scheduling request 225 via the UCI 205, then the UE 115-a may transmit the UCI 205 using an uplink resource. As such, the UE 115-a may include, in the indication of additional information 235, multiple bits of information explicitly indicating whether the UE 115-a is to skip one or more uplink resources configured for the UE 115-a. In such examples, the uplink resource may be allocated for the indication of the scheduling request 225. That is, the UE 115-a may transmit the indication of the additional information 235 and the indication of the scheduling request 225 similarly to the transmission of the indication of HARQ feedback 220 and the indication of the scheduling request 225, where the one or more bits of the indication of HARQ feedback 220 may be replaced by the multiple bits of information associated with the indication of additional information 235.

In some other examples, the network entity 105-a may indicate, via the configuration in the control message 210, that the UE 115-a is to use the PUCCH format 2 for transmission of the UCI 205 via the PUCCH 215. In such examples, the UE 115-a may transmit the indication of the HARQ feedback 220, the indication of the scheduling request 225, the indication of the CSI 230, and the indication of the additional information 235 via one or more bits in the UCI. As such, the UE 115-a may multiplex one or more bits of the indication of the additional information 235 with one or more bits of the indication of the HARQ feedback 220, one or more bits of the indication of the scheduling request 225, and one or more bits of the indication of the CSI 230.

Further, the UE 115-a may map the one or more bits of the indication of additional information 235, the one or more bits of the indication of HARQ feedback 220, the one or more bits of the indication of scheduling request 225, and the one or more bits of the indication of the CSI 230 with respective priorities. In such examples, the priority of the one or more bits of the indication of HARQ feedback 220 may be higher than the priority of the one or more bits of the indication of additional information 235, which may be higher than the priority of the one or more bits of the indication of the CSI 230. That is, the priority order (e.g., which bits are prioritized if the bits to be encoded are too large) may be the one or more bits of the indication of HARQ feedback 220 followed by the one or more bits of the indication of additional information 235 followed by the one or more bits of the indication of the CSI 230.

In some other examples, the network entity 105-a may indicate, via the configuration in the control message 210, that the UE 115-a is to use the PUCCH format 3 or 4 for transmission of the UCI 205 via the PUCCH 215. In such examples, the UE 115-a may transmit the indication of the HARQ feedback 220, the indication of the scheduling request 225, the indication of the CSI 230, and the indication of the additional information 235 via one or more bits in the UCI. As such, the UE 115-a may multiplex and jointly code one or more bits of the indication of the additional information 235 with one or more bits of the indication of the HARQ feedback 220, one or more bits of the indication of the scheduling request 225, and one or more bits of the indication of the CSI 230.

Further, the UE 115-a may map the one or more bits of the indication of additional information 235, the one or more bits of the indication of HARQ feedback 220, the one or more bits of the indication of scheduling request 225, and the one or more bits of the indication of the CSI 230 with respective priorities. In such examples, the priority of the one or more bits of the indication of HARQ feedback 220 may be higher than the priority of the one or more bits of the indication of additional information 235, which may be higher than the priority of the one or more bits of the indication of the CSI 230. That is, the priority order (e.g., which bits are closer to a DMRS) may be the one or more bits of the indication of HARQ feedback 220 followed by the one or more bits of the indication of additional information 235 followed by the one or more bits of the indication of the CSI 230 (e.g., CSI part 1 bits).

In accordance with the configuration indicated in the control message 210, the UE 115-a may transmit the UCI 205 via the PUCCH 215, where the UCI 205 may include the indication of the additional information 235. In this way, the UE 115-a may improve coordination between devices and enable more efficient utilization of communication resources. For example, by transmitting the indication of additional information 235 in the UCI 205, the UE 115-a may indicate, to the network entity 105-a, which uplink resources may be skipped, thereby improving coordination between the UE 115-a and network entity 105-a. Further, by transmitting the indication of the additional information 235, the network entity 105-a may be able to reschedule the skipped resources for use by other UEs 115, resulting in more efficient utilization of communication resources in the wireless communications system 200.

FIG. 3 illustrates an example of a diagram 300 that supports indications for uplink resources via UCI in accordance with one or more aspects of the present disclosure. The diagram 300 may be implemented by aspects of the wireless communications system 100 and the wireless communications system 200. For example, the diagram 300 may be implemented by a UE 115 and a network entity 105 as described herein with reference to FIGS. 1 and 2. For example, the UE 115 may implement aspects of the diagram 400 in order to transmit an indication of additional information via UCI in a PUCCH using a PUCCH format 0, where the indication of additional information includes a single bit of information.

The diagram 300 may include various cyclic shift diagrams 305, where each cyclic shift diagram 305 may include one or more cyclic shifts 310. In some aspects, each position of a respective cyclic shift illustrated by the cyclic shift diagrams 305 may correspond to a value of a cyclic shift. Using PUCCH format 0, the UE 115-a may generate a sequence (e.g., a signal) using a specific cyclic shift 310 out of the cyclic shift diagram 305 (e.g., a cyclic shift 310 may be applied to a base sequence for the transmission of PUCCH including UCI), where each cyclic shift may be mapped to different indications or information. As such, after receipt of the sequence, the network entity 105 may decode the sequence and detect (e.g., determine) the cyclic shift 310 used for the sequence. Based on the detecting the cyclic shift 310 that was used, the network entity 105 determine the information based on the predefined mapping (e.g., as predefined in a standards body such as the 3rd generation partnership project (3GPP)). Further, each UE 115 in a wireless communications system may use respective initial cyclic shift values to determine which cyclic shift 310 to use for generation of the sequence. In this way, multiple UEs 115 may transmit indications via the cyclic shifts 310 without interference or confusion at the network entity 105.

In the example of the cyclic shift diagram 305-a, the UE 115 may transmit UCI via the PUCCH format 0, where the UCI includes an indication of a scheduling request (e.g., a positive scheduling request). Thus, as predefined or preconfigured by the network entity 105, the UE 115 may generate a sequence using a cyclic shift 310-a (e.g., an initial cyclic shift), where the cyclic shift 310-a may be mapped to, or associated with, the indication of the scheduling request. In some aspects, an initial cyclic shift may correspond to a value of 0. Additionally, or alternatively, the initial cyclic shift value may be some other value, and the initial cyclic shift value may be UE-specific. The UE 115 may transmit the sequence, based on the cyclic shift 310-a, where the network entity 105 may receive the sequence, detect the cyclic shift 310-a, and identify the indication of the positive scheduling request based on the preconfigured mapping. However, it is to be understood, that the cyclic shift 310-a may be mapped to any other cyclic shift 310 in the cyclic shift diagram 305-a in accordance with the initial cyclic shift value of each UE 115 in the wireless communications system.

In some other examples of the cyclic shift diagram 305-a, if the UE 115 is to transmit UCI, using the PUCCH format 0, that includes an indication of the positive scheduling request and an indication of HARQ feedback, then the UE 115 may determine a cyclic shift 310 from one of four cyclic shifts 310 (e.g., the cyclic shift 310-a, a cyclic shift 310-b, a cyclic shift 310-c, and a cyclic shift 310-d), where each cyclic shift 310 indicates respective information. For example, the cyclic shift 310-a may be mapped to an indication of a NACK, the cyclic shift 310-b (e.g., a value of 6, a cyclic shift value having some offset from an initial cyclic shift value) may be mapped to an indication of an ACK, the cyclic shift 310-c (e.g., a value of 9, a cyclic shift value having some offset from an initial cyclic shift value) may be mapped to an indication of an ACK and a positive scheduling request, and the cyclic shift 310-d (e.g., a value of 3, a cyclic shift value having some offset from an initial cyclic shift value) may be mapped to an indication of a NACK and a positive scheduling request. In this way, the UE 115 may indicate one of the four possibilities of HARQ feedback and scheduling requests using a cyclic shift 310.

In some other examples of the cyclic shift diagram 305-a, if the UE is to transmit UCI, using the PUCCH Format 0, that includes an indication of the positive scheduling request and an indication of HARQ feedback using two bits of information, then the UE 115 may determine a cyclic shift 310 from one of eight cyclic shifts 310 (e.g., four additional cyclic shifts not shown). As an illustrative example, the cyclic shift 310-a may be associated with two bits of HARQ feedback, where each bit indicates a respective ACK or NACK. Further, the cyclic shift 310-b may be associated with the indication of the positive scheduling request.

In accordance with the techniques described herein, the UE 115 may receive a control message including a configuration for UCI that supports an indication of additional information. As such, the configuration may indicate that the UE is to use the PUCCH format 0 for the transmission of the UCI, that a single bit of information is to be used for the indication of additional information, and whether the UE 115 is to transmit an implicit or explicit indication when not skipping one or more uplink resources. In such examples, each cyclic shift 310 may be orthogonalized such that each cyclic shift 310 may mapped to the respective indications in the UCI. That is, each cyclic shift 310 in a cyclic shift diagram 305 may be mapped to, or associated with, a combination of the indication of HARQ feedback, the indication of the positive scheduling request, and the indication of the additional information. As such, based on the cyclic shift 310 used for the generation of the sequence for the UCI, the network entity 105 may receive each indication in the UCI.

For example, if the UE 115 is to transmit only the indication of additional information via the UCI, then the UE 115 may determine the cyclic shift 310-e (e.g., an initial cyclic shift value) of the cyclic shift diagram 305-b to generate the sequence of the UCI, where the cyclic shift 310-e may be mapped to, or associated with, the indication of additional information (e.g., the UE 115 is to skip one or more uplink resources). If the UE 115 is configured to explicitly indicate that the UE 115 is not skipping one or more uplink resources, then the UE 115 may determine to use the cyclic shift 310-f, which may be mapped to, or associated with, an indication of no skipping. In such cases, the cyclic shift 310-e may have a value of 0 and the cyclic shift 310-f may have a value of 6. In such examples, the indication to skip, and indication to not skip, may be opposite cyclic shifts 310 (e.g., relative to the cyclic shifts 310 illustrated by the respective cyclic shift diagrams 305). Alternatively, if the UE 115 is configured to implicitly indicate that the UE 115 is not skipping one or more uplink resources, and only the additional information is to be sent via the UCI (e.g., the UE 115 does not have HARQ feedback or a positive scheduling request to transmit via the UCI), then the UE 115 may not transmit the UCI.

In some examples, the UE 115 may be configured to implicitly indicate that the UE 115 is not skipping one or more uplink resources. As such, if the UE 115 is to transmit the indication of additional information, the indication of the positive scheduling request, or both, via the UCI, then the UE 115 may determine a cyclic shift 310 from the cyclic shift diagram 305-c. For example, the cyclic shift 310-g (e.g., a value of 0, an initial cyclic shift value) may be mapped to, or associated with only the indication of the positive scheduling request, while the cyclic shift 310-h (e.g., a value of 8, a cyclic shift value having some offset from an initial cyclic shift value) may be mapped to, or associated with, only the indication of the additional information (e.g., indication to skip one or more uplink resources). Likewise, the cyclic shift 310-i (e.g., a value of 4, a cyclic shift value having some offset from an initial cyclic shift value) may be mapped to, or associated with, both the indication of the additional information and the indication of the positive scheduling request. Thus, based on the indications to be sent from the UE 115, the UE 115 may determine the corresponding cyclic shift 310 to use for generation of the sequence for the UCI.

In some other examples, the UE 115 may be configured to explicitly indicate that the UE 115 is not skipping one or more uplink resources. As such, if the UE 115 is to transmit the indication of additional information, the indication of a positive scheduling request, or both via the UCI, then the UE 115 determine a cyclic shift 310 from the cyclic shift diagram 305-d. For example, the cyclic shift 310-j (e.g., a value of 0, an initial cyclic shift value) may be mapped to, or associated with, the indication of the positive scheduling request. Additionally, the cyclic shift 310-k (e.g., a value of 10, a cyclic shift value having some offset from an initial cyclic shift value) may be mapped to, or associated with, an indication that the UE 115 is not skipping one or more uplink resources, while the cyclic shift 310-1 (e.g., opposite cyclic shift 310) (e.g., a value of 4, a cyclic shift value having some offset from an initial cyclic shift value) may be mapped to, or associated with, the indication of additional information (e.g., the UE 115 is to skip one or more uplink resources). Similarly, the cyclic shift 310-m (e.g., a value of 8, a cyclic shift value having some offset from an initial cyclic shift value) may be mapped to, or associated with, both the indication of the positive scheduling request and the indication that the UE 115 is not skipping one or more uplink resources, while the cyclic shift 310-n (e.g., a value of 2, a cyclic shift value having some offset from an initial cyclic shift value) may be mapped to, or associated with, both the indication of the additional information and the indication of the positive scheduling request. Thus, based on the indications to be sent from the UE 115, the UE 115 may determine the corresponding cyclic shift 310 to use for generation of the sequence for the UCI.

In some examples, if the UE 115 transmits the indication of the additional information, the indication of the scheduling request (e.g., the positive scheduling request), the indication of the HARQ feedback, or a combination thereof, via the UCI, then the UE 115 may determine a cyclic shift 310 from the cyclic shift diagram 305-e. As such, the indication of the HARQ feedback may be a singly bit (e.g., include two opposite cyclic shifts: one for ACK and one for NACK), where each cyclic shift 310 in the cyclic shift diagram 305-e may be mapped to, or associated with, one of eight possible combinations of the indications. The two opposite shifts may be selected based on the multiplexing scheme (e.g., whether the UCI will include the indication of the additional information or the indication of the positive scheduling request).

As an illustrative example, the cyclic shift 310-o (e.g., a value of 0, an initial cyclic shift value) may be mapped to, or associated with, only a NACK of the indication of HARQ feedback, while the cyclic shift 310-p (e.g., opposite cyclic shift 310) (e.g., a value of 6, a cyclic shift value having some offset from an initial cyclic shift value) may be mapped to, or associated with, only an ACK of the indication of HARQ feedback. Similarly, the cyclic shift 310-q (e.g., a value of 11, a cyclic shift value having some offset from an initial cyclic shift value) may be mapped to, or associated with, both the indication of ACK and an indication that the UE 115 is not skipping one or more uplink resources, while the cyclic shift 310-r (e.g., a value of 5, a cyclic shift value having some offset from an initial cyclic shift value) may be mapped to, or associated with, both the indication of NACK and the indication that the UE 115 is not skipping one or more uplink resources. The cyclic shift 310-s (e.g., a value of 10, a cyclic shift value having some offset from an initial cyclic shift value) may be mapped to, or associated with, an indication of the ACK, an indication of the positive scheduling request, and the indication that the UE 115 is not skipping one or more uplink resources, while the cyclic shift 310-t (e.g., a value of 4, a cyclic shift value having some offset from an initial cyclic shift value) may be mapped to, or associated with the indication of a NACK, the indication of the positive scheduling request, and the indication that the UE 115 is not skipping one or more uplink resources.

The cyclic shift 310-u (e.g., a value of 9, a cyclic shift value having some offset from an initial cyclic shift value) may be mapped to, or associated with, an indication of the ACK and the indication of the scheduling request, while the cyclic shift 310-v (e.g., a value of 3, a cyclic shift value having some offset from an initial cyclic shift value) may be mapped to, or associated with, the indication of a NACK and the indication of the positive scheduling request. The cyclic shift 310-w (e.g., a value of 8, a cyclic shift value having some offset from an initial cyclic shift value) may be mapped to, or associated with, the indication of the ACK and an indication of additional information (e.g., the UE 115 is to skip one or more uplink resources), while the cyclic shift 310-x (e.g., a value of 2, a cyclic shift value having some offset from an initial cyclic shift value) may be mapped to, or associated with, the indication of the NACK and the indication of the additional information. Further, the cyclic shift 310-y (e.g., a value of 7, a cyclic shift value having some offset from an initial cyclic shift value) may be mapped to, or associated with, the indication of the ACK, the indication of the positive scheduling request, and the indication of the additional information, while the cyclic shift 310-z (e.g., a value of 1, a cyclic shift value having some offset from an initial cyclic shift value) may be mapped to, or associated with, the indication of the NACK, the indication of the positive scheduling request, and the indication of the additional information.

The figures and descriptions, as shown and described in the diagram 300, may be examples of cyclic shift assignments or cyclic shift values. As such, different assignments (e.g., positions and combinations of the mapping between cyclic shifts 310 and the indications) may be used. In one example, the cyclic shift assignments may be such that the distance between cyclic shifts indicating different information is maximized for relatively higher priority bits (e.g., the one or more bits associated with the indication of the HARQ feedback may be prioritized).

In this way, the UE 115 may transmit an indication of additional information via a single bit in the UCI using PUCCH format 0, thereby reducing signaling overhead in the wireless communications system, improving coordination between devices, and enabling the network entity 105 to use uplink resources more efficiently. For example, by mapping one or more cyclic shifts 310 to associated indications, the UE 115 may not transmit multiple signals to indicate the additional information, thereby reducing overhead in the wireless communications system. Further, by indicating the additional information to the network entity 105, the UE 115 may improve coordination between devices, such that the network entity 105 may have an indication of which uplink resources configured for the UE 115 may be skipped. Further, in response to receiving the indication of additional information, the network entity 105 may reschedule, reuse, or repurpose the one or more skipped uplink resources, thereby providing for a more efficient utilization of communication resources.

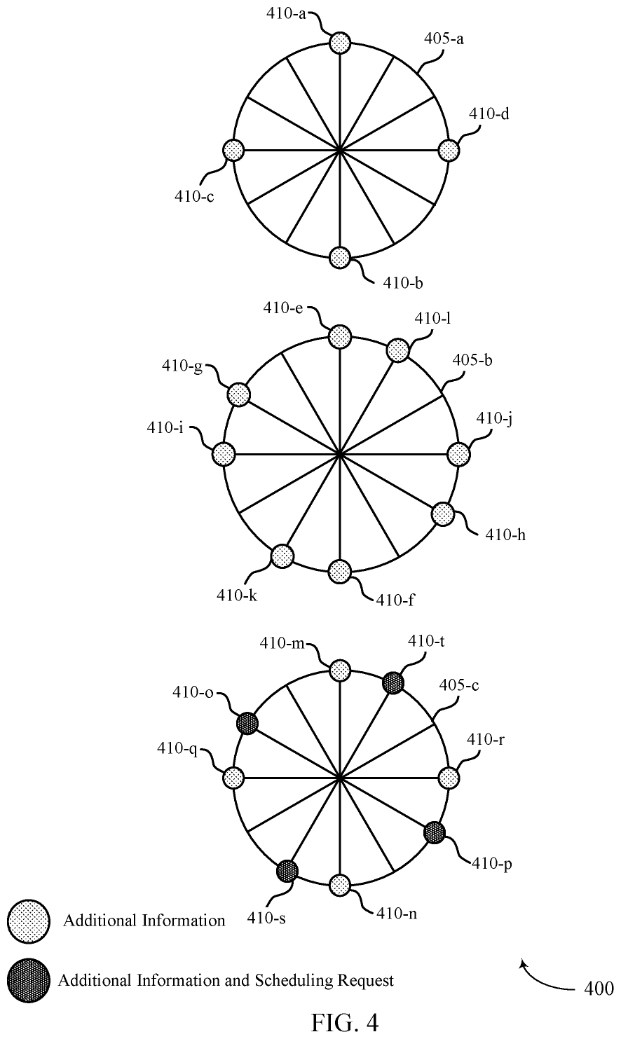

FIG. 4 illustrates an example of a diagram 400 that supports indications for uplink resources via UCI in accordance with one or more aspects of the present disclosure. The diagram 400 may implement, or be implemented by, aspects of the wireless communications system 100, the wireless communications system 200, and the diagram 300. For example, the diagram 400 may be implemented by a UE 115 and a network entity 105, which may be examples of corresponding devices described herein with reference to FIGS. 1 through 2. Additionally, the diagram 400 may include one or more cyclic shift diagrams 405, which may be examples of the cyclic shift diagrams 305 as described herein with reference to FIG. 3.

The UE 115 may implement aspects of the diagram 400 in order to transmit an indication of additional information, an indication of a scheduling request (e.g., a positive scheduling request), or both via UCI in a PUCCH using a PUCCH format 0, where the indication of additional information includes multiple bits of information (e.g., up to 3 bits of information). For example, each cyclic shift 410 in a cyclic shift diagram 405 may be mapped to, or associated with, a combination of the indication of the positive scheduling request and the indication of the additional information. Further, each UE 115 in a wireless communications system may include an initial cyclic shift value, such that when determining the cyclic shift 410 to use for the UCI, the UE 115 may offset the mapped cyclic shift 410 from the initial cyclic shift. That is, a cyclic shift value may be different from an initial cyclic shift value by some value. As such, based on the cyclic shift 410 used for the generation of the sequence for the UCI, the network entity 105 may receive each indication in the UCI.

As an illustrative example, if the UE 115 is to only transmit the indication of the additional information via multiple bits (e.g., via two or three bits) in the UCI, the UE 115 may use a cyclic shift 410 from either a cyclic shift diagram 405-a (e.g., when using two bits) or a cyclic shift diagram 405-b (e.g., when using three bits).

For example, if the UE 115 is to transmit the indication of additional information via two bits in the UCI, then the UE 115 may use a cyclic shift 410 from the cyclic shift diagram 405-a (e.g., which may be similar to existing techniques for two bit HARQ feedback). In such examples, each cyclic shift 410 (e.g., the cyclic shift 410-a, the cyclic shift 410-b, the cyclic shift 410-c, and the cyclic shift 410-d) may be mapped to, or associated with, two bits of information, where each cyclic shift 410 may represent the indication of additional information. As an illustrative example, the cyclic shift 410-a (e.g., an initial cyclic shift value) may be associated with a bit value of [0,0], the cyclic shift 410-b may be associated with a bit value of [1,0], the cyclic shift 410-c may be associated with a bit value of [1,1], and the cyclic shift 410-d may be associated with a bit value of [0,1], where each bit of the respective bit values may be associated with an indication that the UE 115 is to skip one or more uplink resources or that it is to refrain from skipping one or more uplink resources.

Alternatively, if the UE 115 is to transmit the indication of additional information via three bits in the UCI, then the UE 115 may use a cyclic shift 410 from the cyclic shift diagram 405-b. In such examples, each cyclic shift 410 (e.g., the cyclic shift 410-e, the cyclic shift 410-f, the cyclic shift 410-g, the cyclic shift 410-h, the cyclic shift 410-i, the cyclic shift 410-j, the cyclic shift 410-k, and the cyclic shift 410-1) may be mapped to, or associated with, an indication of up to three bits of information, where each cyclic shift 410 may represent the indication of additional information (e.g., an indication that one or more uplink resources are to be unused by the UE 115). As an illustrative example, the cyclic shift 410-e may be associated with a bit value of [0,0,0], the cyclic shift 410-f may be associated with a bit value of [1,0,0], the cyclic shift 410-g may be associated with a bit value of [1,1,1], the cyclic shift 410-h may be associated with a bit value of [0,1,1], the cyclic shift 410-i may be associated with a bit value of [1,1,0], the cyclic shift 410-j may be associated with a bit value of [0,1,0], the cyclic shift 410-k may be associated with a bit value of [1,0,1], and the cyclic shift 410-1 may be associated with a bit value of [0,0,1], where each bit of the bit value may be associated with an indication that the UE 115 is to skip one or more uplink resources or that it is to refrain from skipping one or more uplink resources or some other indication.

In some examples, if the UE 115 is to transmit the indication of additional information and the indication of the positive scheduling request, then the UE 115 may use two bits for the indication of the additional information and one bit for the indication of the positive scheduling request. In such examples, the UE 115 may determine a cyclic shift 410 from the cyclic shift diagram 405-c. For example, the cyclic shift diagram 405 may have four orthogonal cyclic shifts 410 for the two bits associated with the indication of additional information (e.g., CGskip) and then group shift such four cyclic shifts 410 to indicate the scheduling request (e.g., similar to existing two bit HARQ feedback and positive scheduling request).

For example, the cyclic shift 410-m, the cyclic shift 410-q, the cyclic shift 410-n and the cyclic shift 410-r may be mapped to, or associated with, the two bits that are indicative of the additional information. In such examples, the cyclic shift 410-m may be associated with a bit value of [0,0], the cyclic shift 410-q may be associated with a bit value of [1,1], the cyclic shift 410-n may be associated with a bit value of [1,0], and the cyclic shift 410-r may be associated with a bit value of [0,1], where each bit of the respective bit values may be associated with an indication that the UE 115 is to skip one or more uplink resources or that it is to refrain from skipping one or more uplink resources. Further, the cyclic shift 410-o, the cyclic shift 410-s, the cyclic shift 410-p, and the cyclic shift 410-t may be mapped to, or associated with two bits that are indicative of the additional information and the indication of the positive scheduling request. As an illustrative example, the cyclic shift 410-t may be associated with a bit value of [0,0], the cyclic shift 410-p may be associated with a bit value of [0,1], the cyclic shift 410-s may be associated with a bit value of [1,0], and the cyclic shift 410-o may be associated with a bit value of [1,1], where each bit of the respective bit values may be associated with an indication that the UE 115 is to skip one or more uplink resources or that it is to refrain from skipping one or more uplink resources.

Thus, based on the quantity of bits used for the indication of additional information and the respective indications in the UCI, the UE 115 may determine a cyclic shift 410, generate the sequence associated with the UCI using the determined cyclic shift 410, and transmit the UCI, such that the network entity 105 may decode the sequence, determine the cyclic shift, and receive the indication of additional information. In this way, the UE 115 may transmit an indication of additional information via two or three bits in the UCI using PUCCH format 0, thereby reducing signaling overhead in the wireless communications system, improving coordination between devices, and enabling the network entity 105 to use uplink resources more efficiently.

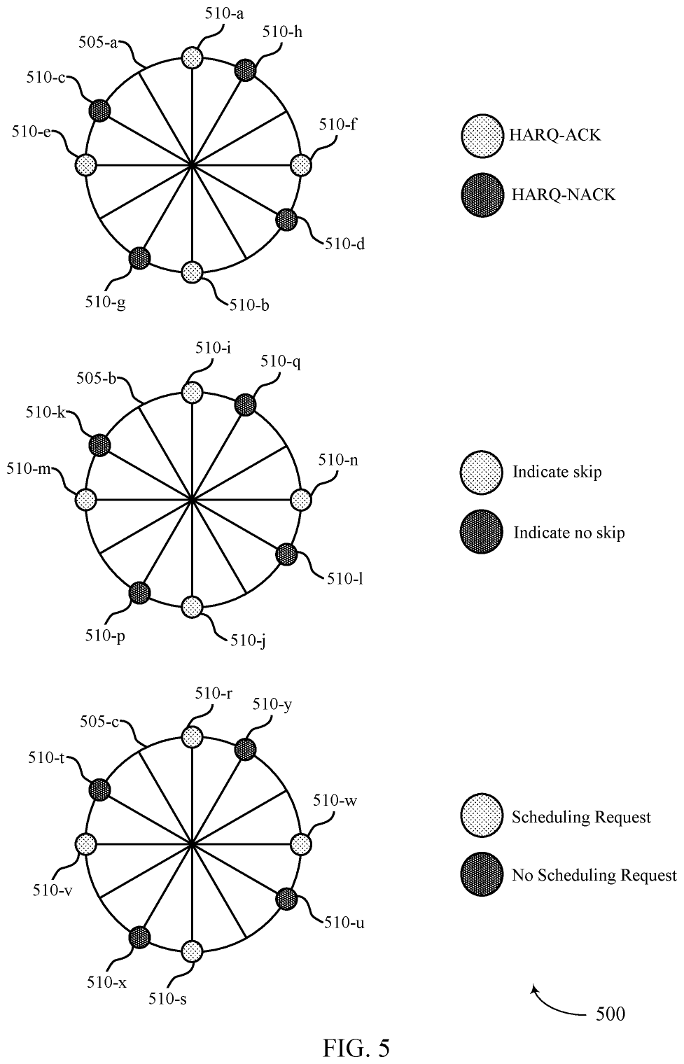

FIG. 5 illustrates an example of a diagram 500 that supports indications for uplink resources via UCI in accordance with one or more aspects of the present disclosure. The diagram 500 may implement, or be implemented by, aspects of the wireless communications system 100, the wireless communications system 200, the diagram 300, and the diagram 400 as described herein. For example, the diagram 400 may be implemented by a UE 115 and a network entity 105, which may be examples of corresponding devices described herein with reference to FIGS. 1 through 2. Additionally, the diagram 400 may include one or more cyclic shift diagrams 505, which may be examples of the cyclic shift diagrams 305 and the cyclic shift diagrams 405 as described herein with reference to FIGS. 3 through 4.

The UE 115 may implement aspects of the diagram 400 in order to transmit an indication of additional information, an indication of a scheduling request (e.g., a positive scheduling request), an indication of the HARQ feedback, or any combination thereof, via UCI in a PUCCH using a PUCCH format 0, where the indication of additional information includes multiple bits of information (e.g., up to two bits of information). For example, each cyclic shift 510 in a cyclic shift diagram 505 may be mapped to, or associated with, a combination of the indication of the positive scheduling request, the indication of the additional information, and the indication of the HARQ feedback. Further, each UE 115 in a wireless communications system may include an initial cyclic shift value, such that when determining the cyclic shift 510 to use for the UCI, the UE 115 may offset the mapped cyclic shift 510 from the initial cyclic shift. As such, based on the cyclic shift 510 used for the generation of the sequence for the UCI, the network entity 105 may receive each indication via the UCI.

In some examples, the UE 115 may transmit the indication of the additional information via two bits and the indication of the HARQ feedback via a single bit. In such examples, the UE 115 may determine a cyclic shift 510 from the cyclic shift diagram 505-a, where the cyclic shift diagram 505-a may include four orthogonal cyclic shifts 510 (e.g., the cyclic shift 510-a, the cyclic shift 510-b, the cyclic shift 510-e, and the cyclic shift 510-f) mapped to, or associated with, the two bits for the indication of additional information (e.g., CGskip bits). In such examples, cyclic shift diagram 505-a may include four group shifted cyclic shifts 510 (e.g., shifted by one: the cyclic shift 510-c, the cyclic shift 510-g, the cyclic shift 510-d, and the cyclic shift 510-h) to indicate the single bit of information mapped to, or associated with, the indication of HARQ feedback.

As an illustrative example, the cyclic shift 510-a, the cyclic shift 510-b, the cyclic shift 510-e, and the cyclic shift 510-f may each be associated with two bits that are indicative of the additional information and associated with an ACK (e.g., single bit indicating an ACK) of the indication of HARQ feedback. In such examples, the cyclic shift 510-a may have a bit value of [0,0], the cyclic shift 510-b may have a bit value of [1,0], the cyclic shift 510-e may have a bit value of [1,1], and the cyclic shift 510-f may have a bit value of [0,1], where each bit of the respective bit values may be associated with an indication that the UE 115 is to skip one or more uplink resources or that it is to refrain from skipping one or more uplink resources.

Further, the cyclic shift 510-c, the cyclic shift 510-g, the cyclic shift 510-d, and the cyclic shift 510-h may each be associated with two bits that are indicative of the additional information and associated with a NACK (e.g., single bit indicating a NACK) of the indication of HARQ feedback. As such, the cyclic shift 510-c may have a bit value of [1,1], the cyclic shift 510-g may have a bit value of [1,0], the cyclic shift 510-d may have a bit value of [0,1], and the cyclic shift 510-h may have a bit value of [0,0], where each bit of the respective bit values may be associated with an indication that the UE 115 is to skip one or more uplink resources or that it is to refrain from skipping one or more uplink resources.

In some other examples, the UE 115 may transmit the indication of the additional information via a single bit and the indication of the HARQ feedback via two bits. In such examples, the UE 115 may determine a cyclic shift 510 from the cyclic shift diagram 505-b, where the cyclic shift diagram 505-b may include four orthogonal cyclic shifts 510 (e.g., a cyclic shift 510-i, a cyclic shift 510-m, a cyclic shift 510-j, and a cyclic shift 510-n) for the two bit associated with the indication of HARQ feedback. In such examples, cyclic shift diagram 505-b may include four group shifted cyclic shifts 510 (e.g., shifted by one: a cyclic shift 510-k, a cyclic shift 510-p, a cyclic shift 510-1, and a cyclic shift 510-q) to indicate the single bit of information associated with the indication of the additional information.

As an illustrative example, the cyclic shift 510-i, the cyclic shift 510-m, the cyclic shift 510-j, and the cyclic shift 510-n may be associated with two bits of information indicative of the HARQ feedback and be associated with the indication of additional information (e.g., indicate that the UE 115 is to skip one or more uplink resources). In such examples, the cyclic shift 510-i may have a bit value of [0,0], the cyclic shift 510-m may have a bit value of [1,1], the cyclic shift 510-j may have a bit value of [1,0], and the cyclic shift 510-n may have a bit value of [0,1], where a ‘1’ may indicate an ACK and a ‘0’ may indicate a NACK, or vice versa.

Further, the cyclic shift 510-k, the cyclic shift 510-p, the cyclic shift 510-1, and the cyclic shift 510-q may be associated with two bits of information indicative of HARQ feedback and be associated with an indication that the UE is not skipping one or more uplink resources. As such, the cyclic shift 510-q may have a bit value of [0,0], the cyclic shift 510-k may have a bit value of [1,1], the cyclic shift 510-p may have a bit value of [1,0], and the cyclic shift 510-1 may have a bit value of [0,1], where a ‘1’ may indicate an ACK and a ‘0’ may indicate a NACK, or vice versa.

In some examples, the UE 115 may transmit the indication of the additional information via a single bit, the indication of the HARQ feedback via a single bit, and the indication of the scheduling request via a single bit in the UCI. In such examples, the UE 115 may determine a cyclic shift 510 from the cyclic shift diagram 505-c, where the cyclic shift diagram 505-c may include four orthogonal cyclic shifts 510 (e.g., a cyclic shift 510-r, a cyclic shift 510-v, a cyclic shift 510-s, and a cyclic shift 510-w) associated with the two respective bits for the indication of the additional information and the indication of the HARQ feedback, and associated with the indication of the scheduling request (e.g., positive scheduling request). Further, the cyclic shift diagram 505 may include four group shifted cyclic shifts (e.g., a cyclic shift 510-t, a cyclic shift 510-x, a cyclic shift 510-u, and a cyclic shift 510-y) that are associated with a negative indication of the scheduling request (e.g., a negative scheduling request).

As an illustrative example, the cyclic shift 510-r, the cyclic shift 510-v, the cyclic shift 510-s, and the cyclic shift 510-w may be associated with two bits of respective information indicative of the HARQ feedback and of the additional information (e.g., indicate that the UE 115 is to skip one or more uplink resources) and a single bit indicating the indication of the scheduling request. In such examples, the cyclic shift 510-r may be associated with the indication of the scheduling request, be associated with an ACK of the HARQ feedback, and be associated with the indication of additional information (e.g., that the UE 115 is to skip one or more uplink resources). Alternatively, the cyclic shift 510-s may be associated with the indication of the scheduling request, be associated with a NACK of the indication of the HARQ feedback, and be associated with an indication the that the UE 115 is not skipping one or more uplink resources.

Similarly, the cyclic shift 510-w may be associated with the indication of the scheduling request, be associated with an ACK of the HARQ feedback, and an indication the that the UE 115 is not skipping one or more uplink resources. Alternatively, the cyclic shift 510-v may be associated with the indication of the scheduling request, be associated with a NACK of the indication of the HARQ feedback, and be associated with the indication of the additional information (e.g., that the UE 115 is skipping one or more uplink resources).

Further, the cyclic shift 510-y may be associated with a negative indication of the scheduling request, be associated with an ACK of the HARQ feedback, and be associated with the indication of additional information (e.g., that the UE 115 is to skip one or more uplink resources). Alternatively, the cyclic shift 510-x may be associated with a negative indication of the scheduling request, be associated with a NACK of the indication of the HARQ feedback, and be associated with an indication the that the UE 115 is not skipping one or more uplink resources.

Similarly, the cyclic shift 510-u may be associated with a negative indication of the scheduling request, be associated with an ACK of the HARQ feedback, and an indication the that the UE 115 is not skipping one or more uplink resources. Alternatively, the cyclic shift 510-v may be associated with a negative indication of the scheduling request, be associated with a NACK of the indication of the HARQ feedback, and be associated with the indication of the additional information (e.g., that the UE 115 is skipping one or more uplink resources).

Thus, based on the indications and quantity of bits in the respective indications, the UE 115 may determine a cyclic shift 510, generate a sequence for the UCI using the determined cyclic shift 510, and transmit the UCI via the PUCCH. The network entity 105 may receive and decode the sequence, determine the cyclic shift used, and receive the indications via the UCI. In this way, the UE 115 may transmit an indication of additional information via two or three bits in the UCI using PUCCH format 0, thereby reducing signaling overhead in the wireless communications system, improving coordination between devices, and enabling the network entity 105 to use uplink resources more efficiently.

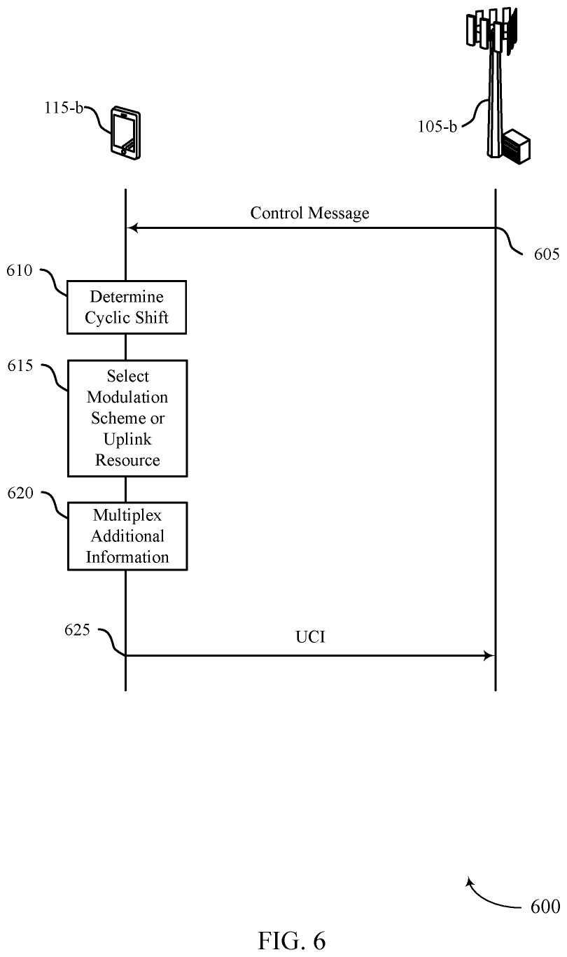

FIG. 6 illustrates an example of a process flow 600 that supports indications for uplink resources via UCI in accordance with one or more aspects of the present disclosure. The process flow 600 may implement, or be implemented by, aspects of the wireless communications system 100, the wireless communications system 200, the diagram 300, the diagram 400, and the diagram 500. For example, the process flow 600 may include a UE 115-b and a network entity 105-b, which may be examples of corresponding devices described herein with reference to FIGS. 1 through 5. In the following description of the process flow 600, the operations may be performed in a different order than the order shown. Specific operations also may be left out of the process flow 600, or other operations may be added to the process flow 600. Further, although some operations or signaling may be shown to occur at different times for discussion purposes, these operations may actually occur at the same time.

At 605, the UE 115-b may receive, from the network entity 105-b, a control message (e.g., such as an RRC message) indicating a configuration (e.g., such as a PUCCH-Config) for UCI that supports an indication of HARQ feedback, an indication of a scheduling request, an indication of CSI, and an indication of additional information, where the additional information may be an indication for the UE 115-b to skip one or more uplink resources that have been configured for the UE 115-b. The control message may be an example of the control message 210 as described herein with reference to FIG. 2.

In some examples, network entity 105-b may indicate, via the configuration of the control message, one of five PUCCH formats (e.g., PUCCH format 0, PUCCH format 1, PUCCH format 2, PUCCH format 3, or PUCCH format 4), such that the UE 115-b may transmit UCI via a PUCCH using the indicating PUCCH format. In some examples, the network entity 105-b may indicate that the UE 115-b is to use the PUCCH format 0, where, in such examples, the UE 115-b may proceed to 610. In some other examples, the network entity 105-b may indicate that the UE 115-b is to use the PUCCH format 1, where, in such examples, the UE 115-b may proceed to 615. In some other examples, the network entity 105-b may indicate for the UE 115-b to use the PUCCH format 2, the PUCCH format 3, or the PUCCH format 4, where, in such examples, the UE 115-b may proceed to 620.

At 610, in response to receiving the control message indicating for the UE 115-b to transmit UCI via the PUCCH format 0, the UE 115-b may determine a cyclic shift from multiple cyclic shifts (e.g., 12 cyclic shifts) associated with a sequence of the UCI. The UE 115-b may determine the cyclic shift based on whether the UCI is to include the indication of the HARQ feedback, the indication of the scheduling request, the indication of the additional information, or a combination thereof. Additionally, the UE 115-b may determine the cyclic shift value in accordance with an initial cyclic shift value that is associated with the UE 115-b. As such, the UE 115-b may determine the cyclic shift in accordance with the techniques described herein with reference to FIGS. 3 through 5.

At 615, in response to receiving the control message indicating for the UE 115-b to transmit UCI via the PUCCH format 1, the UE 115-b may select at least one of a modulation scheme (e.g., QPSK or BPSK) or an uplink resource (e.g., CGskip resource or scheduling request resource) to be used for the transmission at least the indication of additional information. In such examples, the UE 115-b may select the modulation scheme, uplink resource, or both based on whether the UCI is to include the indication of the additional information, the indication of the HARQ feedback, the indication of the scheduling request, or any combination thereof. The UE 115-b may select the modulation scheme or uplink resource in accordance with the techniques described herein with reference to FIG. 2.

At 620, in response to receiving the control message indicating for the UE 115-b to transmit UCI via the PUCCH format 2, the PUCCH format 3, or the PUCCH format 4, the UE 115 may multiplex one or more bits associated with the indication of additional information with one or more bits associated with the indication of the HARQ feedback, one or more bits associated with the indication of the scheduling request, and one or more bits associated with the indication of the CSI. Further, if the UE 115-b is to use the PUCCH format 3 or the PUCCH format 4, the UE 115-b may additional jointly encode the one or more bits associated with the indication of additional information with the one or more bits associated with the indication of the HARQ feedback, the one or more bits associated with the indication of the scheduling request, and the one or more bits associated with the indication of the CSI. The UE 115-b may multiplex such indications in accordance with the techniques described herein with reference to FIG. 2.

Further, the UE 115-b may map the one or more bits associated with the indication of additional information, the one or more bits associated with the indication of the HARQ feedback, and the one or more bits associated with the indication of the CSI to respective priorities. As such, a first priority associated with the one or more bits associated with the indication of the HARQ feedback may be greater than a second priority associated with the one or more bits associated with the indication of additional information, which may be greater than a third priority associated with the one or more bits associated with the indication of the CSI. In such examples, the UE 115-b may drop, or otherwise exclude, the one or more bits associated with the indication of the CSI in cases when the UCI exceeds capacity.

At 625, the UE 115-b may transmit the UCI via the PUCCH using one of the five PUCCH formats, where the UCI includes at least one of the indication of the HARQ feedback, or the indication of the scheduling request, or the indication of the CSI, or the indication of the additional information. The UE 115-b may transmit such indications in accordance with the indicated PUCCH format.

In this way, the UE 115-b may improve coordination between devices and enable more efficient utilization of communication resources. For example, by transmitting the indication of additional information in the UCI, the UE 115-b may indicate, to the network entity 105-b, which uplink resources may be skipped, thereby improving coordination between the UE 115-b and network entity 105-b. Further, by transmitting the indication of the additional information, the network entity 105-b may reschedule the skipped resources for use by other UEs 115, resulting in more efficient utilization of communication resources in the wireless communications system.

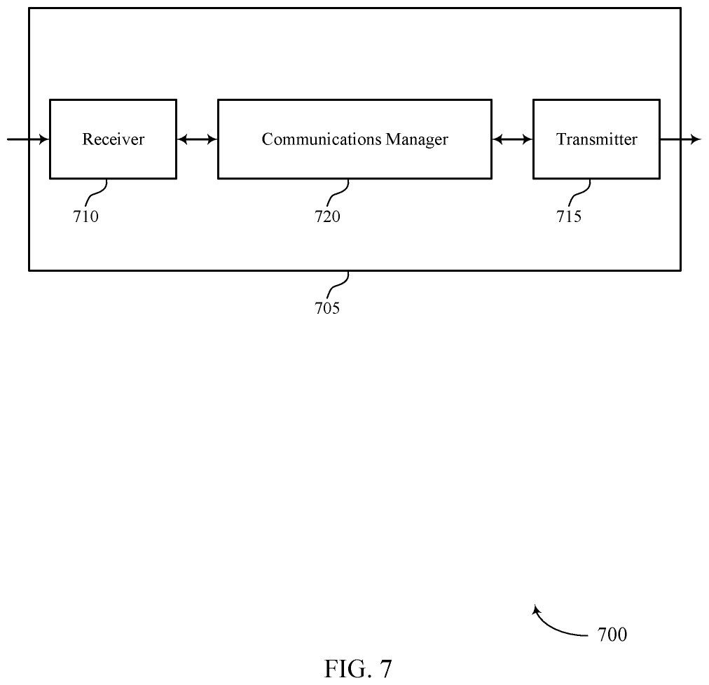

FIG. 7 illustrates a block diagram 700 of a device 705 that supports indications for uplink resources via UCI in accordance with one or more aspects of the present disclosure. The device 705 may be an example of aspects of a UE 115 as described herein. The device 705 may include a receiver 710, a transmitter 715, and a communications manager 720. The device 705 may also include a processor. Each of these components may be in communication with one another (e.g., via one or more buses).

The receiver 710 may provide a means for receiving information such as packets, user data, control information, or any combination thereof associated with various information channels (e.g., control channels, data channels, information channels related to indications for uplink resources via UCI). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to indications for uplink resources via UCI). In some examples, the transmitter 715 may be co-located with a receiver 710 in a transceiver module. The transmitter 715 may utilize a single antenna or a set of multiple antennas.

The communications manager 720, the receiver 710, the transmitter 715, or various combinations thereof or various components thereof may be examples of means for performing various aspects of indications for uplink resources via UCI as described herein. For example, the communications manager 720, the receiver 710, the transmitter 715, or various combinations or components thereof may support a method for performing one or more of the functions described herein.

In some examples, the communications manager 720, the receiver 710, the transmitter 715, or various combinations or components thereof may be implemented in hardware (e.g., in communications management circuitry). The hardware may include a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 720, the receiver 710, the transmitter 715, or various combinations or components thereof may be implemented in code (e.g., as communications management software or firmware) executed by a processor. If implemented in code executed by a processor, the functions of the communications manager 720, the receiver 710, the transmitter 715, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 720 may be configured to perform various operations (e.g., receiving, obtaining, monitoring, outputting, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to obtain information, output information, or perform various other operations as described herein.

The communications manager 720 may support wireless communication at a UE in accordance with examples as disclosed herein. For example, the communications manager 720 may be configured as or otherwise support a means for receiving a control message indicating a configuration for UCI that supports an indication of HARQ feedback, an indication of a scheduling request, an indication of CSI, and an indication of additional information, the indication of the additional information being associated with a set of multiple uplink resources configured for the UE. The communications manager 720 may be configured as or otherwise support a means for transmitting the UCI via a PUCCH in accordance with the configuration, where the UCI includes at least one of the indication of the HARQ feedback, or the indication of the scheduling request, or the indication of the CSI, or the indication of the additional information.

By including or configuring the communications manager 720 in accordance with examples as described herein, the device 705 (e.g., a processor controlling or otherwise coupled with the receiver 710, the transmitter 715, the communications manager 720, or a combination thereof) may support techniques for indicating additional information in UCI, which may result in more efficient utilization of communication resources.

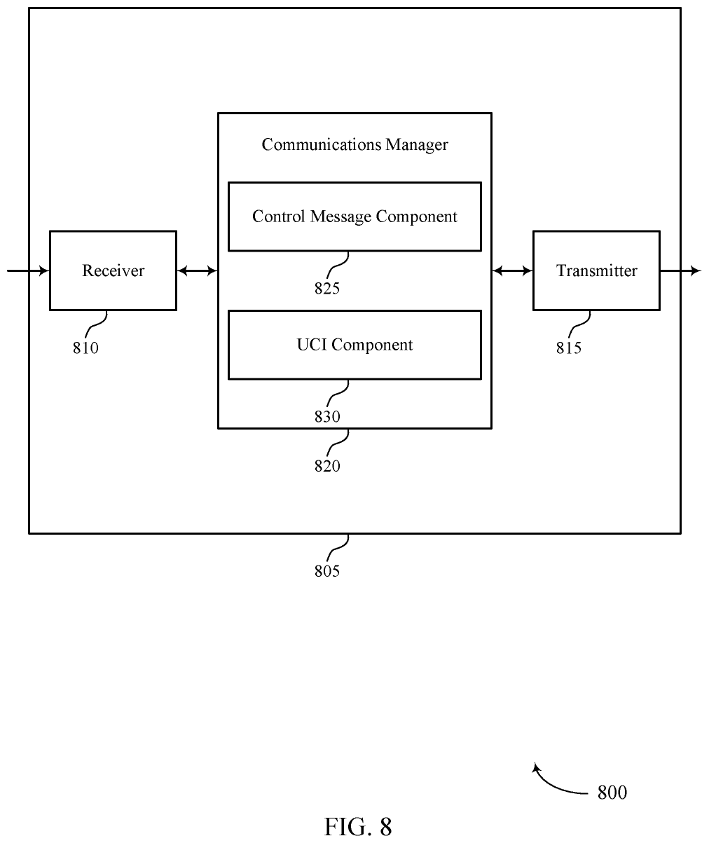

FIG. 8 illustrates a block diagram 800 of a device 805 that supports indications for uplink resources via UCI in accordance with one or more aspects of the present disclosure. The device 805 may be an example of aspects of a device 705 or a UE 115 as described herein. The device 805 may include a receiver 810, a transmitter 815, and a communications manager 820. The device 805 may also include a processor. Each of these components may be in communication with one another (e.g., via one or more buses).

The receiver 810 may provide a means for receiving information such as packets, user data, control information, or any combination thereof associated with various information channels (e.g., control channels, data channels, information channels related to indications for uplink resources via UCI). Information may be passed on to other components of the device 805. The receiver 810 may utilize a single antenna or a set of multiple antennas.

The transmitter 815 may provide a means for transmitting signals generated by other components of the device 805. For example, the transmitter 815 may transmit information such as packets, user data, control information, or any combination thereof associated with various information channels (e.g., control channels, data channels, information channels related to indications for uplink resources via UCI). In some examples, the transmitter 815 may be co-located with a receiver 810 in a transceiver module. The transmitter 815 may utilize a single antenna or a set of multiple antennas.

The device 805, or various components thereof, may be an example of means for performing various aspects of indications for uplink resources via UCI as described herein. For example, the communications manager 820 may include a control message component 825 a UCI component 830, or any combination thereof. The communications manager 820 may be an example of aspects of a communications manager 720 as described herein. In some examples, the communications manager 820, or various components thereof, may be configured to perform various operations (e.g., receiving, obtaining, monitoring, outputting, transmitting) using or otherwise in cooperation with the receiver 810, the transmitter 815, or both. For example, the communications manager 820 may receive information from the receiver 810, send information to the transmitter 815, or be integrated in combination with the receiver 810, the transmitter 815, or both to obtain information, output information, or perform various other operations as described herein.

The communications manager 820 may support wireless communication at a UE in accordance with examples as disclosed herein. The control message component 825 may be configured as or otherwise support a means for receiving a control message indicating a configuration for UCI that supports an indication of HARQ feedback, an indication of a scheduling request, an indication of CSI, and an indication of additional information, the indication of the additional information being associated with a set of multiple uplink resources configured for the UE. The UCI component 830 may be configured as or otherwise support a means for transmitting the UCI via a PUCCH in accordance with the configuration, where the UCI includes at least one of the indication of the HARQ feedback, or the indication of the scheduling request, or the indication of the CSI, or the indication of the additional information.

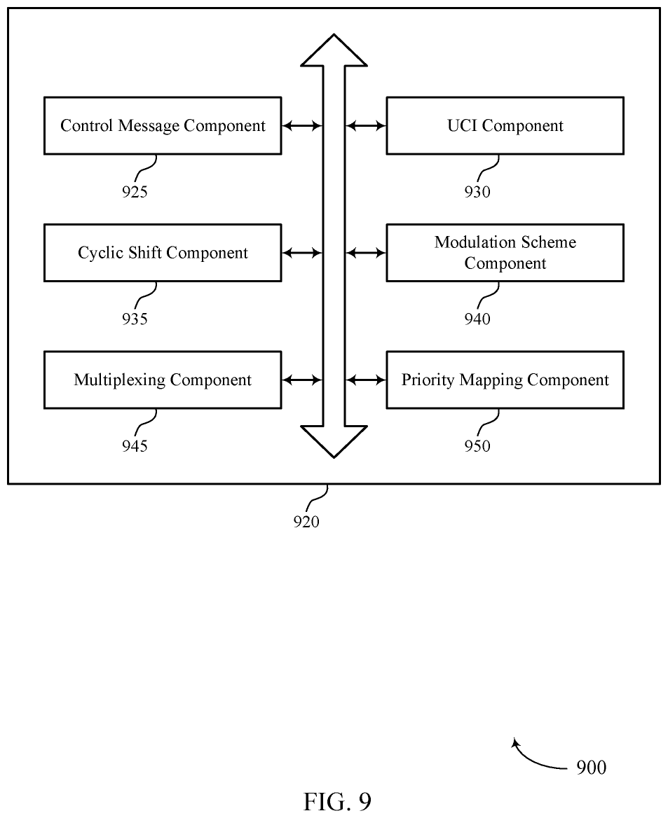

FIG. 9 illustrates a block diagram 900 of a communications manager 920 that supports indications for uplink resources via UCI in accordance with one or more aspects of the present disclosure. The communications manager 920 may be an example of aspects of a communications manager 720, a communications manager 820, or both, as described herein. The communications manager 920, or various components thereof, may be an example of means for performing various aspects of indications for uplink resources via UCI as described herein. For example, the communications manager 920 may include a control message component 925, a UCI component 930, a cyclic shift component 935, a modulation scheme component 940, a multiplexing component 945, a priority mapping component 950, or any combination thereof. Each of these components may communicate, directly or indirectly, with one another (e.g., via one or more buses).

The communications manager 920 may support wireless communication at a UE in accordance with examples as disclosed herein. The control message component 925 may be configured as or otherwise support a means for receiving a control message indicating a configuration for UCI that supports an indication of HARQ feedback, an indication of a scheduling request, an indication of CSI, and an indication of additional information, the indication of the additional information being associated with a set of multiple uplink resources configured for the UE. The UCI component 930 may be configured as or otherwise support a means for transmitting the UCI via a PUCCH in accordance with the configuration, where the UCI includes at least one of the indication of the HARQ feedback, or the indication of the scheduling request, or the indication of the CSI, or the indication of the additional information.

In some examples, the PUCCH is configured as PUCCH format 0, and the cyclic shift component 935 may be configured as or otherwise support a means for determining a cyclic shift from a set of multiple cyclic shifts associated with the UCI based on whether the UCI includes the indication of the HARQ feedback, the indication of the scheduling request, the indication of the additional information, or a combination thereof, where the UCI is transmitted via the PUCCH based on the cyclic shift being applied to a base sequence.

In some examples, the cyclic shift includes an initial cyclic shift value based on the UCI including only the indication of the additional information.

In some examples, the cyclic shift includes a first cyclic shift value based on the UCI including only the indication of the additional information, the first cyclic shift value being offset from an initial cyclic shift value.

In some examples, the cyclic shift includes a second cyclic shift value based on the UCI including only the indication of the HARQ feedback, the second cyclic shift value being offset from an initial cyclic shift value by a first value in accordance with the HARQ feedback including a negative acknowledgment, or the second cyclic shift value being offset from the initial cyclic shift value by a second value different from the first value in accordance with the HARQ feedback including an acknowledgment.

In some examples, the cyclic shift includes an initial cyclic shift value based on the UCI including only the indication of the scheduling request.

In some examples, the cyclic shift includes a fourth cyclic shift value based on the UCI including the indication of the additional information and the indication of the scheduling request, the fourth cyclic shift value being offset from an initial cyclic shift value based on the scheduling request and the additional information.

In some examples, the cyclic shift includes a fifth cyclic shift value based on the UCI including the indication of the additional information and the indication of the HARQ feedback, the fifth cyclic shift value being offset from an initial cyclic shift value by a third value in accordance with the HARQ feedback including a negative acknowledgment, or the fifth cyclic shift value being offset from the initial cyclic shift value by a fourth value different from the third value in accordance with the HARQ feedback including an acknowledgment.

In some examples, the cyclic shift includes a sixth cyclic shift value based on the UCI including the indication of the additional information, the indication of the HARQ feedback, and the indication of the scheduling request, the sixth cyclic shift value being offset from an initial cyclic shift value by a fifth value in accordance with the HARQ feedback including a negative acknowledgment, or the sixth cyclic shift value being offset from the initial cyclic shift value by a sixth value different from the fifth value in accordance with the HARQ feedback including an acknowledgment.

In some examples, the cyclic shift includes a seventh cyclic shift value based on the UCI including the indication of the HARQ feedback and the indication of the scheduling request, the seventh cyclic shift value being offset from an initial cyclic shift value by a seventh value in accordance with the HARQ feedback including a negative acknowledgment, or the seventh cyclic shift value being offset from the initial cyclic shift value by a eighth value different from the seventh value in accordance with the HARQ feedback including an acknowledgment.

In some examples, the cyclic shift is further based on a quantity of bits associated with each of the indication of the HARQ feedback, or indication of the scheduling request, or the indication of the additional information, or any combination thereof, and a bit value of each of the indication of the HARQ feedback, or the indication of the additional information, or both.

In some examples, the PUCCH is configured as PUCCH format 1, and the modulation scheme component 940 may be configured as or otherwise support a means for selecting at least one of a modulation scheme or an uplink resource for transmitting at least the indication of the additional information, where the UCI is transmitted via the PUCCH based on at least one of the modulation scheme or the uplink resource.

In some examples, the UCI includes only the indication of the additional information; and the additional information is indicated using the modulation scheme based on a quantity of bits associated with the indication of the additional information.

In some examples, the modulation scheme includes a BPSK modulation scheme in accordance with the indication of the additional information including one bit.

In some examples, the modulation scheme includes a QPSK modulation scheme in accordance with the indication of the additional information including two or more bits.

In some examples, the UCI includes the indication of the additional information and the indication of the HARQ feedback; the indication of the additional information and the indication of the HARQ feedback is transmitted via the uplink resource, the uplink resource being allocated for the indication of the additional information; and the indication of the HARQ feedback transmitted via the uplink resource includes the indication of the additional information based on the indication of the additional information including one bit.

In some examples, the UCI includes the indication of the additional information and the indication of the HARQ feedback; the indication of the additional information and the indication of the HARQ feedback is transmitted using the modulation scheme, the modulation scheme including a QPSK modulation scheme; and the indication of the additional information includes one bit.

In some examples, the UCI includes the indication of the additional information and the indication of the scheduling request; the indication of the additional information and the indication of the scheduling request is transmitted via the uplink resource, the uplink resource including either a first uplink resource allocated for the indication of the additional information or a second uplink resource allocated for the indication of the scheduling request; and the indication of the additional information includes one bit.

In some examples, the UCI includes the indication of the additional information and the indication of the scheduling request; the indication of the additional information and the indication of the scheduling request is transmitted via the uplink resource, the uplink resource being allocated for the indication of the scheduling request; and the indication of the additional information includes one or more bits.

In some examples, the UCI includes the indication of the additional information, the indication of the scheduling request, and the indication of the HARQ feedback; the indication of the HARQ feedback is transmitted via the uplink resource, the uplink resource including either a first uplink resource allocated for the indication of the additional information or a second uplink resource allocated for the indication of the scheduling request; and the indication of the additional information includes one bit.

In some examples, the UCI includes the indication of the additional information, the indication of the scheduling request, and the indication of the HARQ feedback, the indication of the additional information; the indication of the scheduling request, and the indication of the HARQ feedback is transmitted using the modulation scheme and via the uplink resource, the modulation scheme including a QPSK modulation scheme and the uplink resource being allocated for the indication of the scheduling request; and the indication of the additional information includes one bit.

In some examples, the PUCCH is configured as PUCCH format 2, and the multiplexing component 945 may be configured as or otherwise support a means for transmitting, as part of the UCI, at least one of the indication of the additional information, or the indication of the HARQ feedback, or the indication of the CSI, where one or more bits associated with the indication of the additional information are multiplexed with at least one of one or more bits associated with the indication of the HARQ feedback or one or more bits associated with the indication of the CSI.

In some examples, the one or more bits associated with the indication of the HARQ feedback have a first priority that is greater than a second priority associated with the one or more bits associated with the indication of the additional information; the second priority is greater than a third priority associated with the one or more bits associated with the indication of the CSI; and the UCI includes at least one of the indication of the additional information, or the indication of the scheduling request, or the indication of the HARQ feedback, or the indication of the CSI, based on the first priority, the second priority, or the third priority.

In some examples, the PUCCH is configured as PUCCH format 3 or PUCCH format 4, and the multiplexing component 945 may be configured as or otherwise support a means for transmitting, as part of the UCI, at least one of the indication of the additional information, or the indication of the HARQ feedback, or the indication of the CSI, where one or more bits associated with the indication of the additional information are multiplexed and jointly encoded with at least one of one or more bits associated with the indication of the HARQ feedback, or one or more bits associated with the indication of the CSI.

In some examples, the priority mapping component 950 may be configured as or otherwise support a means for mapping at least one of the one or more bits associated with the indication of the additional information, or the one or more bits associated with the indication of the HARQ feedback, or the one or more bits associated with the indication of the CSI based on at least one of a first mapping priority, or a second mapping priority that is less than the first mapping priority, or a third mapping priority that is less than the second mapping priority, where: the one or more bits associated with the indication of the HARQ feedback have the first mapping priority; the one or more bits associated with the indication of the additional information have the second mapping priority; and the one or more bits associated with the indication of the CSI have the third mapping priority.

In some examples, the additional information indicates that the UE is to skip one or more uplink resources of the set of multiple uplink resources configured for the UE.

In some examples, the UCI excludes the indication of the scheduling request based on the UCI indicating that the UE is to skip the one or more uplink resources.

In some examples, the UCI excludes the indication of the additional information based on the UCI including the indication of the scheduling request.

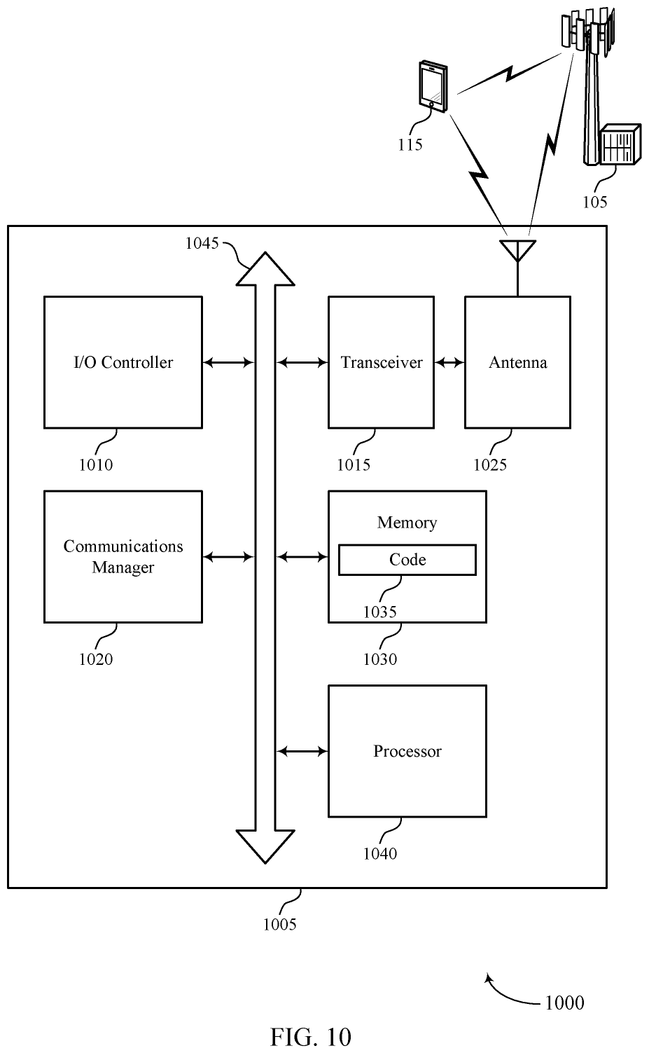

FIG. 10 illustrates a diagram of a system 1000 including a device 1005 that supports indications for uplink resources via UCI in accordance with one or more aspects of the present disclosure. The device 1005 may be an example of or include the components of a device 705, a device 805, or a UE 115 as described herein. The device 1005 may communicate (e.g., wirelessly) with one or more network entities 105, one or more UEs 115, or any combination thereof. The device 1005 may include components for bi-directional voice and data communications including components for transmitting and receiving communications, such as a communications manager 1020, an input/output (I/O) controller 1010, a transceiver 1015, an antenna 1025, a memory 1030, code 1035, and a processor 1040. These components may be in electronic communication or otherwise coupled (e.g., operatively, communicatively, functionally, electronically, electrically) via one or more buses (e.g., a bus 1045).

The I/O controller 1010 may manage input and output signals for the device 1005. The I/O controller 1010 may also manage peripherals not integrated into the device 1005. In some cases, the I/O controller 1010 may represent a physical connection or port to an external peripheral. In some cases, the I/O controller 1010 may utilize an operating system such as iOS®, ANDROID®, MS-DOS®, MS-WINDOWS®, OS/2®, UNIX®, LINUX®, or another known operating system. Additionally, or alternatively, the I/O controller 1010 may represent or interact with a modem, a keyboard, a mouse, a touchscreen, or a similar device. In some cases, the I/O controller 1010 may be implemented as part of a processor, such as the processor 1040. In some cases, a user may interact with the device 1005 via the I/O controller 1010 or via hardware components controlled by the I/O controller 1010.

In some cases, the device 1005 may include a single antenna 1025. However, in some other cases, the device 1005 may have more than one antenna 1025, which may be capable of concurrently transmitting or receiving multiple wireless transmissions. The transceiver 1015 may communicate bi-directionally, via the one or more antennas 1025, wired, or wireless links as described herein. For example, the transceiver 1015 may represent a wireless transceiver and may communicate bi-directionally with another wireless transceiver. The transceiver 1015 may also include a modem to modulate the packets, to provide the modulated packets to one or more antennas 1025 for transmission, and to demodulate packets received from the one or more antennas 1025. The transceiver 1015, or the transceiver 1015 and one or more antennas 1025, may be an example of a transmitter 715, a transmitter 815, a receiver 710, a receiver 810, or any combination thereof or component thereof, as described herein.

The memory 1030 may include random access memory (RAM) and read-only memory (ROM). The memory 1030 may store computer-readable, computer-executable code 1035 including instructions that, when executed by the processor 1040, cause the device 1005 to perform various functions described herein. The code 1035 may be stored in a non-transitory computer-readable medium such as system memory or another type of memory. In some cases, the code 1035 may not be directly executable by the processor 1040 but may cause a computer (e.g., when compiled and executed) to perform functions described herein. In some cases, the memory 1030 may contain, among other things, a basic I/O system (BIOS) which may control basic hardware or software operation such as the interaction with peripheral components or devices.

The processor 1040 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1040 may be configured to operate a memory array using a memory controller. In some other cases, a memory controller may be integrated into the processor 1040. The processor 1040 may be configured to execute computer-readable instructions stored in a memory (e.g., the memory 1030) to cause the device 1005 to perform various functions (e.g., functions or tasks supporting indications for uplink resources via UCI). For example, the device 1005 or a component of the device 1005 may include a processor 1040 and memory 1030 coupled with or to the processor 1040, the processor 1040 and memory 1030 configured to perform various functions described herein.

The communications manager 1020 may support wireless communication at a UE in accordance with examples as disclosed herein. For example, the communications manager 1020 may be configured as or otherwise support a means for receiving a control message indicating a configuration for UCI that supports an indication of HARQ feedback, an indication of a scheduling request, an indication of CSI, and an indication of additional information, the indication of the additional information being associated with a set of multiple uplink resources configured for the UE. The communications manager 1020 may be configured as or otherwise support a means for transmitting the UCI via a PUCCH in accordance with the configuration, where the UCI includes at least one of the indication of the HARQ feedback, or the indication of the scheduling request, or the indication of the CSI, or the indication of the additional information.

By including or configuring the communications manager 1020 in accordance with examples as described herein, the device 1005 may support techniques for indicating additional information in UCI, which may result in more efficient utilization of communication resources and improved coordination between devices.

In some examples, the communications manager 1020 may be configured to perform various operations (e.g., receiving, monitoring, transmitting) using or otherwise in cooperation with the transceiver 1015, the one or more antennas 1025, or any combination thereof. Although the communications manager 1020 is illustrated as a separate component, in some examples, one or more functions described with reference to the communications manager 1020 may be supported by or performed by the processor 1040, the memory 1030, the code 1035, or any combination thereof. For example, the code 1035 may include instructions executable by the processor 1040 to cause the device 1005 to perform various aspects of indications for uplink resources via UCI as described herein, or the processor 1040 and the memory 1030 may be otherwise configured to perform or support such operations.

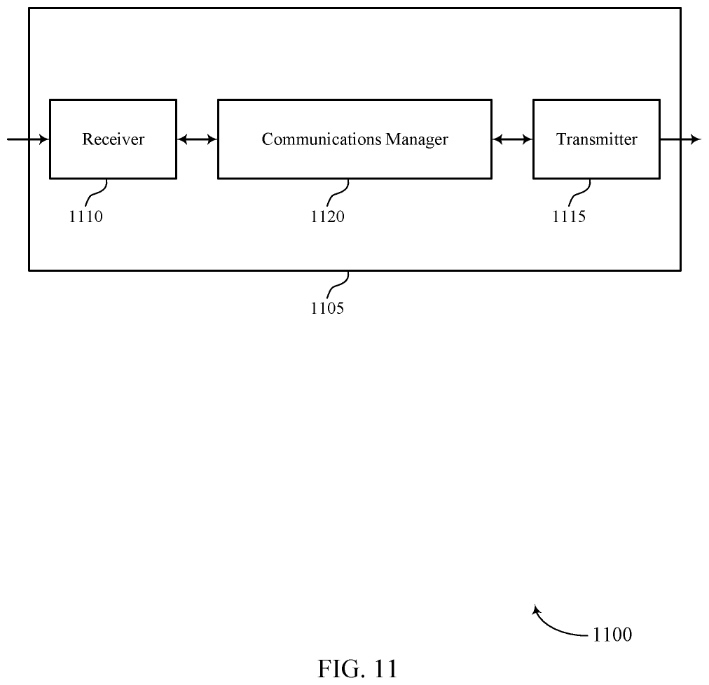

FIG. 11 illustrates a block diagram 1100 of a device 1105 that supports indications for uplink resources via UCI in accordance with one or more aspects of the present disclosure. The device 1105 may be an example of aspects of a network entity 105 as described herein. The device 1105 may include a receiver 1110, a transmitter 1115, and a communications manager 1120. The device 1105 may also include a processor. Each of these components may be in communication with one another (e.g., via one or more buses).

The receiver 1110 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1105. In some examples, the receiver 1110 may support obtaining information by receiving signals via one or more antennas. Additionally, or alternatively, the receiver 1110 may support obtaining information by receiving signals via one or more wired (e.g., electrical, fiber optic) interfaces, wireless interfaces, or any combination thereof.

The transmitter 1115 may provide a means for outputting (e.g., transmitting, providing, conveying, sending) information generated by other components of the device 1105. For example, the transmitter 1115 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1115 may support outputting information by transmitting signals via one or more antennas. Additionally, or alternatively, the transmitter 1115 may support outputting information by transmitting signals via one or more wired (e.g., electrical, fiber optic) interfaces, wireless interfaces, or any combination thereof. In some examples, the transmitter 1115 and the receiver 1110 may be co-located in a transceiver, which may include or be coupled with a modem.

The communications manager 1120, the receiver 1110, the transmitter 1115, or various combinations thereof or various components thereof may be examples of means for performing various aspects of indications for uplink resources via UCI as described herein. For example, the communications manager 1120, the receiver 1110, the transmitter 1115, or various combinations or components thereof may support a method for performing one or more of the functions described herein.

In some examples, the communications manager 1120, the receiver 1110, the transmitter 1115, or various combinations or components thereof may be implemented in hardware (e.g., in communications management circuitry). The hardware may include a processor, a DSP, a CPU, an ASIC, an FPGA or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 1120, the receiver 1110, the transmitter 1115, or various combinations or components thereof may be implemented in code (e.g., as communications management software or firmware) executed by a processor. If implemented in code executed by a processor, the functions of the communications manager 1120, the receiver 1110, the transmitter 1115, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 1120 may be configured to perform various operations (e.g., receiving, obtaining, monitoring, outputting, transmitting) using or otherwise in cooperation with the receiver 1110, the transmitter 1115, or both. For example, the communications manager 1120 may receive information from the receiver 1110, send information to the transmitter 1115, or be integrated in combination with the receiver 1110, the transmitter 1115, or both to obtain information, output information, or perform various other operations as described herein.

The communications manager 1120 may support wireless communication at a network entity in accordance with examples as disclosed herein. For example, the communications manager 1120 may be configured as or otherwise support a means for transmitting a control message indicating a configuration for UCI that supports an indication of HARQ feedback, an indication of a scheduling request, an indication of CSI, and an indication of additional information, the indication of the additional information being associated with a set of multiple uplink resources configured for a UE. The communications manager 1120 may be configured as or otherwise support a means for receiving the UCI via a PUCCH in accordance with the configuration, where the UCI includes at least one of the indication of the HARQ feedback, or the indication of the scheduling request, or the indication of the CSI, or the indication of the additional information.

By including or configuring the communications manager 1120 in accordance with examples as described herein, the device 1105 (e.g., a processor controlling or otherwise coupled with the receiver 1110, the transmitter 1115, the communications manager 1120, or a combination thereof) may support techniques for indicating additional information in UCI, which may result in more efficient utilization of communication resources.

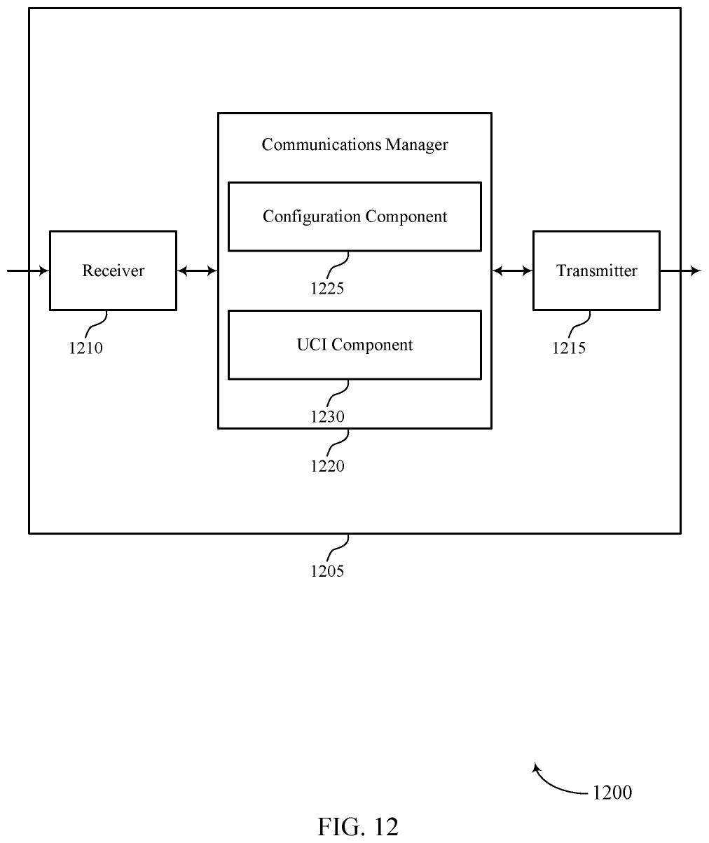

FIG. 12 illustrates a block diagram 1200 of a device 1205 that supports indications for uplink resources via UCI in accordance with one or more aspects of the present disclosure. The device 1205 may be an example of aspects of a device 1105 or a network entity 105 as described herein. The device 1205 may include a receiver 1210, a transmitter 1215, and a communications manager 1220. The device 1205 may also include a processor. Each of these components may be in communication with one another (e.g., via one or more buses).

The receiver 1210 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1205. In some examples, the receiver 1210 may support obtaining information by receiving signals via one or more antennas. Additionally, or alternatively, the receiver 1210 may support obtaining information by receiving signals via one or more wired (e.g., electrical, fiber optic) interfaces, wireless interfaces, or any combination thereof.

The transmitter 1215 may provide a means for outputting (e.g., transmitting, providing, conveying, sending) information generated by other components of the device 1205. For example, the transmitter 1215 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1215 may support outputting information by transmitting signals via one or more antennas. Additionally, or alternatively, the transmitter 1215 may support outputting information by transmitting signals via one or more wired (e.g., electrical, fiber optic) interfaces, wireless interfaces, or any combination thereof. In some examples, the transmitter 1215 and the receiver 1210 may be co-located in a transceiver, which may include or be coupled with a modem.

The device 1205, or various components thereof, may be an example of means for performing various aspects of indications for uplink resources via UCI as described herein. For example, the communications manager 1220 may include a configuration component 1225 a UCI component 1230, or any combination thereof. The communications manager 1220 may be an example of aspects of a communications manager 1120 as described herein. In some examples, the communications manager 1220, or various components thereof, may be configured to perform various operations (e.g., receiving, obtaining, monitoring, outputting, transmitting) using or otherwise in cooperation with the receiver 1210, the transmitter 1215, or both. For example, the communications manager 1220 may receive information from the receiver 1210, send information to the transmitter 1215, or be integrated in combination with the receiver 1210, the transmitter 1215, or both to obtain information, output information, or perform various other operations as described herein.

The communications manager 1220 may support wireless communication at a network entity in accordance with examples as disclosed herein. The configuration component 1225 may be configured as or otherwise support a means for transmitting a control message indicating a configuration for UCI that supports an indication of HARQ feedback, an indication of a scheduling request, an indication of CSI, and an indication of additional information, the indication of the additional information being associated with a set of multiple uplink resources configured for a UE. The UCI component 1230 may be configured as or otherwise support a means for receiving the UCI via a PUCCH in accordance with the configuration, where the UCI includes at least one of the indication of the HARQ feedback, or the indication of the scheduling request, or the indication of the CSI, or the indication of the additional information.

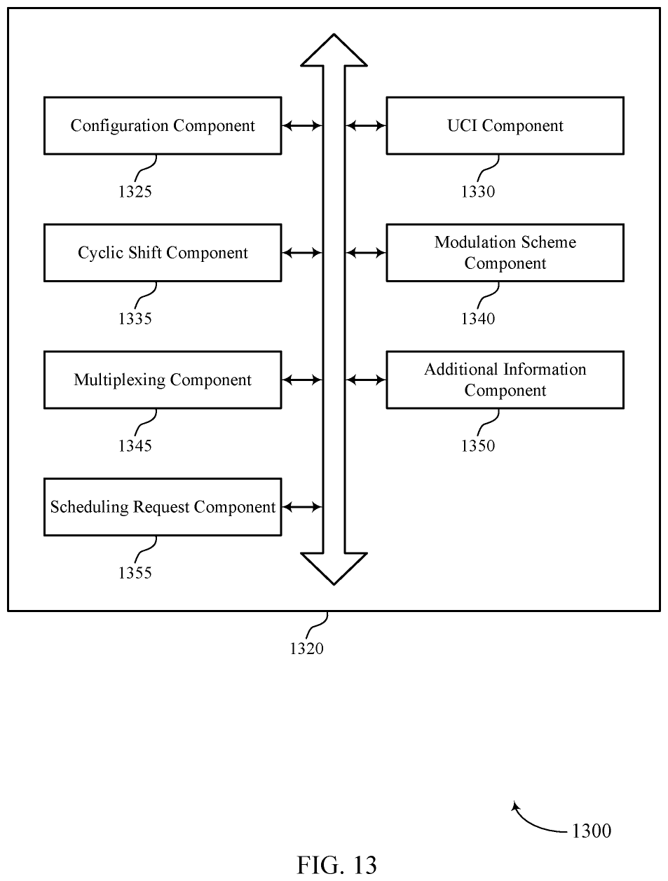

FIG. 13 illustrates a block diagram 1300 of a communications manager 1320 that supports indications for uplink resources via UCI in accordance with one or more aspects of the present disclosure. The communications manager 1320 may be an example of aspects of a communications manager 1120, a communications manager 1220, or both, as described herein. The communications manager 1320, or various components thereof, may be an example of means for performing various aspects of indications for uplink resources via UCI as described herein. For example, the communications manager 1320 may include a configuration component 1325, a UCI component 1330, a cyclic shift component 1335, a modulation scheme component 1340, a multiplexing component 1345, an additional information component 1350, a scheduling request component 1355, or any combination thereof. Each of these components may communicate, directly or indirectly, with one another (e.g., via one or more buses) which may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1320 may support wireless communication at a network entity in accordance with examples as disclosed herein. The configuration component 1325 may be configured as or otherwise support a means for transmitting a control message indicating a configuration for UCI that supports an indication of HARQ feedback, an indication of a scheduling request, an indication of CSI, and an indication of additional information, the indication of the additional information being associated with a set of multiple uplink resources configured for a UE. The UCI component 1330 may be configured as or otherwise support a means for receiving the UCI via a PUCCH in accordance with the configuration, where the UCI includes at least one of the indication of the HARQ feedback, or the indication of the scheduling request, or the indication of the CSI, or the indication of the additional information.

In some examples, the PUCCH is configured as PUCCH format 0, and the cyclic shift component 1335 may be configured as or otherwise support a means for receiving the UCI via the PUCCH based on a cyclic shift applied to a base sequence, the cyclic shift being from a set of multiple cyclic shifts, where the cyclic shift is based on whether the UCI includes the indication of the HARQ feedback, the indication of the scheduling request, the indication of the additional information, or a combination thereof.

In some examples, the cyclic shift includes an initial cyclic shift value based on the UCI including only the indication of the additional information.

In some examples, the cyclic shift includes a first cyclic shift value based on the UCI including only the indication of the additional information, the first cyclic shift value being offset from an initial cyclic shift value.

In some examples, the cyclic shift includes a second cyclic shift value based on the UCI including only the indication of the HARQ feedback, the second cyclic shift value being offset from an initial cyclic shift value by a first value in accordance with the HARQ feedback including a negative acknowledgment, or the second cyclic shift value being offset from the initial cyclic shift value by a second value different from the first value in accordance with the HARQ feedback including an acknowledgment.

In some examples, the cyclic shift includes an initial cyclic shift value based on the UCI including only the indication of the scheduling request.

In some examples, the cyclic shift includes a fourth cyclic shift value based on the UCI including the indication of the additional information and the indication of the scheduling request, the fourth cyclic shift value being offset from an initial cyclic shift value based on the scheduling request and the additional information.

In some examples, the cyclic shift includes a fifth cyclic shift value based on the UCI including the indication of the additional information and the indication of the HARQ feedback, the fifth cyclic shift value being offset from an initial cyclic shift value by a third value in accordance with the HARQ feedback including a negative acknowledgment, or the fifth cyclic shift value being offset from the initial cyclic shift value by a fourth value different from the third value in accordance with the HARQ feedback including an acknowledgment.

In some examples, the cyclic shift includes a sixth cyclic shift value based on the UCI including the indication of the additional information, the indication of the HARQ feedback, and the indication of the scheduling request, the sixth cyclic shift value being offset from an initial cyclic shift value by a fifth value in accordance with the HARQ feedback including a negative acknowledgment, or the sixth cyclic shift value being offset from the initial cyclic shift value by a sixth value different from the fifth value in accordance with the HARQ feedback including an acknowledgment.

In some examples, the cyclic shift includes a seventh cyclic shift value based on the UCI including the indication of the HARQ feedback and the indication of the scheduling request, the seventh cyclic shift value being offset from an initial cyclic shift value by a seventh value in accordance with the HARQ feedback including a negative acknowledgment, or the seventh cyclic shift value being offset from the initial cyclic shift value by a eighth value different from the seventh value in accordance with the HARQ feedback including an acknowledgment.

In some examples, the cyclic shift is further based on a quantity of bits associated with each of the indication of the HARQ feedback, or the indication of the scheduling request, or the indication of the additional information, or any combination thereof, and a bit value of each of the indication of the HARQ feedback, or the indication of the additional information, or both.

In some examples, the PUCCH is configured as PUCCH format 1, and the modulation scheme component 1340 may be configured as or otherwise support a means for receiving at least the indication of the additional information based on at least one of a modulation scheme or an uplink resource, where the UCI is received via the PUCCH based on at least one of the modulation scheme or the uplink resource.

In some examples, the UCI includes only the indication of the additional information; and the additional information is indicated using the modulation scheme based on a quantity of bits associated with the indication of the additional information.

In some examples, the modulation scheme includes a QPSK modulation scheme in accordance with the indication of the additional information including two or more bits.

In some examples, the modulation scheme includes a BPSK modulation scheme in accordance with the indication of the additional information including one bit.

In some examples, the UCI includes the indication of the additional information and the indication of the HARQ feedback; the indication of the additional information and the indication of the HARQ feedback is transmitted via the uplink resource, the uplink resource being allocated for the indication of the additional information; and the indication of the HARQ feedback transmitted via the uplink resource includes the indication of the additional information based on the indication of the additional information including one bit.

In some examples, the UCI includes the indication of the additional information and the indication of the HARQ feedback; the indication of the additional information and the indication of the HARQ feedback is transmitted using the modulation scheme, the modulation scheme including a QPSK modulation scheme; and the indication of the additional information includes one.

In some examples, the UCI includes the indication of the additional information and the indication of the scheduling request; the indication of the additional information and the indication of the scheduling request is transmitted via the uplink resource, the uplink resource including either a first uplink resource allocated for the indication of the additional information or a second uplink resource allocated for the indication of the scheduling request; and the indication of the additional information includes one bit.

In some examples, the UCI includes the indication of the additional information and the indication of the scheduling request; the indication of the additional information and the indication of the scheduling request is transmitted via the uplink resource, the uplink resource being allocated for the indication of the scheduling request; and the indication of the additional information includes one or more bits.

In some examples, the UCI includes the indication of the additional information, the indication of the scheduling request, and the indication of the HARQ feedback; the indication of the HARQ feedback is transmitted via the uplink resource, the uplink resource including either a first uplink resource allocated for the indication of the additional information or a second uplink resource allocated for the indication of the scheduling request; and the indication of the additional information includes one.

In some examples, the UCI includes the indication of the additional information, the indication of the scheduling request, and the indication of the HARQ feedback, the indication of the additional information; the indication of the scheduling request, and the indication of the HARQ feedback is transmitted using the modulation scheme and via the uplink resource, the modulation scheme including a QPSK modulation scheme and the uplink resource being allocated for the indication of the scheduling request; and the indication of the additional information includes one bit.

In some examples, the PUCCH is configured as PUCCH format 2, and the multiplexing component 1345 may be configured as or otherwise support a means for receiving, as part of the UCI, at least one of the indication of the additional information, or the indication of the HARQ feedback, or the indication of the CSI, where one or more bits associated with the indication of the additional information are multiplexed with at least one of one or more bits associated with the indication of the HARQ feedback, or one or more bits associated with the indication of the CSI.

In some examples, the one or more bits associated with the indication of the HARQ feedback have a first priority that is greater than a second priority associated with the one or more bits associated with the indication of the additional information; the second priority is greater than a third priority associated with the one or more bits associated with the indication of the CSI; and the UCI includes at least one of the indication of the additional information, or the indication of the scheduling request, or the indication of the HARQ feedback, or the indication of the CSI, based on the first priority, the second priority, or the third priority.

In some examples, the PUCCH is configured as PUCCH format 3 or PUCCH format 4, and the multiplexing component 1345 may be configured as or otherwise support a means for receiving, as part of the UCI, at least one of the indication of the additional information, or the indication of the HARQ feedback, or the indication of the CSI, where one or more bits associated with the indication of the additional information are multiplexed and jointly encoded with at least one of one or more bits associated with the indication of the HARQ feedback, or one or more bits associated with the indication of the CSI.

In some examples, at least one of the one or more bits associated with the indication of the additional information, or the one or more bits associated with the indication of the HARQ feedback, or the one or more bits associated with the indication of the CSI are mapped to resources based on at least one of a first mapping priority, or a second mapping priority that is less than the first mapping priority, or a third mapping priority that is less than the second mapping priority. In some examples, the one or more bits associated with the indication of the HARQ feedback have the first mapping priority; the one or more bits associated with the indication of the additional information have the second mapping priority; and the one or more bits associated with the indication of the CSI have the third mapping priority.

In some examples, the additional information indicates that the UE is skipping one or more uplink resources of the set of multiple uplink resources configured for the UE.

In some examples, the additional information component 1350 may be configured as or otherwise support a means for indicating a configuration to exclude the indication of the scheduling request from the UCI based on the UCI including the indication of the additional information, where the UCI is received in accordance with the configuration to exclude the indication of the scheduling request.

In some examples, the scheduling request component 1355 may be configured as or otherwise support a means for indicating a configuration to exclude the indication of the additional information from the UCI based on the UCI including the indication of the scheduling request, where the UCI is received in accordance with the configuration to exclude the indication of the additional information.

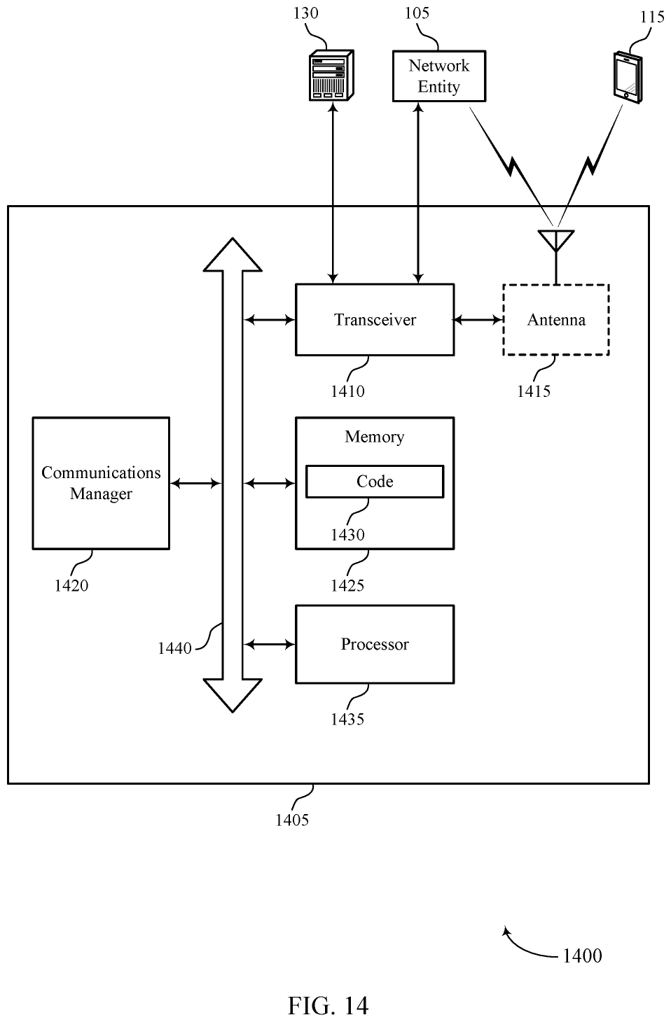

FIG. 14 illustrates a diagram of a system 1400 including a device 1405 that supports indications for uplink resources via UCI in accordance with one or more aspects of the present disclosure. The device 1405 may be an example of or include the components of a device 1105, a device 1205, or a network entity 105 as described herein. The device 1405 may communicate with one or more network entities 105, one or more UEs 115, or any combination thereof, which may include communications over one or more wired interfaces, over one or more wireless interfaces, or any combination thereof. The device 1405 may include components that support outputting and obtaining communications, such as a communications manager 1420, a transceiver 1410, an antenna 1415, a memory 1425, code 1430, and a processor 1435. These components may be in electronic communication or otherwise coupled (e.g., operatively, communicatively, functionally, electronically, electrically) via one or more buses (e.g., a bus 1440).

The transceiver 1410 may support bi-directional communications via wired links, wireless links, or both as described herein. In some examples, the transceiver 1410 may include a wired transceiver and may communicate bi-directionally with another wired transceiver. Additionally, or alternatively, in some examples, the transceiver 1410 may include a wireless transceiver and may communicate bi-directionally with another wireless transceiver. In some examples, the device 1405 may include one or more antennas 1415, which may be capable of transmitting or receiving wireless transmissions (e.g., concurrently). The transceiver 1410 may also include a modem to modulate signals, to provide the modulated signals for transmission (e.g., by one or more antennas 1415, by a wired transmitter), to receive modulated signals (e.g., from one or more antennas 1415, from a wired receiver), and to demodulate signals. In some implementations, the transceiver 1410 may include one or more interfaces, such as one or more interfaces coupled with the one or more antennas 1415 that are configured to support various receiving or obtaining operations, or one or more interfaces coupled with the one or more antennas 1415 that are configured to support various transmitting or outputting operations, or a combination thereof. In some implementations, the transceiver 1410 may include or be configured for coupling with one or more processors or memory components that are operable to perform or support operations based on received or obtained information or signals, or to generate information or other signals for transmission or other outputting, or any combination thereof. In some implementations, the transceiver 1410, or the transceiver 1410 and the one or more antennas 1415, or the transceiver 1410 and the one or more antennas 1415 and one or more processors or memory components (for example, the processor 1435, or the memory 1425, or both), may be included in a chip or chip assembly that is installed in the device 1405. In some examples, the transceiver may be operable to support communications via one or more communications links (e.g., a communication link 125, a backhaul communication link 120, a midhaul communication link 162, a fronthaul communication link 168).

The memory 1425 may include RAM and ROM. The memory 1425 may store computer-readable, computer-executable code 1430 including instructions that, when executed by the processor 1435, cause the device 1405 to perform various functions described herein. The code 1430 may be stored in a non-transitory computer-readable medium such as system memory or another type of memory. In some cases, the code 1430 may not be directly executable by the processor 1435 but may cause a computer (e.g., when compiled and executed) to perform functions described herein. In some cases, the memory 1425 may contain, among other things, a BIOS which may control basic hardware or software operation such as the interaction with peripheral components or devices.

The processor 1435 may include an intelligent hardware device (e.g., a general-purpose processor, a DSP, an ASIC, a CPU, an FPGA, a microcontroller, a programmable logic device, discrete gate or transistor logic, a discrete hardware component, or any combination thereof). In some cases, the processor 1435 may be configured to operate a memory array using a memory controller. In some other cases, a memory controller may be integrated into the processor 1435. The processor 1435 may be configured to execute computer-readable instructions stored in a memory (e.g., the memory 1425) to cause the device 1405 to perform various functions (e.g., functions or tasks supporting indications for uplink resources via UCI). For example, the device 1405 or a component of the device 1405 may include a processor 1435 and memory 1425 coupled with the processor 1435, the processor 1435 and memory 1425 configured to perform various functions described herein. The processor 1435 may be an example of a cloud-computing platform (e.g., one or more physical nodes and supporting software such as operating systems, virtual machines, or container instances) that may host the functions (e.g., by executing code 1430) to perform the functions of the device 1405. The processor 1435 may be any one or more suitable processors capable of executing scripts or instructions of one or more software programs stored in the device 1405 (such as within the memory 1425). In some implementations, the processor 1435 may be a component of a processing system. A processing system may generally refer to a system or series of machines or components that receives inputs and processes the inputs to produce a set of outputs (which may be passed to other systems or components of, for example, the device 1405). For example, a processing system of the device 1405 may refer to a system including the various other components or subcomponents of the device 1405, such as the processor 1435, or the transceiver 1410, or the communications manager 1420, or other components or combinations of components of the device 1405. The processing system of the device 1405 may interface with other components of the device 1405, and may process information received from other components (such as inputs or signals) or output information to other components. For example, a chip or modem of the device 1405 may include a processing system and one or more interfaces to output information, or to obtain information, or both. The one or more interfaces may be implemented as or otherwise include a first interface configured to output information and a second interface configured to obtain information, or a same interface configured to output information and to obtain information, among other implementations. In some implementations, the one or more interfaces may refer to an interface between the processing system of the chip or modem and a transmitter, such that the device 1405 may transmit information output from the chip or modem. Additionally, or alternatively, in some implementations, the one or more interfaces may refer to an interface between the processing system of the chip or modem and a receiver, such that the device 1405 may obtain information or signal inputs, and the information may be passed to the processing system. A person having ordinary skill in the art will readily recognize that a first interface also may obtain information or signal inputs, and a second interface also may output information or signal outputs.

In some examples, a bus 1440 may support communications of (e.g., within) a protocol layer of a protocol stack. In some examples, a bus 1440 may support communications associated with a logical channel of a protocol stack (e.g., between protocol layers of a protocol stack), which may include communications performed within a component of the device 1405, or between different components of the device 1405 that may be co-located or located in different locations (e.g., where the device 1405 may refer to a system in which one or more of the communications manager 1420, the transceiver 1410, the memory 1425, the code 1430, and the processor 1435 may be located in one of the different components or divided between different components).

In some examples, the communications manager 1420 may manage aspects of communications with a core network 130 (e.g., via one or more wired or wireless backhaul links). For example, the communications manager 1420 may manage the transfer of data communications for client devices, such as one or more UEs 115. In some examples, the communications manager 1420 may manage communications with other network entities 105, and may include a controller or scheduler for controlling communications with UEs 115 in cooperation with other network entities 105. In some examples, the communications manager 1420 may support an X2 interface within an LTE/LTE-A wireless communications network technology to provide communication between network entities 105.

The communications manager 1420 may support wireless communication at a network entity in accordance with examples as disclosed herein. For example, the communications manager 1420 may be configured as or otherwise support a means for transmitting a control message indicating a configuration for UCI that supports an indication of HARQ feedback, an indication of a scheduling request, an indication of CSI, and an indication of additional information, the indication of the additional information being associated with a set of multiple uplink resources configured for a UE. The communications manager 1420 may be configured as or otherwise support a means for receiving the UCI via a PUCCH in accordance with the configuration, where the UCI includes at least one of the indication of the HARQ feedback, or the indication of the scheduling request, or the indication of the CSI, or the indication of the additional information.

By including or configuring the communications manager 1420 in accordance with examples as described herein, the device 1405 may support techniques for indicating additional information in UCI, which may result in a more efficient utilization of communication resources and improved coordination between devices.

In some examples, the communications manager 1420 may be configured to perform various operations (e.g., receiving, obtaining, monitoring, outputting, transmitting) using or otherwise in cooperation with the transceiver 1410, the one or more antennas 1415 (e.g., where applicable), or any combination thereof. Although the communications manager 1420 is illustrated as a separate component, in some examples, one or more functions described with reference to the communications manager 1420 may be supported by or performed by the transceiver 1410, the processor 1435, the memory 1425, the code 1430, or any combination thereof. For example, the code 1430 may include instructions executable by the processor 1435 to cause the device 1405 to perform various aspects of indications for uplink resources via UCI as described herein, or the processor 1435 and the memory 1425 may be otherwise configured to perform or support such operations.

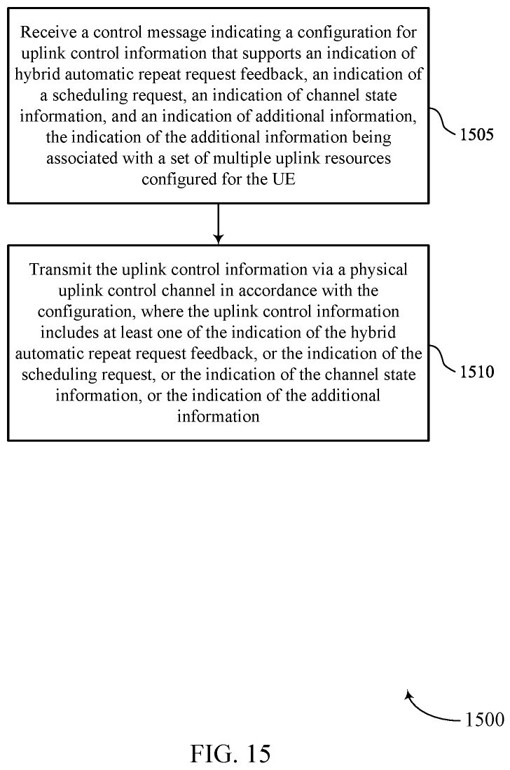

FIG. 15 illustrates a flowchart showing a method 1500 that supports indications for uplink resources via UCI in accordance with one or more aspects of the present disclosure. The operations of the method 1500 may be implemented by a UE or its components as described herein. For example, the operations of the method 1500 may be performed by a UE 115 as described with reference to FIGS. 1 through 10. In some examples, a UE may execute a set of instructions to control the functional elements of the UE to perform the described functions. Additionally, or alternatively, the UE may perform aspects of the described functions using special-purpose hardware.

At 1505, the method may include receiving a control message indicating a configuration for UCI that supports an indication of HARQ feedback, an indication of a scheduling request, an indication of CSI, and an indication of additional information, the indication of the additional information being associated with a set of multiple uplink resources configured for the UE. The operations of 1505 may be performed in accordance with examples as disclosed herein. In some examples, aspects of the operations of 1505 may be performed by a control message component 925 as described with reference to FIG. 9.

At 1510, the method may include transmitting the UCI via a PUCCH in accordance with the configuration, where the UCI includes at least one of the indication of the HARQ feedback, or the indication of the scheduling request, or the indication of the CSI, or the indication of the additional information. The operations of 1510 may be performed in accordance with examples as disclosed herein. In some examples, aspects of the operations of 1510 may be performed by a UCI component 930 as described with reference to FIG. 9.

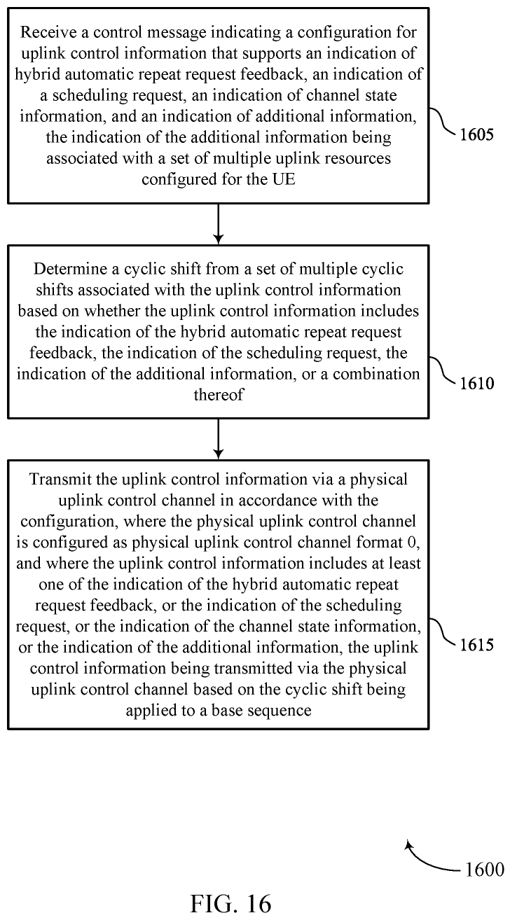

FIG. 16 illustrates a flowchart showing a method 1600 that supports indications for uplink resources via UCI in accordance with one or more aspects of the present disclosure. The operations of the method 1600 may be implemented by a UE or its components as described herein. For example, the operations of the method 1600 may be performed by a UE 115 as described with reference to FIGS. 1 through 10. In some examples, a UE may execute a set of instructions to control the functional elements of the UE to perform the described functions. Additionally, or alternatively, the UE may perform aspects of the described functions using special-purpose hardware.

At 1605, the method may include receiving a control message indicating a configuration for UCI that supports an indication of HARQ feedback, an indication of a scheduling request, an indication of CSI, and an indication of additional information, the indication of the additional information being associated with a set of multiple uplink resources configured for the UE. The operations of 1605 may be performed in accordance with examples as disclosed herein. In some examples, aspects of the operations of 1605 may be performed by a control message component 925 as described with reference to FIG. 9.

At 1610, the method may include determining a cyclic shift from a set of multiple cyclic shifts associated with the UCI based on whether the UCI includes the indication of the HARQ feedback, the indication of the scheduling request, the indication of the additional information, or a combination thereof. The operations of 1610 may be performed in accordance with examples as disclosed herein. In some examples, aspects of the operations of 1610 may be performed by a cyclic shift component 935 as described with reference to FIG. 9.

At 1615, the method may include transmitting the UCI via a PUCCH in accordance with the configuration, where the PUCCH is configured as PUCCH format 0. In some examples, the UCI includes at least one of the indication of the HARQ feedback, or the indication of the scheduling request, or the indication of the CSI, or the indication of the additional information, where the UCI is transmitted via the PUCCH based on the cyclic shift being applied to a base sequence. The operations of 1615 may be performed in accordance with examples as disclosed herein. In some examples, aspects of the operations of 1615 may be performed by a UCI component 930 as described with reference to FIG. 9.

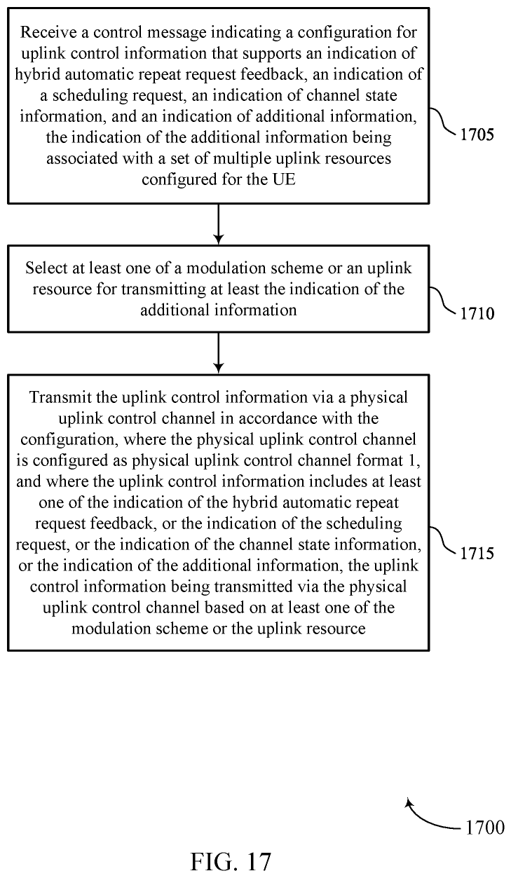

FIG. 17 illustrates a flowchart showing a method 1700 that supports indications for uplink resources via UCI in accordance with one or more aspects of the present disclosure. The operations of the method 1700 may be implemented by a UE or its components as described herein. For example, the operations of the method 1700 may be performed by a UE 115 as described with reference to FIGS. 1 through 10. In some examples, a UE may execute a set of instructions to control the functional elements of the UE to perform the described functions. Additionally, or alternatively, the UE may perform aspects of the described functions using special-purpose hardware.

At 1705, the method may include receiving a control message indicating a configuration for UCI that supports an indication of HARQ feedback, an indication of a scheduling request, an indication of CSI, and an indication of additional information, the indication of the additional information being associated with a set of multiple uplink resources configured for the UE. The operations of 1705 may be performed in accordance with examples as disclosed herein. In some examples, aspects of the operations of 1705 may be performed by a control message component 925 as described with reference to FIG. 9.

At 1710, the method may include selecting at least one of a modulation scheme or an uplink resource for transmitting at least the indication of the additional information. The operations of 1710 may be performed in accordance with examples as disclosed herein. In some examples, aspects of the operations of 1710 may be performed by a modulation scheme component 940 as described with reference to FIG. 9.

At 1715, the method may include transmitting the UCI via a PUCCH in accordance with the configuration, where the PUCCH is configured as PUCCH format 1. In some examples, the UCI includes at least one of the indication of the HARQ feedback, or the indication of the scheduling request, or the indication of the CSI, or the indication of the additional information, where the UCI is transmitted via the PUCCH based on at least one of the modulation scheme or the uplink resource. The operations of 1715 may be performed in accordance with examples as disclosed herein. In some examples, aspects of the operations of 1715 may be performed by a UCI component 930 as described with reference to FIG. 9.

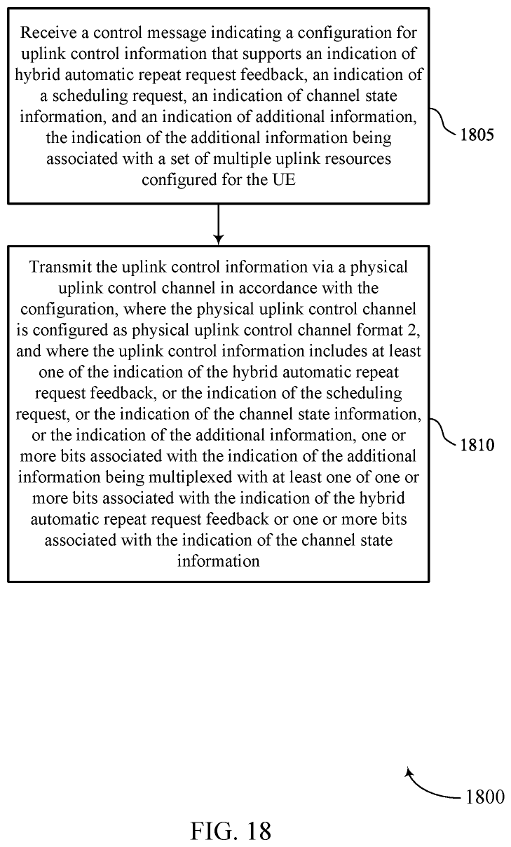

FIG. 18 illustrates a flowchart showing a method 1800 that supports indications for uplink resources via UCI in accordance with one or more aspects of the present disclosure. The operations of the method 1800 may be implemented by a UE or its components as described herein. For example, the operations of the method 1800 may be performed by a UE 115 as described with reference to FIGS. 1 through 10. In some examples, a UE may execute a set of instructions to control the functional elements of the UE to perform the described functions. Additionally, or alternatively, the UE may perform aspects of the described functions using special-purpose hardware.

At 1805, the method may include receiving a control message indicating a configuration for UCI that supports an indication of HARQ feedback, an indication of a scheduling request, an indication of CSI, and an indication of additional information, the indication of the additional information being associated with a set of multiple uplink resources configured for the UE. The operations of 1805 may be performed in accordance with examples as disclosed herein. In some examples, aspects of the operations of 1805 may be performed by a control message component 925 as described with reference to FIG. 9.

At 1810, the method may include transmitting the UCI via a PUCCH in accordance with the configuration, where the UCI includes at least one of the indication of the HARQ feedback, or the indication of the scheduling request, or the indication of the CSI, or the indication of the additional information. In some examples, one or more bits associated with the indication of the additional information are multiplexed with at least one of one or more bits associated with the indication of the HARQ feedback or one or more bits associated with the indication of the CSI. The operations of 1810 may be performed in accordance with examples as disclosed herein. In some examples, aspects of the operations of 1810 may be performed by a multiplexing component 945 as described with reference to FIG. 9.

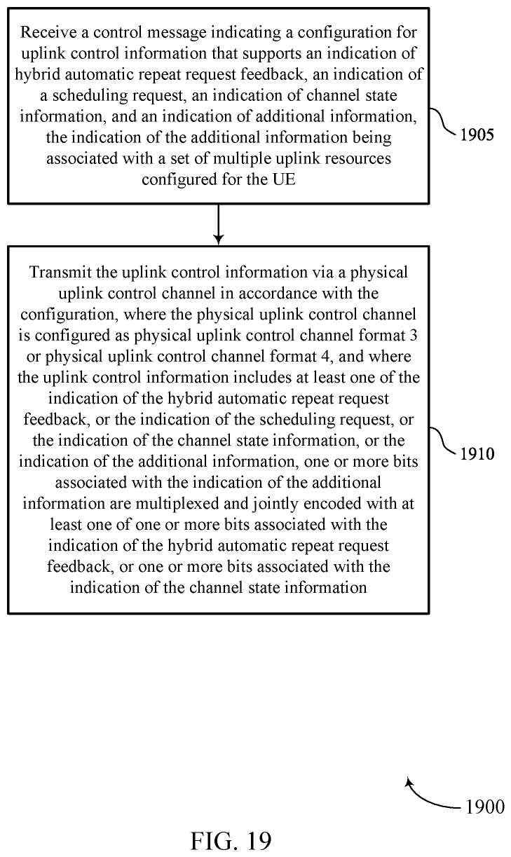

FIG. 19 illustrates a flowchart showing a method 1900 that supports indications for uplink resources via UCI in accordance with one or more aspects of the present disclosure. The operations of the method 1900 may be implemented by a UE or its components as described herein. For example, the operations of the method 1900 may be performed by a UE 115 as described with reference to FIGS. 1 through 10. In some examples, a UE may execute a set of instructions to control the functional elements of the UE to perform the described functions. Additionally, or alternatively, the UE may perform aspects of the described functions using special-purpose hardware.

At 1905, the method may include receiving a control message indicating a configuration for UCI that supports an indication of HARQ feedback, an indication of a scheduling request, an indication of CSI, and an indication of additional information, the indication of the additional information being associated with a set of multiple uplink resources configured for the UE. The operations of 1905 may be performed in accordance with examples as disclosed herein. In some examples, aspects of the operations of 1905 may be performed by a control message component 925 as described with reference to FIG. 9.

At 1910, the method may include transmitting the UCI via a PUCCH in accordance with the configuration, where the PUCCH is configured as PUCCH format 3 or PUCCH format 4. In some examples, the UCI includes at least one of the indication of the HARQ feedback, or the indication of the scheduling request, or the indication of the CSI, or the indication of the additional information, where one or more bits associated with the indication of the additional information are multiplexed and jointly encoded with at least one of one or more bits associated with the indication of the HARQ feedback, or one or more bits associated with the indication of the CSI. The operations of 1910 may be performed in accordance with examples as disclosed herein. In some examples, aspects of the operations of 1910 may be performed by a multiplexing component 945 as described with reference to FIG. 9.

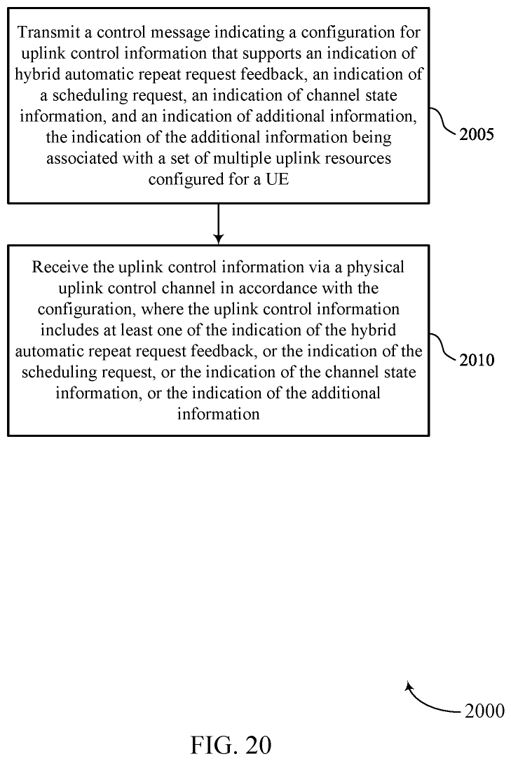

FIG. 20 illustrates a flowchart showing a method 2000 that supports indications for uplink resources via UCI in accordance with one or more aspects of the present disclosure. The operations of the method 2000 may be implemented by a network entity or its components as described herein. For example, the operations of the method 2000 may be performed by a network entity as described with reference to FIGS. 1 through 6 and 11 through 14. In some examples, a network entity may execute a set of instructions to control the functional elements of the network entity to perform the described functions. Additionally, or alternatively, the network entity may perform aspects of the described functions using special-purpose hardware.

At 2005, the method may include transmitting a control message indicating a configuration for UCI that supports an indication of HARQ feedback, an indication of a scheduling request, an indication of CSI, and an indication of additional information, the indication of the additional information being associated with a set of multiple uplink resources configured for a UE. The operations of 2005 may be performed in accordance with examples as disclosed herein. In some examples, aspects of the operations of 2005 may be performed by a configuration component 1325 as described with reference to FIG. 13.

At 2010, the method may include receiving the UCI via a PUCCH in accordance with the configuration, where the UCI includes at least one of the indication of the HARQ feedback, or the indication of the scheduling request, or the indication of the CSI, or the indication of the additional information. The operations of 2010 may be performed in accordance with examples as disclosed herein. In some examples, aspects of the operations of 2010 may be performed by a UCI component 1330 as described with reference to FIG. 13.

The following provides an overview of aspects of the present disclosure:

Aspect 1: A method for wireless communication at a UE, comprising: receiving a control message indicating a configuration for UCI that supports an indication of HARQ feedback, an indication of a scheduling request, an indication of CSI, and an indication of additional information, the indication of the additional information being associated with a plurality of uplink resources configured for the UE; and transmitting the UCI via a PUCCH in accordance with the configuration, wherein the UCI comprises at least one of the indication of the HARQ feedback, or the indication of the scheduling request, or the indication of the CSI, or the indication of the additional information.

Aspect 2: The method of aspect 1, wherein the PUCCH is configured as PUCCH format 0, the method further comprising: determining a cyclic shift from a plurality of cyclic shifts associated with the UCI based at least in part on whether the UCI comprises the indication of the HARQ feedback, the indication of the scheduling request, the indication of the additional information, or a combination thereof, wherein the UCI is transmitted via the PUCCH based at least in part on the cyclic shift being applied to a base sequence.

Aspect 3: The method of aspect 2, wherein the cyclic shift comprises an initial cyclic shift value based at least in part on the UCI comprising only the indication of the additional information.

Aspect 4: The method of aspect 2, wherein the cyclic shift comprises a first cyclic shift value based at least in part on the UCI comprising only the indication of the additional information, the first cyclic shift value being offset from an initial cyclic shift value.

Aspect 5: The method of aspect 2, wherein the cyclic shift comprises a second cyclic shift value based at least in part on the UCI comprising only the indication of the HARQ feedback, the second cyclic shift value being offset from an initial cyclic shift value by a first value in accordance with the HARQ feedback comprising a negative acknowledgment, or the second cyclic shift value being offset from the initial cyclic shift value by a second value different from the first value in accordance with the HARQ feedback comprising an acknowledgment.

Aspect 6: The method of aspect 2, wherein the cyclic shift comprises an initial cyclic shift value based at least in part on the UCI comprising only the indication of the scheduling request.

Aspect 7: The method of aspect 2, wherein the cyclic shift comprises a fourth cyclic shift value based at least in part on the UCI comprising the indication of the additional information and the indication of the scheduling request, the fourth cyclic shift value being offset from an initial cyclic shift value based at least in part on the scheduling request and the additional information.

Aspect 8: The method of aspect 2, wherein the cyclic shift comprises a fifth cyclic shift value based at least in part on the UCI comprising the indication of the additional information and the indication of the HARQ feedback, the fifth cyclic shift value being offset from an initial cyclic shift value by a third value in accordance with the HARQ feedback comprising a negative acknowledgment, or the fifth cyclic shift value being offset from the initial cyclic shift value by a fourth value different from the third value in accordance with the HARQ feedback comprising an acknowledgment.

Aspect 9: The method of aspect 2, wherein the cyclic shift comprises a sixth cyclic shift value based at least in part on the UCI comprising the indication of the additional information, the indication of the HARQ feedback, and the indication of the scheduling request, the sixth cyclic shift value being offset from an initial cyclic shift value by a fifth value in accordance with the HARQ feedback comprising a negative acknowledgment, or the sixth cyclic shift value being offset from the initial cyclic shift value by a sixth value different from the fifth value in accordance with the HARQ feedback comprising an acknowledgment.

Aspect 10: The method of aspect 2, wherein the cyclic shift comprises a seventh cyclic shift value based at least in part on the UCI comprising the indication of the HARQ feedback and the indication of the scheduling request, the seventh cyclic shift value being offset from an initial cyclic shift value by a seventh value in accordance with the HARQ feedback comprising a negative acknowledgment, or the seventh cyclic shift value being offset from the initial cyclic shift value by a eighth value different from the seventh value in accordance with the HARQ feedback comprising an acknowledgment.

Aspect 11: The method of aspect 2, wherein the cyclic shift is further based at least in part on a quantity of bits associated with each of the indication of the HARQ feedback, or indication of the scheduling request, or the indication of the additional information, or any combination thereof, and a bit value of each of the indication of the HARQ feedback, or the indication of the additional information, or both.

Aspect 12: The method of aspect 1, wherein the PUCCH is configured as PUCCH format 1, the method further comprising: selecting at least one of a modulation scheme or an uplink resource for transmitting at least the indication of the additional information, wherein the UCI is transmitted via the PUCCH based at least in part on at least one of the modulation scheme or the uplink resource.

Aspect 13: The method of aspect 12, wherein the UCI comprises only the indication of the additional information; and the additional information is indicated using the modulation scheme based at least in part on a quantity of bits associated with the indication of the additional information.

Aspect 14: The method of aspect 13, wherein the modulation scheme comprises a BPSK modulation scheme in accordance with the indication of the additional information comprising one bit.

Aspect 15: The method of aspect 13, wherein the modulation scheme comprises a QPSK modulation scheme in accordance with the indication of the additional information comprising two or more bits.

Aspect 16: The method of aspect 12, wherein the UCI comprises the indication of the additional information and the indication of the HARQ feedback; the indication of the additional information and the indication of the HARQ feedback is transmitted via the uplink resource, the uplink resource being allocated for the indication of the additional information; and the indication of the HARQ feedback transmitted via the uplink resource comprises the indication of the additional information based at least in part on the indication of the additional information comprising one bit.

Aspect 17: The method of aspect 12, wherein the UCI comprises the indication of the additional information and the indication of the HARQ feedback; the indication of the additional information and the indication of the HARQ feedback is transmitted using the modulation scheme, the modulation scheme comprising a QPSK modulation scheme; and the indication of the additional information comprises one bit.

Aspect 18: The method of aspect 12, wherein the UCI comprises the indication of the additional information and the indication of the scheduling request; the indication of the additional information and the indication of the scheduling request is transmitted via the uplink resource, the uplink resource comprising either a first uplink resource allocated for the indication of the additional information or a second uplink resource allocated for the indication of the scheduling request; and the indication of the additional information comprises one bit.

Aspect 19: The method of aspect 12, wherein the UCI comprises the indication of the additional information and the indication of the scheduling request; the indication of the additional information and the indication of the scheduling request is transmitted via the uplink resource, the uplink resource being allocated for the indication of the scheduling request; and the indication of the additional information comprises one or more bits.

Aspect 20: The method of aspect 12, wherein the UCI comprises the indication of the additional information, the indication of the scheduling request, and the indication of the HARQ feedback; the indication of the HARQ feedback is transmitted via the uplink resource, the uplink resource comprising either a first uplink resource allocated for the indication of the additional information or a second uplink resource allocated for the indication of the scheduling request; and the indication of the additional information comprises one bit.

Aspect 21: The method of aspect 12, wherein the UCI comprises the indication of the additional information, the indication of the scheduling request, and the indication of the HARQ feedback, the indication of the additional information; the indication of the scheduling request, and the indication of the HARQ feedback is transmitted using the modulation scheme and via the uplink resource, the modulation scheme comprising a QPSK modulation scheme and the uplink resource being allocated for the indication of the scheduling request; and the indication of the additional information comprises one bit.

Aspect 22: The method of aspect 1, wherein the PUCCH is configured as PUCCH format 2, the method further comprising: transmitting, as part of the UCI, at least one of the indication of the additional information, or the indication of the HARQ feedback, or the indication of the CSI, wherein one or more bits associated with the indication of the additional information are multiplexed with at least one of one or more bits associated with the indication of the HARQ feedback or one or more bits associated with the indication of the CSI.

Aspect 23: The method of aspect 22, wherein the one or more bits associated with the indication of the HARQ feedback have a first priority that is greater than a second priority associated with the one or more bits associated with the indication of the additional information; the second priority is greater than a third priority associated with the one or more bits associated with the indication of the CSI; and the UCI comprises at least one of the indication of the additional information, or the indication of the scheduling request, or the indication of the HARQ feedback, or the indication of the CSI, based at least in part on the first priority, the second priority, or the third priority.

Aspect 24: The method of aspect 1, wherein the PUCCH is configured as PUCCH format 3 or PUCCH format 4, the method further comprising: transmitting, as part of the UCI, at least one of the indication of the additional information, or the indication of the HARQ feedback, or the indication of the CSI, wherein one or more bits associated with the indication of the additional information are multiplexed and jointly encoded with at least one of one or more bits associated with the indication of the HARQ feedback, or one or more bits associated with the indication of the CSI.

Aspect 25: The method of aspect 24, further comprising: mapping at least one of the one or more bits associated with the indication of the additional information, or the one or more bits associated with the indication of the HARQ feedback, or the one or more bits associated with the indication of the CSI based at least in part on at least one of a first mapping priority, or a second mapping priority that is less than the first mapping priority, or a third mapping priority that is less than the second mapping priority, wherein: the one or more bits associated with the indication of the HARQ feedback have the first mapping priority; the one or more bits associated with the indication of the additional information have the second mapping priority; and the one or more bits associated with the indication of the CSI have the third mapping priority.

Aspect 26: The method of any of aspects 1 through 25, wherein the additional information indicates that the UE is to skip one or more uplink resources of the plurality of uplink resources configured for the UE.

Aspect 27: The method of aspect 26, wherein the UCI excludes the indication of the scheduling request based at least in part on the UCI indicating that the UE is to skip the one or more uplink resources.

Aspect 28: The method of aspect 26, wherein the UCI excludes the indication of the additional information based at least in part on the UCI comprising the indication of the scheduling request.

Aspect 29: A method for wireless communication at a network entity, comprising: transmitting a control message indicating a configuration for UCI that supports an indication of HARQ feedback, an indication of a scheduling request, an indication of CSI, and an indication of additional information, the indication of the additional information being associated with a plurality of uplink resources configured for a UE; and receiving the UCI via a PUCCH in accordance with the configuration, wherein the UCI comprises at least one of the indication of the HARQ feedback, or the indication of the scheduling request, or the indication of the CSI, or the indication of the additional information.

Aspect 30: The method of aspect 29, wherein the PUCCH is configured as PUCCH format 0, the method further comprising: receiving the UCI via the PUCCH based at least in part on a cyclic shift applied to a base sequence, the cyclic shift being from a plurality of cyclic shifts, wherein the cyclic shift is based at least in part on whether the UCI comprises the indication of the HARQ feedback, the indication of the scheduling request, the indication of the additional information, or a combination thereof.

Aspect 31: The method of aspect 30, wherein the cyclic shift comprises an initial cyclic shift value based at least in part on the UCI comprising only the indication of the additional information.

Aspect 32: The method of any of aspects 30 through 31, wherein the cyclic shift comprises a first cyclic shift value based at least in part on the UCI comprising only the indication of the additional information, the first cyclic shift value being offset from an initial cyclic shift value.

Aspect 33: The method of aspect 30, wherein the cyclic shift comprises a second cyclic shift value based at least in part on the UCI comprising only the indication of the HARQ feedback, the second cyclic shift value being offset from an initial cyclic shift value by a first value in accordance with the HARQ feedback comprising a negative acknowledgment, or the second cyclic shift value being offset from the initial cyclic shift value by a second value different from the first value in accordance with the HARQ feedback comprising an acknowledgment.

Aspect 34: The method of aspect 30, wherein the cyclic shift comprises an initial cyclic shift value based at least in part on the UCI comprising only the indication of the scheduling request.

Aspect 35: The method of aspect 30, wherein the cyclic shift comprises a fourth cyclic shift value based at least in part on the UCI comprising the indication of the additional information and the indication of the scheduling request, the fourth cyclic shift value being offset from an initial cyclic shift value based at least in part on the scheduling request and the additional information.

Aspect 36: The method of aspect 30, wherein the cyclic shift comprises a fifth cyclic shift value based at least in part on the UCI comprising the indication of the additional information and the indication of the HARQ feedback, the fifth cyclic shift value being offset from an initial cyclic shift value by a third value in accordance with the HARQ feedback comprising a negative acknowledgment, or the fifth cyclic shift value being offset from the initial cyclic shift value by a fourth value different from the third value in accordance with the HARQ feedback comprising an acknowledgment.

Aspect 37: The method of aspect 30, wherein the cyclic shift comprises a sixth cyclic shift value based at least in part on the UCI comprising the indication of the additional information, the indication of the HARQ feedback, and the indication of the scheduling request, the sixth cyclic shift value being offset from an initial cyclic shift value by a fifth value in accordance with the HARQ feedback comprising a negative acknowledgment, or the sixth cyclic shift value being offset from the initial cyclic shift value by a sixth value different from the fifth value in accordance with the HARQ feedback comprising an acknowledgment.

Aspect 38: The method of aspect 30, wherein the cyclic shift comprises a seventh cyclic shift value based at least in part on the UCI comprising the indication of the HARQ feedback and the indication of the scheduling request, the seventh cyclic shift value being offset from an initial cyclic shift value by a seventh value in accordance with the HARQ feedback comprising a negative acknowledgment, or the seventh cyclic shift value being offset from the initial cyclic shift value by a eighth value different from the seventh value in accordance with the HARQ feedback comprising an acknowledgment.

Aspect 39: The method of aspect 30, wherein the cyclic shift is further based at least in part on a quantity of bits associated with each of the indication of the HARQ feedback, or the indication of the scheduling request, or the indication of the additional information, or any combination thereof, and a bit value of each of the indication of the HARQ feedback, or the indication of the additional information, or both.

Aspect 40: The method of aspect 29, wherein the PUCCH is configured as PUCCH format 1, the method further comprising: receiving at least the indication of the additional information based at least in part on at least one of a modulation scheme or an uplink resource, wherein the UCI is received via the PUCCH based at least in part on at least one of the modulation scheme or the uplink resource.

Aspect 41: The method of aspect 40, wherein the UCI comprises only the indication of the additional information; and the additional information is indicated using the modulation scheme based at least in part on a quantity of bits associated with the indication of the additional information.

Aspect 42: The method of aspect 41, wherein the modulation scheme comprises a QPSK modulation scheme in accordance with the indication of the additional information comprising two or more bits.

Aspect 43: The method of aspect 40, wherein the modulation scheme comprises a BPSK modulation scheme in accordance with the indication of the additional information comprising one bit.

Aspect 44: The method of aspect 40, wherein the UCI comprises the indication of the additional information and the indication of the HARQ feedback; the indication of the additional information and the indication of the HARQ feedback is transmitted via the uplink resource, the uplink resource being allocated for the indication of the additional information; and the indication of the HARQ feedback transmitted via the uplink resource comprises the indication of the additional information based at least in part on the indication of the additional information comprising one bit.

Aspect 45: The method of aspect 40, wherein the UCI comprises the indication of the additional information and the indication of the HARQ feedback; the indication of the additional information and the indication of the HARQ feedback is transmitted using the modulation scheme, the modulation scheme comprising a QPSK modulation scheme; and the indication of the additional information comprises one.

Aspect 46: The method of aspect 40, wherein the UCI comprises the indication of the additional information and the indication of the scheduling request; the indication of the additional information and the indication of the scheduling request is transmitted via the uplink resource, the uplink resource comprising either a first uplink resource allocated for the indication of the additional information or a second uplink resource allocated for the indication of the scheduling request; and the indication of the additional information comprises one bit.

Aspect 47: The method of aspect 40, wherein the UCI comprises the indication of the additional information and the indication of the scheduling request; the indication of the additional information and the indication of the scheduling request is transmitted via the uplink resource, the uplink resource being allocated for the indication of the scheduling request; and the indication of the additional information comprises one or more bits.

Aspect 48: The method of aspect 40, wherein the UCI comprises the indication of the additional information, the indication of the scheduling request, and the indication of the HARQ feedback; the indication of the HARQ feedback is transmitted via the uplink resource, the uplink resource comprising either a first uplink resource allocated for the indication of the additional information or a second uplink resource allocated for the indication of the scheduling request; and the indication of the additional information comprises one.

Aspect 49: The method of aspect 40, wherein the UCI comprises the indication of the additional information, the indication of the scheduling request, and the indication of the HARQ feedback, the indication of the additional information; the indication of the scheduling request, and the indication of the HARQ feedback is transmitted using the modulation scheme and via the uplink resource, the modulation scheme comprising a QPSK modulation scheme and the uplink resource being allocated for the indication of the scheduling request; and the indication of the additional information comprises one bit.

Aspect 50: The method of aspect 29, wherein the PUCCH is configured as PUCCH format 2, the method further comprising: receiving, as part of the UCI, at least one of the indication of the additional information, or the indication of the HARQ feedback, or the indication of the CSI, wherein one or more bits associated with the indication of the additional information are multiplexed with at least one of one or more bits associated with the indication of the HARQ feedback, or one or more bits associated with the indication of the CSI.

Aspect 51: The method of aspect 50, wherein the one or more bits associated with the indication of the HARQ feedback have a first priority that is greater than a second priority associated with the one or more bits associated with the indication of the additional information; the second priority is greater than a third priority associated with the one or more bits associated with the indication of the CSI; and the UCI comprises at least one of the indication of the additional information, or the indication of the scheduling request, or the indication of the HARQ feedback, or the indication of the CSI, based at least in part on the first priority, the second priority, or the third priority.

Aspect 52: The method of aspect 29, wherein the PUCCH is configured as PUCCH format 3 or PUCCH format 4, the method further comprising: receiving, as part of the UCI, at least one of the indication of the additional information, or the indication of the HARQ feedback, or the indication of the CSI, wherein one or more bits associated with the indication of the additional information are multiplexed and jointly encoded with at least one of one or more bits associated with the indication of the HARQ feedback, or one or more bits associated with the indication of the CSI.

Aspect 53: The method of aspect 52, wherein at least one of the one or more bits associated with the indication of the additional information, or the one or more bits associated with the indication of the HARQ feedback, or the one or more bits associated with the indication of the CSI are mapped to resources based at least in part on at least one of a first mapping priority, or a second mapping priority that is less than the first mapping priority, or a third mapping priority that is less than the second mapping priority, wherein the one or more bits associated with the indication of the HARQ feedback have the first mapping priority; the one or more bits associated with the indication of the additional information have the second mapping priority; and the one or more bits associated with the indication of the CSI have the third mapping priority.

Aspect 54: The method of any of aspects 29 through 53, wherein the additional information indicates that the UE is skipping one or more uplink resources of the plurality of uplink resources configured for the UE.

Aspect 55: The method of aspect 54, further comprising: indicating a configuration to exclude the indication of the scheduling request from the UCI based at least in part on the UCI comprising the indication of the additional information, wherein the UCI is received in accordance with the configuration to exclude the indication of the scheduling request.

Aspect 56: The method of aspect 54, further comprising: indicating a configuration to exclude the indication of the additional information from the UCI based at least in part on the UCI comprising the indication of the scheduling request, wherein the UCI is received in accordance with the configuration to exclude the indication of the additional information.

Aspect 57: A UE for wireless communication, comprising one or more memories storing processor-executable code and one or more processors coupled with the one or more memories. The one or more processors may be individually or collectively operable to execute the code to cause the UE to perform a method of any of aspects 1 through 28.

Aspect 58: An apparatus for wireless communication at a UE, comprising at least one means for performing a method of any of aspects 1 through 28.

Aspect 59: A non-transitory computer-readable medium storing code for wireless communication at a UE, the code comprising instructions executable by one or more processors to perform a method of any of aspects 1 through 28.

Aspect 60: A network entity for wireless communication, comprising one or more memories storing processor-executable code and one or more processors coupled with the one or more memories. The one or more processors may be individually or collectively operable to execute the code to cause the network entity to perform a method of any of aspects 29 through 56.

Aspect 61: An apparatus for wireless communication at a network entity, comprising at least one means for performing a method of any of aspects 29 through 56.

Aspect 62: A non-transitory computer-readable medium storing code for wireless communication at a network entity, the code comprising instructions executable by one or more processors to perform a method of any of aspects 29 through 56.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (e.g., receiving information), accessing (e.g., accessing data stored in memory) and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
one or more memories storing processor-executable code; and
one or more processors coupled with the one or more memories and individually or collectively operable to execute the code to cause the UE to:
receive a control message indicating a configuration for uplink control information that supports an indication of hybrid automatic repeat request feedback, an indication of a scheduling request, an indication of channel state information, and an indication of additional information, the indication of the additional information being associated with a plurality of uplink resources configured for the UE; and
transmit the uplink control information via a physical uplink control channel in accordance with the configuration,
wherein the uplink control information comprises at least one of the indication of the hybrid automatic repeat request feedback, the indication of the scheduling request, the indication of the channel state information, or the indication of the additional information.

2. The UE of claim 1, wherein the physical uplink control channel is configured as physical uplink control channel format 0, and the one or more processors are individually or collectively further operable to execute the code to cause the UE to:
determine a cyclic shift from a plurality of cyclic shifts associated with the uplink control information based at least in part on whether the uplink control information comprises the indication of the hybrid automatic repeat request feedback, the indication of the scheduling request, the indication of the additional information, or a combination thereof,
wherein the uplink control information is transmitted via the physical uplink control channel based at least in part on the cyclic shift being applied to a base sequence.

3. The UE of claim 2, wherein the cyclic shift comprises an initial cyclic shift value based at least in part on the uplink control information comprising only the indication of the additional information.

4. The UE of claim 2, wherein the cyclic shift comprises a first cyclic shift value based at least in part on the uplink control information comprising only the indication of the additional information, the first cyclic shift value being offset from an initial cyclic shift value.

5. The UE of claim 2, wherein the cyclic shift comprises a second cyclic shift value based at least in part on the uplink control information comprising only the indication of the hybrid automatic repeat request feedback,
the second cyclic shift value being offset from an initial cyclic shift value by a first value in accordance with the hybrid automatic repeat request feedback comprising a negative acknowledgment, or
the second cyclic shift value being offset from the initial cyclic shift value by a second value different from the first value in accordance with the hybrid automatic repeat request feedback comprising an acknowledgment.

6. The UE of claim 2, wherein the cyclic shift comprises an initial cyclic shift value based at least in part on the uplink control information comprising only the indication of the scheduling request.

7. The UE of claim 1, wherein the physical uplink control channel is configured as physical uplink control channel format 1, and the one or more processors are individually or collectively further operable to execute the code to cause the UE to:
select at least one of a modulation scheme or an uplink resource for transmitting at least the indication of the additional information,
wherein the uplink control information is transmitted via the physical uplink control channel based at least in part on at least one of the modulation scheme or the uplink resource.

8. The UE of claim 7, wherein:
the uplink control information comprises only the indication of the additional information; and
the additional information is indicated using the modulation scheme based at least in part on a quantity of bits associated with the indication of the additional information.

9. The UE of claim 7, wherein:
the uplink control information comprises the indication of the additional information and the indication of the hybrid automatic repeat request feedback;
the indication of the additional information and the indication of the hybrid automatic repeat request feedback is transmitted via the uplink resource, the uplink resource being allocated for the indication of the additional information; and
the indication of the hybrid automatic repeat request feedback transmitted via the uplink resource comprises the indication of the additional information based at least in part on the indication of the additional information comprising one bit.

10. The UE of claim 7, wherein:
the uplink control information comprises the indication of the additional information and the indication of the hybrid automatic repeat request feedback;
the indication of the additional information and the indication of the hybrid automatic repeat request feedback is transmitted using the modulation scheme, the modulation scheme comprising a quadrature phase shift keying modulation scheme; and
the indication of the additional information comprises one bit.

11. The UE of claim 7, wherein:
the uplink control information comprises the indication of the additional information and the indication of the scheduling request;
the indication of the additional information and the indication of the scheduling request is transmitted via the uplink resource, the uplink resource comprising either a first uplink resource allocated for the indication of the additional information or a second uplink resource allocated for the indication of the scheduling request; and
the indication of the additional information comprises one bit.

12. The UE of claim 1, wherein the physical uplink control channel is configured as physical uplink control channel format 2, and the one or more processors are individually or collectively further operable to execute the code to cause the UE to:
transmit, as part of the uplink control information, at least one of the indication of the additional information, the indication of the hybrid automatic repeat request feedback, or the indication of the channel state information,
wherein one or more bits associated with the indication of the additional information are multiplexed with at least one of one or more bits associated with the indication of the hybrid automatic repeat request feedback or one or more bits associated with the indication of the channel state information.

13. The UE of claim 1, wherein the physical uplink control channel is configured as physical uplink control channel format 3 or physical uplink control channel format 4, and the one or more processors are individually or collectively further operable to execute the code to cause the UE to:
transmit, as part of the uplink control information, at least one of the indication of the additional information, the indication of the hybrid automatic repeat request feedback, or the indication of the channel state information,
wherein one or more bits associated with the indication of the additional information are multiplexed and jointly encoded with at least one of one or more bits associated with the indication of the hybrid automatic repeat request feedback, or one or more bits associated with the indication of the channel state information.

14. A network entity, comprising:
one or more memories storing processor-executable code; and
one or more processors coupled with the one or more memories and individually or collectively operable to execute the code to cause the network entity to:
transmit a control message indicating a configuration for uplink control information that supports an indication of hybrid automatic repeat request feedback, an indication of a scheduling request, an indication of channel state information, and an indication of additional information, the indication of the additional information being associated with a plurality of uplink resources configured for a user equipment (UE); and
receive the uplink control information via a physical uplink control channel in accordance with the configuration,
wherein the uplink control information comprises at least one of the indication of the hybrid automatic repeat request feedback, the indication of the scheduling request, the indication of the channel state information, or the indication of the additional information.

15. The network entity of claim 14, wherein the physical uplink control channel is configured as physical uplink control channel format 0, and the one or more processors are individually or collectively further operable to execute the code to cause the network entity to:
receive the uplink control information via the physical uplink control channel based at least in part on a cyclic shift applied to a base sequence, the cyclic shift being from a plurality of cyclic shifts,
wherein the cyclic shift is based at least in part on whether the uplink control information comprises the indication of the hybrid automatic repeat request feedback, the indication of the scheduling request, the indication of the additional information, or a combination thereof.

16. The network entity of claim 14, wherein the physical uplink control channel is configured as physical uplink control channel format 1, and the one or more processors are individually or collectively further operable to execute the code to cause the network entity to:
receive at least the indication of the additional information based at least in part on at least one of a modulation scheme or an uplink resource,
wherein the uplink control information is received via the physical uplink control channel based at least in part on at least one of the modulation scheme or the uplink resource.

17. The network entity of claim 14, wherein the physical uplink control channel is configured as physical uplink control channel format 2, and the one or more processors are individually or collectively further operable to execute the code to cause the network entity to:
receive, as part of the uplink control information, at least one of the indication of the additional information, the indication of the hybrid automatic repeat request feedback, or the indication of the channel state information,
wherein one or more bits associated with the indication of the additional information are multiplexed with at least one of one or more bits associated with the indication of the hybrid automatic repeat request feedback, or one or more bits associated with the indication of the channel state information.

18. The network entity of claim 14, wherein the physical uplink control channel is configured as physical uplink control channel format 3 or physical uplink control channel format 4, and the one or more processors are individually or collectively further operable to execute the code to cause the network entity to:
receive, as part of the uplink control information, at least one of the indication of the additional information, the indication of the hybrid automatic repeat request feedback, or the indication of the channel state information,
wherein one or more bits associated with the indication of the additional information are multiplexed and jointly encoded with at least one of one or more bits associated with the indication of the hybrid automatic repeat request feedback, or one or more bits associated with the indication of the channel state information.

19. The network entity of claim 14, wherein the additional information indicates that the UE is skipping one or more uplink resources of the plurality of uplink resources configured for the UE.

20. A method for wireless communication at a user equipment (UE), comprising:
receiving a control message indicating a configuration for uplink control information that supports an indication of hybrid automatic repeat request feedback, an indication of a scheduling request, an indication of channel state information, and an indication of additional information, the indication of the additional information being associated with a plurality of uplink resources configured for the UE; and
transmitting the uplink control information via a physical uplink control channel in accordance with the configuration,
wherein the uplink control information comprises at least one of the indication of the hybrid automatic repeat request feedback, the indication of the scheduling request, the indication of the channel state information, or the indication of the additional information.
